(19) United States
(12) Patent Application Publication
(10) Pub. No.: US 2003/0053016 A1
(43) Pub. Date: Mar. 20, 2003

(54) Formed body, reflecting plate, reflection display device, and method for fabricating reflecting plate

(76) Inventors: Hirofumi Kubota, Ishikawa (JP); Yasuhiko Yamanaka, Osaka (JP); Naohide Wakita, Osaka (JP); Seiji Nishiyama, Osaka (JP)

Correspondence Address: MCDERMOTT WILL & EMERY, 600 13TH STREET, N.W., WASHINGTON, DC, 20005-3096, US

(21) Appl. No.: 10/204,019

(22) PCT Filed: Feb. 16, 2001
(86) PCT No.: PCT/JP01/01141

(30) Foreign Application Priority Data
Feb. 16, 2000 (JP) 2000-37803
Feb. 18, 2000 (JP) 2000-40596
Mar. 31, 2000 (JP) 2000-100138
Oct. 31, 2000 (JP) 2000-332931

(51) Int. Cl. G02F 1/1335

(52) U.S. Cl. 349/113

(57) ABSTRACT

Disclosed is a reflector and a reflective liquid crystal display capable of maintaining high controllability of the shape of the reflective electrode and improving reflection characteristic, only in the step of forming active elements, without a need for special manufacturing steps. In a reflector comprising an active element D and a concave/convex reflective electrode on an insulating substrate, a step-like structure B obtained by cumulating a plurality of column-shaped bodies A1, A2 with width sequentially reduced upwardly. The column-shaped bodies A1, A2 are comprised of one or more layers selected from all layers L1-L2 constituting the active element D and obtained by layer forming and predetermined patterning in the step of manufacturing the active element D.

### TECHNICAL FIELD

The present invention relates to a reflector for performing display by using ambient light and a manufacturing method of the same, and a reflective display panel comprising the reflector.

### BACKGROUND ART

### First background Art

In the conventional reflective liquid crystal display panel, as disclosed in Japanese Laid-Open Patent Application Publication No. Hei. 8-184846, a reflective electrode having diffusivity is formed through steps of applying photosensitive resin over an insulating film layer as an uppermost layer of an active matrix element comprised of a metal layer, a semiconductor layer, the insulating film layer or the like, forming column-shaped bodies by photolithography and etching, heating the column-shaped bodies to be deformed, and leveling by application of resin.

As disclosed in Japanese Laid-Open Patent Application Publications Nos. Hei. 9-54318, 11-133399, 11-258596, etching is conducted on cumulated layers comprised of metal layers, a semiconductor layer, an insulating film layer or the like composing an active matrix element, using the insulating film layer corresponding to the uppermost layer as a mask, thereby obtaining a concave/convex shape, on which a reflective electrode with diffusivity is formed.

In the active matrix element of the conventional transmissive liquid crystal display panel, the reflective electrode is manufactured through steps of five photolithographies and etchings. On the other hand, the method disclosed in Japanese Laid-Open Patent Application Publication No. Hei. 8-184846 provides high controllability of the concave/convex shape for giving diffusivity to the reflective electrode, but its step is more complex than that of the TFT (Thin Film Transistor) type active matrix substrate of the conventional transmissive liquid crystal display, which leads to increased manufacturing cost. This is a significant problem in manufacture.

To solve such a problem, techniques disclosed in Japanese Laid-Open Patent Application Publications Nos. Hei. 9-54318, 11-13399, and 11-258596, are directed to reducing the number of steps by conducting photolithography and etching once on the layers composing the active matrix element, for the purpose of suppressing an increase in cost. Although these techniques can apparently reduce cost by reducing the steps, the following problems arise after formation of the element.

To be specific, in the reflective electrode manufactured in the steps disclosed in Japanese Laid-Open Patent Application Publications Nos. Hei. 9-54318 and 11-258596, the inclination angle distributes with high frequency in large inclination angles. In the aforementioned reflective electrode, when light is incident from the direction of the polar angle 0 degree and a light-emanating angle distribution is measured in a polar angle direction, intensity of the emanating light is high in the 0 degree direction corresponding to so-called regular reflection and at large polar angles. The reflector having such diffusivity characteristic is observed as dark by a viewer under an ambient light.

When an inverse stagger TFT element was formed as the active matrix element and the reflective electrode was formed by using this step, it was found that the reproducibility of the reflective electrode was low and there was significantly large between-lot variation. Through close observation of the reflective electrode manufactured through the above steps, it was found that crack or peeling occurred on the reflective electrode. Since the etching rate of one-etching of the layers for pattering varies from layer to layer, non-uniformity is generated in side surfaces of the respective layers formed in the TFT device pattering. This causes insufficient adhesion in forming the reflective electrode of metal, which leads to crack or peeling. Such crack or peeling is believed to bring about increased between-lot variations or degraded reproducibility in the reflection characteristic of the reflective electrode.

In view of the above problem, the present invention provides a reflector and a reflective liquid crystal display, and a method of manufacturing these, which are capable of maintaining high controllability of a shape of the reflective electrode and thereby improving reflection characteristic, by a step of forming active elements, without additional manufacturing steps.

### SECOND BACKGROUND ART

As a method of achieving high-luminance reflective display element, there has been proposed a diffusive reflector having an concave/convex structure on a surface of a reflective layer (Japanese laid-Open Patent Application Publication No. Hei. 5-232465), in which a flattening layer is provided on independent convex portions.

Also, a method of forming a concave/convex structure by using a process of forming a TFT device or peripheral wires for the purpose of reducing the number of producing steps is disclosed in Japanese Laid-Open Patent Application Publication No. Hei. 11-258596, in which column-shaped protrusions of plural layers are provided to form the concave/convex structure.

It is essential that the concave/convex structure be controlled in order to provide high-luminance panel. It is required that the average inclination angle distribution of the inclined surface of the concave/concave structure be designed to have approximately 6 to 15 degrees at maximum.

Conventionally, after forming the flattening layer on the array substrate, the convex portions of one layer were formed by using photosensitive resist, and further, the flattening layer whose shape was changed by thermal annealing, was formed thereon, thus conducting shape control.

Thus, conventionally, because the TFT device and peripheral wires such as gate and source line are cumulated on the array substrate and then resist is provided thereon, the manufacturing process was complex and productivity was low (Japanese Laid-Open Patent Application Publication No. Hei. 5-232465).

Meanwhile, in the case where the concave/convex structure is formed by using the process of forming the TFT device or peripheral wires (Publication No. 11-258596), it is necessary to form convex portions of plural layers according to the steps. However, due to misalignment of mask in manufacture, the independent column-shaped convex portions were non-uniformly cumulated, and consequently, desired concave/convex structure was difficult to obtain.

### THIRD BACKGROUND ART

The reflective display panel has a drawback that display becomes darker than the transmissive display panel because of the use of ambient light. For this reason, for the purpose of obtaining high display quality, it is imperative that the reflector with high ambient light availability and superior visibility be used.

The reflector can obtain high reflectance by using metal film made of aluminum or silver with high reflectance. However, when the reflector having mirror characteristic is used on a flat substrate, light is reflected only in the direction of regular reflection as shown in FIG. 73(b), and consequently, a light source is mirrored, thereby causing display to be difficult to see as seen from this direction, while since there is little reflected light in directions other than this direction, display is very dark. To solve this problem, a reflective liquid crystal display panel has been proposed, in which minute concave/convex portions are formed on the surface of the reflector for the purpose of diffusing reflected light as shown in FIG. 73(a) to thereby suppress mirroring of the light source and improving visibility associated with brightness (reflectance) and viewing angles, etc, (Japanese Laid-Open Patent Application Publication No. Hei 6-27481).

In the conventional example, as shown in FIG. 74, protrusions 414a, 414b as a base of concave/convex portions are formed on a substrate 411 provided with a drive element 410, and a resin layer 416 is applied over the protrusions 414a, 414b, thereby creating smooth concave/convex portions. A reflective member 419 is formed over the concave/convex portions to form minute concave/convex portions on the surface of the reflector, thereby obtaining a reflector having satisfactory visibility.

By forming the minute and smooth concave/convex portions on the resin layer 415 as the base of the reflective member 419, the reflected light can be diffused, and thereby, the problems that the light source is mirrored and display in the directions other than the regular reflection is dark, can be solved. As a result, a reflective display panel with brightness and wide viewing angle is obtained.

However, in the above conventional example, the step of forming the minute and smooth concave/convex portions requires two steps, i.e., 1) step of forming the protrusions as the base of the concave/convex portions and 2) step of applying the resin layer over the protrusion to smooth the concave/convex portions, which takes long time.

In addition, while the protrusion 414a, 4141b in the above conventional example, are formed by applying, and then exposing and developing the photosensitive material, thereby leaving the protrusions at predetermined positions, moires are generated as the result of interference of light, if patterns of protrusions are regularly positioned in a photomask used in the exposure, which results in very-difficult-to-see display. This follows that the minute concave/convex portions needs to be arranged irregularly, and in the conventional example, it is necessary to consider irregularity in arrangement of the concave/convex portion patterns of the photomask.

The present invention is directed to solving the above-mentioned problem associated with the conventional examples, and an object thereof is to provide a reflector and a reflective display panel comprising the reflector, in which concave/convex portions arranged irregularly for prevention of occurrence of moire are easily formed through steps less than those of the conventional examples.

### DISCLOSER OF THE INVENTION

A group of inventions are based on identical or similar concept. Since the inventions are embodied by different embodiments, these inventions are sectioned into a first invention group, a second invention group, and a third invention group for each of closely related inventions. Hereinafter, the contents will be described for each section (invention group).

### First Invention Group

The invention according to claim 1 is a reflector comprising an active element and a concave/convex reflective electrode on a substrate, characterized in that a plurality of cumulated layer patterns obtained by cumulating thin films are formed under the concave/convex reflective electrode, and the cumulated layer patterns include two or more thin films selected from all thin films constituting the active element and obtained by predetermined patterning in a step of manufacturing the active element.

The invention according to claim 2 is the reflector according to claim 1, wherein the cumulated layer patterns are configured to have a taper shape obtained by cumulating the plurality of thin films with width sequentially reduced.

With above structure, a reflector with improved shape controllability and superior reflection characteristic is obtained. Further, it is preferable that the cumulated layer patterns are configured to have a taper shape obtained by cumulating the plurality of thin films with width sequentially reduced. In embodiments in this description, the thin films are referred to as column-shaped bodies and the cumulated layer patterns are referred to as step-like structures.

The invention according to claim 3 is the reflector according to claim 2, wherein the cumulated layer patterns have an asymmetric structure.

The above structure makes it possible that the regular reflection direction can be shifted from the center of the viewing angle of the observer, and consequently, high display quality is obtained.

The invention according to claim 4 is the reflector according to claim 2, wherein an insulating film is formed between the reflective electrode and the cumulated layer patterns.

The above structure makes it possible that the insulating film layer covers the cumulated layer pattern, and as a result, leakage in OFF state by the electric field can be suppressed. Besides, no peeling or cracks are generated in the reflective electrode.

The invention according to claim 5 is the reflector according to claim 4, wherein the insulating film is made of resin.

The invention according to claim 6 is the reflector according to claim 5, wherein the resin is photosensitive resin.

The invention according to claim 7 is the reflector according to claim 2, wherein the thin films constituting the cumulated layer patterns include at least two layers having different taper angles.

With the above structure, the shape of the step-like structure can be arbitrarily controlled by the presence of the two or more layers having different taper angles. Consequently, controllability of the concave/convex shape of the reflective electrode can be improved.

The invention according to claim 8 is a reflector comprising an active element, a color filter, and a concave/convex reflective electrode on a substrate, characterized in that a plurality of cumulated layer patterns obtained by cumulating thin films are formed under the concave/convex reflective electrode, and the cumulated layer patterns include two or more thin films selected from all thin films constituting the active element or the color filter and obtained by predetermined patterning in a step of manufacturing the active element or the color filter.

With the above structure, the reflector with improved shape controllability and superior reflection characteristic can be constituted as in the invention according to claim 1.

The invention according to claim 9 is a method of manufacturing a reflector comprising an active element and a concave/convex reflective electrode on a substrate, wherein cumulated layer patterns are formed under the concave/convex reflective electrode, characterized in that when forming and patterning thin films constituting the active element in a region of the substrate where the active element is formed, two or more of the thin films are formed and patterned in a region where a concave/convex plane is formed, thereby forming the cumulated layer patterns in the region where the concave/convex plane is formed.

With the above method, the shape of the cumulated layer patterns can be controlled, and as a result, the concave/convex shape of the reflective electrode can be controlled with high precision. Besides, since the patterning is conducted for each thin film pattern, it is possible to solve the problem associated with degradation of adhesion of the metal layer caused by uneven side surfaces of the layers which are formed and then patterned all together in the conventional method.

The invention according to claim 10 is a reflector comprising an active element, a capacitor electrode for formation of storage capacitor, a concave/convex reflective electrode, and cumulated layer patterns formed under the reflective electrode, on a substrate, characterized in that a plurality of first cumulated layer patterns obtained by using part of thin films constituting the active element are formed on a region of the substrate except where the capacitor electrode is formed, a plurality of second cumulated layer patterns different from the first cumulated layer patterns are formed on the capacitor electrode, and the concave/convex reflective electrode covers the first and second cumulated layer patterns.

The above structure can form the storage capacitor to prevent flicker caused by insufficient capacity. Also, the reflective electrode has the concave/convex shape immediately on the capacitor electrode, and the area of flat portions between the concave/convex portion of the reflective electrode can be minimized. As a result, the intensity of the regular reflection in the normal direction can be reduced.

The invention according to claim 11 is the reflector according to claim 10, wherein the second cumulated layer patterns are comprised of thin films different from the thin films constituting the active element.

The invention according to claim 12 is the reflector according to claim 11, wherein the second cumulated layer patterns include thin films obtained by patterning the capacitor electrode.

The invention according to claim 13 is a method of manufacturing a reflector comprising an active element, a capacitor electrode for formation of storage capacitor, and a concave/convex reflective electrode, on a substrate, characterized by the steps of: forming thin films different from thin films constituting the active element on the capacitor electrode; and patterning the thin films different from the thin films constituting the active element to form cumulated layer patterns.

The invention according to claim 14 is a method of manufacturing a reflector comprising an active element, a capacitor electrode for formation of storage capacitor, and a concave/convex reflective electrode, on a substrate, characterized by the steps of: forming thin films different from thin films constituting the active element on the capacitor electrode; and patterning the thin films different from the thin films constituting the active element to form cumulated layer patterns.

The invention according to claim 15 is a method of manufacturing a reflector comprising an active element, a capacitor electrode for formation of storage capacitor, a concave/convex reflective electrode, and cumulated layer patterns formed under the reflective electrode, on a substrate, characterized by the step of: patterning the capacitor electrode to form the cumulated layer patterns.

With the above method, its is possible to obtain a reflector in which the flicker caused by insufficient capacity can be prevented, and the reflective electrode has the concave/convex shape immediately on the capacitor electrode, thereby minimizing the area of the flat portions between the concave/convex portion of the reflective electrode, and as a result, the intensity of the regular reflection in the normal direction can be reduced.

The invention according to claim 16 is a reflector comprising an active element, a concave/convex reflective electrode, and cumulated layer patterns formed under the reflective electrode, on a substrate, characterized in that relative positional relationship between thin films constituting the cumulated layer patterns varies for each predetermined region.

The invention according to claim 17 is the reflector according to claim 16, wherein the cumulated layer patterns are asymmetric.

The above structure can minimize reduction of controllability of the concave/convex shape, which is caused by the margin of mask alignment.

The invention according to claim 18 is a shape structure characterized in that the shape structure has plural types of cumulated layer patterns comprised of two or more patterned thin films, and an order of sizes of the formed thin films varies for each plural types.

The invention according to claim 19 is a reflector characterized in that the reflector comprises the shape structure according to claim 18 as the cumulated layer patterns on a substrate.

By providing the shape structure in the reflector, the variation in the reflection characteristic can be reduced by the plural types of cumulated layer patterns. Therefore, the reduction in the controllability of the concave/convex shape of the reflector can be suppressed. The shape structure can be used in the reflector like the embodiments, and can also be used in an optical element (lens) or the like.

The invention according to claim 20 is a reflector comprising an active element and a concave/convex reflective electrode on a substrate, characterized in that cumulated layer patterns obtained by cumulating thin films are formed under the concave/convex reflective electrode, and the cumulated layer patterns include two or more thin films selected from all thin films constituting the active element and obtained by predetermined patterning in a step of manufacturing the active element, the cumulated layer patterns partially having overlapping portion.

The invention according to claim 21 is the reflector according to claim 20, wherein the overlapping portion is smaller than a minimum width of the thin films constituting the cumulated layer patterns.

With the above structure, the thin films constituting the cumulated layer patterns are configured to have partial overlapping portion. To be specific, the overlapping portion is smaller than the minimum width of the thin films constituting the cumulated layer patterns. Thereby, the ratio of the flat portions to the reflector can be reduced. As a result, the reflector with small intensity of the reflected light in the regular reflection direction and with less mirroring under intense ambient light can be attained.

The invention according to claim 22 is the method of manufacturing the reflector according to claim 9, wherein the thin films constituting the cumulated layer patterns have partial overlapping portion.

The invention according to claim 23 is the method of manufacturing the reflector according to claim 22, wherein the overlapping portion is smaller than a minimum width of the thin films constituting the cumulated layer patterns.

With the above method, the ratio of the flat portions to the reflector can be reduced. As a result, the reflector with small intensity of the reflected light in the regular reflection direction and with less mirroring under intense ambient light can be attained.

The invention according to claim 24 is the reflector according to claim 1, having light transmitting portion.

The invention according to claim 25 is the reflector according to claim 24, wherein the light transmitting portion has thickness different from thickness of portion other than the light transmitting portion.

The reflective display panel has degraded display quality under scarce ambient light. To solve such a problem, the reflector constituting the reflective display panel is configured to have the light transmitting portion, and a light source such as the backlight is provided on the rear surface of the substrate. As a result, the display panel with satisfactory visibility under any environment can be attained.

The invention according to claim 26 is a reflective display panel characterized by using the reflector according to claim 1.

The above structure achieves the reflective display panel with superior reflection characteristic.

The invention according to claim 27 is semi-transmissive display panel characterized by using the reflector according to claim 24.

The reflective display panel has degraded display quality under scarce ambient light. To solve such a problem, the reflective electrode and the transparent electrode are provided on the substrate and the light source such as the backlight is provided on the rear surface of the substrate. Thereby, a semi-tranmissive display panel with satisfactory visibility under any environment can be attained.

The invention according to claim 28 is a semi-transmissive display panel according to claim 27, having light collecting portion.

The above structure can improve luminance in the transmissive mode.

### Second Invention Group

The invention according to claim 29 is a reflector comprising: a substrate; and a reflective layer having a concave/convex structure formed on the substrate, characterized in that the concave/convex structure is formed by crossing a plurality of band-like thin film patterns formed on the substrate.

The invention according to claim 30 is the reflector according to 29, wherein convex portions are provided at portions where the thin film patterns cross each other.

With above structure, since the band-like thin film patterns cross each other, desired concave/convex structure can be obtained. In particular, by forming the convex apexes obtained by forming the convex portions at intersections, a more desired concave/convex structure can be obtained.

The invention according to claim 31 is the reflector according to claim 29, wherein the portions where the thin film patterns cross each other have a concave shape.

The above structure also achieves desired concave/convex structure.

The invention according to claim 32 is the reflector according to claim 29, wherein the thin film patterns have a mesh shape.

When the thin film patterns are in the form of mesh like the above structure, the thin film patterns can be substantially constant because even when there is positional deviation between the band-like thin film patterns in the upper and lower layers due to misalignment of the mask, only the intersections somewhat move. Therefore, the panel can exhibit substantially uniform reflection characteristic regardless of the mask misalignment, and consequently, productivity is greatly improved.

The invention according to claim 33 is the reflector according to claim 29, wherein the thin film patterns are irregularly spaced.

In the above structure, by randomly setting the spacing between adjacent band-like thin film patterns, diffraction and interference of the reflected light can be suppressed, and consequently, satisfactory display can be obtained.

The invention according to claim 34 is the reflector according to Claim 29, wherein an active element is further formed on the substrate, and the thin film patterns are comprised of thin films constituting the active element.

The invention according to claim 35 is the reflector according to claim 29, wherein an active element is further formed on the substrate, and the thin film patterns are formed in a step of forming the active element.

With this structure, the band-like patterns can be formed in the process of forming the TFT elements and peripheral wires on the array substrate. This further improves productivity.

The invention according to claim 36 is a reflective display panel characterized by comprising: the reflector according to claim 29; and a light control means provided on the reflector, for controlling amount of absorbed light.

Since the above structure can greatly improve productivity of the reflective display panel, the reflective display panel with high luminance can be attained at low cost.

### Third Invention Group

The invention according to claim 37 is a reflector comprising: a substrate; a resin layer formed on the substrate and having minute concave/convex portions on a surface thereof; a reflective member provided on the resin layer, for reflecting light, characterized in that the resin layer has the concave/convex portions obtained by dispersing and holding at least two types of resin portions.

The invention according to claim 38 is the reflector according to claim 37, wherein the concave/convex portions conform to arrangement of the at least two types of resin portions.

The invention according to claim 39 is the reflector according to claim 37, wherein vertical difference of the concave/convex portions is 0.7 μm or less.

Thereby, since minute concave/convex portions are formed on the surface of the reflector, the reflector with satisfactory reflection characteristic can be obtained. In particular, the minute concave/convex portions having the vertical difference as small as 0.7 μm or less, can be formed, and the reflector with satisfactory reflection characteristic can be obtained.

The invention according to claim 40 is the reflector according to claim 37, wherein the at least two types of resin portions are formed by phase separation in a solution including at least two types of resins applied over the substrate.

Thereby, since at least two types of resins are phase-separated after application of the mixed solution over the substrate, thereby forming at least two types of resin portions, the concave/convex portions without regularity can be formed on the surface of the resin layer. Consequently, the reflector with satisfactory reflection characteristic without moire caused by interference of light can be obtained.

The invention according to claim 41 is the reflector according to claim 37, wherein the at least two types of resin portions have shrinkage factors differing from each other.

This facilitates formation of the concave/convex portions on the surface of the resin layer.

The invention according to claim 42 is a reflective display panel characterized by comprising: the reflector according to claim 37; and light control means provided on the reflector, for controlling amount of absorbed light.

Thereby, minute concave/convex shape can be formed on the surface of the reflector, and as a result, the reflective display panel having satisfactory reflection characteristic can be obtained.

The invention according to claim 43 is the reflective display panel according to claim 42, wherein the resin portions are comprised of photosensitive resin.

The invention according to claim 44 is the reflective display panel according to claim 42, wherein an active element is further formed on the substrate and covered by the resin layer, the resin layer is provided with a contact hole reaching the active element, and the active element is electrically connected to the reflective member through the contact hole.

Thereby, the aperture (contact hole) penetrating the resin layer can be formed, and the active element provided on the substrate can be connected to the electrode on the resin layer through the aperture to allow voltage being applied onto the reflective member on the resin layer to be controlled. Thus, display operation of the reflective display panel can be performed by using the active elements on the substrate.

The invention according to claim 45 is a method of manufacturing a reflector comprising: a substrate; a resin layer formed on the substrate and having minute concave/convex portions on a surface thereof; and a reflective member provided on the resin layer, for reflecting light, wherein the resin layer is provided with the concave/convex portions obtained by dispersing and holding at least two types of resin portions, characterized by comprising the steps of: creating a mixed solution including at least two types of resins; applying the mixed solution over the substrate; phase-separating the resins contained in the mixed solution applied over the substrate to form the resin layer having concave/convex portions on the surface thereof; and forming a reflective member on the resin layer.

This method makes it possible that the resin layer having the concave/convex portions on the surface is formed in one step, and the reflector without regularity of the concave/convex portions and moire is formed.

### BRIEF DESCRIPTION OF THE DRAWINGS

FIG. 1 is a view showing a concept of the present invention;

FIG. 2 is a view showing a concept of the present invention;

FIG. 3 is a cross-sectional view showing main portions of a reflective liquid crystal display according to an embodiment 1-1;

FIG. 4 is a partially enlarged cross-sectional view of FIG. 3;

FIG. 5 is a view showing steps of manufacturing the liquid crystal display according to the embodiment 1-1;

FIG. 6 is a view showing steps of manufacturing a gate electrode and a circular pattern layer 5′;

FIG. 7 is a plan view of a mask 21;

FIG. 8 is a plan view of a mask 27;

FIG. 9 is a view showing steps of manufacturing circular patterns 16′;

FIG. 10 is a plan view of a mask 31;

FIG. 11 is a view showing steps of manufacturing a signal line 18b and source and drain electrodes 18a;

FIG. 12 is a view showing arrangement of a device for evaluating reflection characteristic of a reflective electrode;

FIG. 13 is a view showing a reflection characteristic of a reflector according to the embodiment 1-1;

FIG. 14 is a view showing a reflection characteristic of the conventional reflector;

FIG. 15 is a cross-sectional view showing main portions of a reflective liquid crystal display according to an embodiment 1-2;

FIG. 16 is a partially enlarged cross-sectional view of FIG. 15;

FIG. 17 is a view showing steps of manufacturing the reflective liquid crystal display according to the embodiment 1-2;

FIG. 18 is a cross-sectional view showing main portions of a reflective liquid crystal display according to an embodiment 1-3;

FIG. 19 is a partially enlarged cross-sectional view of FIG. 18;

FIG. 20 is a view showing steps of manufacturing a reflective liquid crystal display according to an embodiment 1-3;

FIG. 21 is a view showing a reflection characteristic of the reflector according to the embodiment 1-3;

FIG. 22 is a cross-sectional view showing main portions of a reflective liquid crystal display according to an embodiment 1-4;

FIG. 23 is a partially enlarged cross-sectional view of FIG. 22;

FIG. 24 is a view showing steps of manufacturing a reflective liquid crystal display according to the embodiment 1-4;

FIG. 25 is a cross-sectional view showing main portions of a reflective liquid crystal display according to an embodiment 1-5;

FIG. 26 is a partially enlarged cross-sectional view of FIG. 25;

FIG. 27 is a cross-sectional view showing main portions of a reflective liquid crystal display according to an embodiment 1-6;

FIG. 28 is a partially enlarged cross-sectional view of FIG. 27;

FIG. 29 is a view showing steps of manufacturing a reflective liquid crystal display according to the embodiment 1-6;

FIG. 30 is a cross-sectional view showing main portions of a reflective and transmissive liquid crystal display according to an embodiment 1-7;

FIG. 31 is a cross-sectional view showing main portions of a reflective and transmissive liquid crystal display according to an embodiment 1-8;

FIG. 32 is a cross-sectional view showing main portions of a reflective liquid crystal display according to an embodiment 1-9;

FIG. 33 is a partially enlarged view of FIG. 32;

FIG. 34 is a view showing steps of manufacturing a reflective liquid crystal display according to an embodiment 1-9;

FIG. 35 is a cross-sectional view showing main portions of a reflective liquid crystal display according to an embodiment 1-10;

FIG. 36 is a partially enlarged view of FIG. 35;

FIG. 37 is a view showing steps of manufacturing a reflective liquid crystal display according to the embodiment 1-10;

FIG. 38 is a cross-sectional view showing contact holes 70A, 70B and their vicinity;

FIG. 39 is a cross-sectional view showing main portions of a reflective liquid crystal display according to an embodiment 1-11;

FIG. 40 is a cross-sectional view showing main portions of the reflective liquid crystal display according to an embodiment 1-12;

FIG. 41 is a view showing steps of manufacturing a reflective liquid crystal display according to the embodiment 1-12;

FIG. 42 is a view showing steps of manufacturing the reflective liquid crystal display according to the embodiment 1-12;

FIG. 43 is a cross-sectional view showing main portions of a reflective liquid crystal display according to an embodiment 1-13;

FIG. 44 is a plan view showing part of a common electrode observed from above;

FIG. 45 is a plan view showing part of a modification of the common electrode;

FIG. 46 is a plan view showing part of another modification of the common electrode;

FIG. 47 is a view showing steps of manufacturing a reflective liquid crystal display according to an embodiment 1-14;

FIG. 48 is a view showing steps of manufacturing the reflective liquid crystal display of the embodiment 1-14;

FIG. 49 is a plan view showing a mask used in manufacturing a reflective liquid crystal display according to an embodiment 1-15;

FIG. 50 is a partly schematic view of a substrate constituting a reflective liquid crystal display according to an embodiment 1-16, in which FIG. 50(a) is a plan view showing a shape of a gate metal layer formed on the substrate, and FIG. 50(b)is a cross-sectional view taken in the direction of arrows substantially along line X-Y of FIG. 50(a);

FIG. 51 is a schematic view of a mask used in the embodiment 1-16;

FIG. 52 is a schematic view showing patterns of a gate metal layer and a semiconductor layer formed on the substrate, in which

FIG. 52(a) is a schematic plan view and FIG. 52(b) is a cross-sectional view taken in the direction of arrows substantially along line X-Y of FIG. 52(a);

FIG. 53 is a schematic view showing patterns with the gate metal layer and the semiconductor layer deviating on the substrate when mask misalignment occurs within a range of a margin δ in mask alignment from the state in FIG. 52, in which FIG. 53(a) is a schematic plan view thereof and FIG. 53(b) is a cross-sectional view taken in the direction of arrows substantially along line X-Y of FIG. 53(a);

FIG. 54 is a schematic plan view of the substrate when the mask misalignment is 0 and the mask misalignment is δ;

FIG. 55 is a cross-sectional view taken in the direction of arrows substantially along line X-Y of FIG. 54;

FIG. 56 is a graph showing a reflection characteristic;

FIG. 57 is a graph showing inclination angle distribution;

FIG. 58 is a schematic view showing a shape of a pattern layer comprised of a gate metal layer in a region where a concave/convex plane is formed, after formation of a gate insulating film layer, in which FIG. 58(a) is a plan view showing the shape of the pattern layer and FIG. 58(b) is a cross-sectional view taken in the direction of arrows substantially along line X-Y of FIG. 58(a);

FIG. 59 is a schematic plan view of a mask used in an embodiment 1-17;

FIG. 60 is a schematic view of a substrate provided with a pattern layer comprised of the semiconductor layer in a region where a concave/convex plane is formed, in which FIG. 60(a) is a schematic plan view of the substrate after the patterning step of the semiconductor layer, and FIG. 60(b) is a cross-sectional view taken in the direction of arrows substantially along line X-Y of FIG. 60(a);

FIG. 61 is a schematic view of another mask used in the embodiment 1-17;

FIG. 62 is a graph in which comparison is made between the reflection characteristic of a reflector without overlapping portion and the reflection characteristic of the reflector illustrated in the embodiment 1-17;

FIG. 63 is a plan view of an array substrate constituting a liquid crystal display panel according to an embodiment 2-1;

FIG. 64 is a schematic view of a concave/convex structure on the array substrate;

FIG. 65 is a partially cross-sectional view of the array substrate;

FIG. 66 is a plan view of another structure of the array substrate constituting the liquid crystal display panel according to the embodiment 2-1;

FIG. 67 is a schematic view showing another structure of the array substrate;

FIG. 68 is a cross-sectional view schematically showing a reflective display panel according to an embodiment 3-1 of the present invention;

FIG. 69 is an explanatory view schematically showing a step of forming a resin layer of the reflective display panel according to the embodiment 3-1 of the present invention;

FIG. 70 is an explanatory view schematically explaining how the resin layer of the reflective display panel is formed;

FIG. 71 is an explanatory view schematically explaining how an concave/convex shape of a surface of the resin layer of the reflective display panel is formed;

FIG. 72 is an explanatory view schematically showing steps of forming a resin layer of a reflective display panel according to an embodiment 3-2 of the present invention;

FIG. 73 is an explanatory view showing a reflective direction of light on a reflective member of the reflective display panel, in which FIG. 73(a) is an explanatory view showing a reflective direction of light on a reflective member having minute concave/convex portions and FIG. 73(b) is an explanatory view showing a reflective direction of light on a reflective member having mirroring characteristic; and

FIG. 74 is an explanatory view showing a constitution of the conventional reflective display panel.

### BEST MODE FOR CARRYING OUT THE INVENTION

### First Invention Group

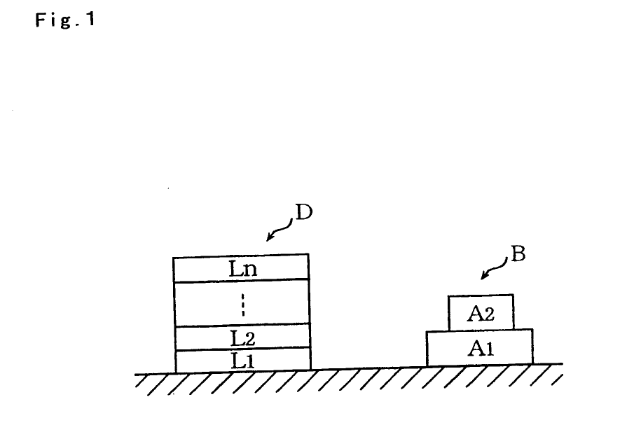

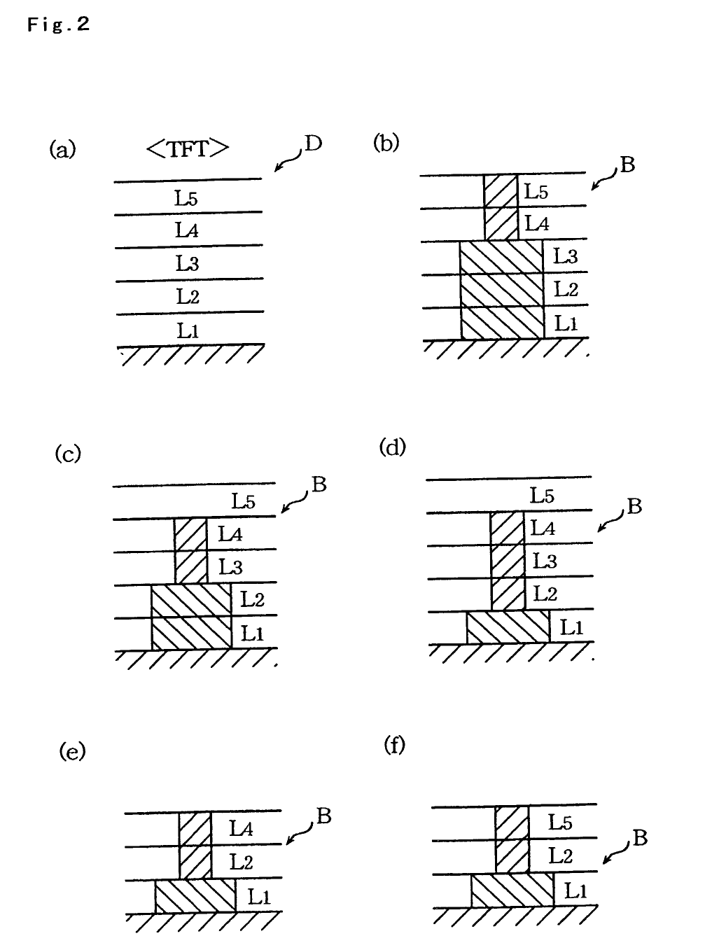

FIGS. 1, 2 are views showing a concept of the present invention. For easier understanding of the present invention, a technical concept of the present invention will be first described with reference to FIGS. 1, 2, and embodiments will be then described in detail. Hereinafter, in description of the embodiments below, a thin film is referred to as a column-shaped body and a cumulated layer pattern is referred to as a step-like structure.

The present invention is characterized in that in a reflector provided with active elements and a concave/convex reflective electrode on an insulating substrate, step-like structures as a base of convex portions of the concave/convex reflective pixel electrode are formed in the step of forming the active elements. As shown in FIG. 1, when a step-like structure B is comprised of, for example, a first column-shaped body A1 and a second column-shaped body A2, the second column-shaped body A2 has a width smaller than that of the first column-shaped body A1. The layers composing the column-shaped bodies A1, A2, are selected from layers L1, L2, . . . , Ln1 composing an active element D. Also, the layers composing the column-shaped bodies A1, A2, are selected from one or more of the layers L1, L2, . . . , Ln1 composing the active element D. It should be noted that the order in which the column-shaped bodies A1, A2 are disposed is the same as the order in which the layers L1, L2, . . . , Ln composing the active element D are disposed, but all the layers L1. L2, . . . Ln are not necessarily used.

The step-like structure B is manufactured by a method of performing layer forming and patterning twice, i.e., layer forming and patterning of the first column-shaped body A1, and then layer forming and patterning of the second column-shaped body A.

Further, with reference to FIG. 2, an example in which the layers composing the active element D are L1, L2, . . . L5 (see FIG. 2(a)) will be described. In this case, if one or more of L1, L2, . . . L5 are selected and forming and patterning are each conducted twice, then various combinations are possible as shown in FIGS. 2(b)-2(f). Accordingly, in the present invention, by controlling the number of column-shaped bodies, the number of layers of the column-shaped bodies, and the patterning width of the column-shaped bodies, the shape of the step-like structure can be controlled. Consequently, the concave/convex shape of the reflective electrode can be controlled with high precision.

It should be appreciated that the concave/convex portions may be formed on the insulating substrate itself as part of the step-like structures. While in the above example, the step-like structure is comprised of two column-shaped bodies, the present invention may be applied to the step-like structure comprised of three or more column-shaped bodies.

Now, the embodiments of the present invention will be described with reference to FIGS.

### Embodiment 1-1

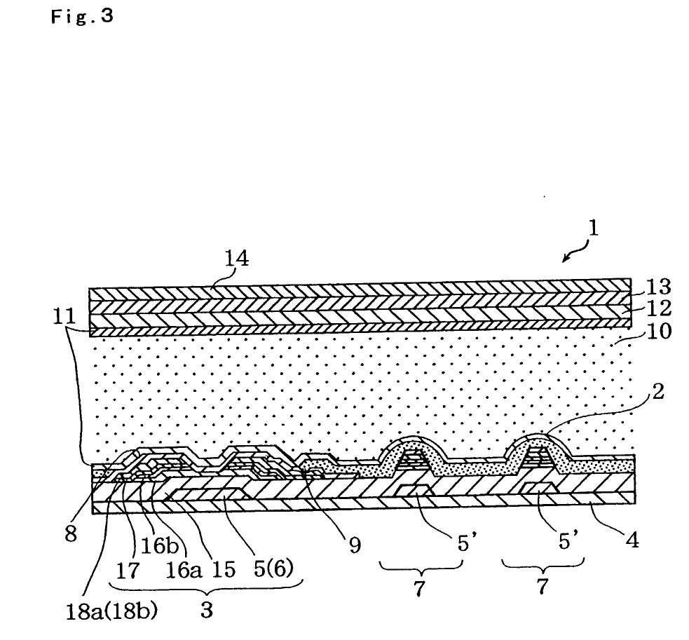

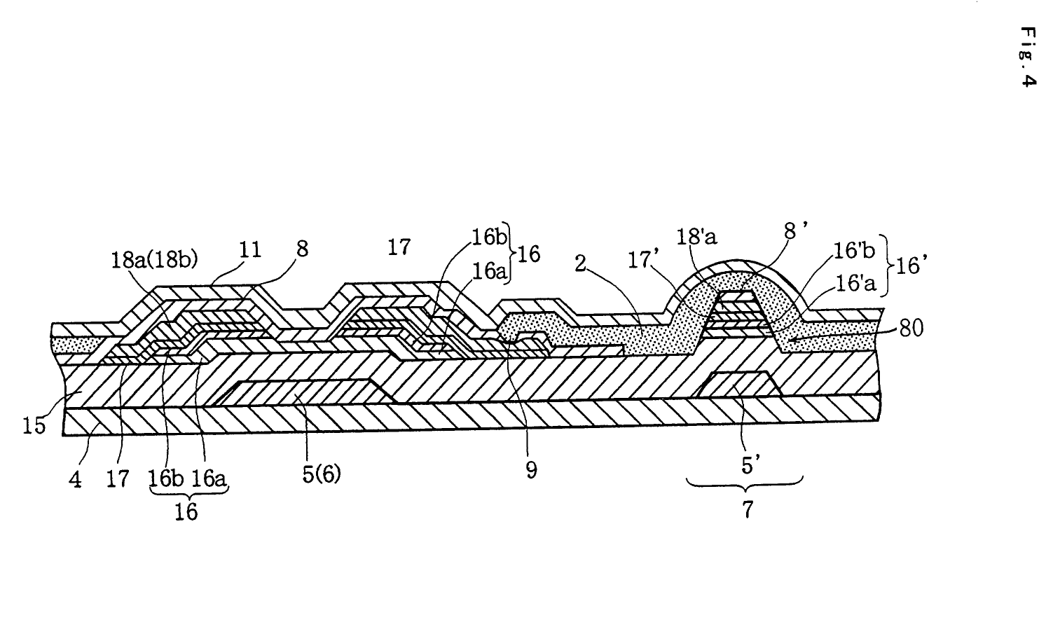

FIG. 3 is a cross-sectional view showing main portions of a reflective liquid crystal display according to an embodiment 1-1 and FIG. 4 is a partially enlarged cross-sectional view thereof. A reflective liquid crystal display 1 comprises an array substrate (corresponding to a reflector) R, an opposing substrate 14 (display-surface side) made of glass or the like, and a liquid crystal layer 10 interposed between the array substrate R and the opposing substrate 14. The array substrate R comprises TFTs 3 as an active element, gate lines 6, signal lines 18b, and step-like structures 80 (see FIG. 4), which are disposed on an insulating substrate 4 made of glass or the like. The TFT 3 comprises a gate electrode 6, a gate insulating film layer 15, a semiconductor layer 16 comprised of an amorphous silicon layer 16a and an impurity layer (n+layer) 16b, an inter-layer insulating film layer 17, source and drain electrodes 18a, a signal line 18b, and a first insulating film layer 8 (corresponding to a passivation film layer). The step-like structure 80 is formed in a region of the insulating substrate 4 where a concave/convex plane is formed and has width reduced from its base end to its tip end. The step-like structure 80 is comprised of the layers of the gate electrode 5, the gate insulating film layer 15, the semiconductor layer 16, the inter-layer insulating film layer 17, the source and drain electrodes 18a, and the first insulating film layer 8. The layers of the step structure 80 are circular in cross sections (To distinguish between the layers composing the TFT 3 and the layers composing the step-like structure 80, the layers of the step-like structure 80 are referred to as circular pattern layers as necessary. Among the circular pattern layers, the layers corresponding to the layers of the TFT are represented by both reference numerals and “′”. For example, the circular pattern layer corresponding to the layer of the gate electrode 6 of the TFT is represented by reference numeral 6′. Also, the circular pattern layer corresponding to the semiconductor layer 16 of the TFT is represented by reference numeral 16′). A concave/convex reflective electrode 2 is provided over the step-like structures 80. An alignment layer 11 is formed over the reflective electrode 2, the TFT 3, and the like. The reflective electrode 2 is electrically connected to the source and drain electrodes 18a through a contact hole 9.

Color filters 13, a transparent electrode 12, and the alignment layer 11 are disposed on an inner surface of the opposing substrate 14.

Subsequently, a method of manufacturing the reflective liquid crystal display will be described.

### First Step

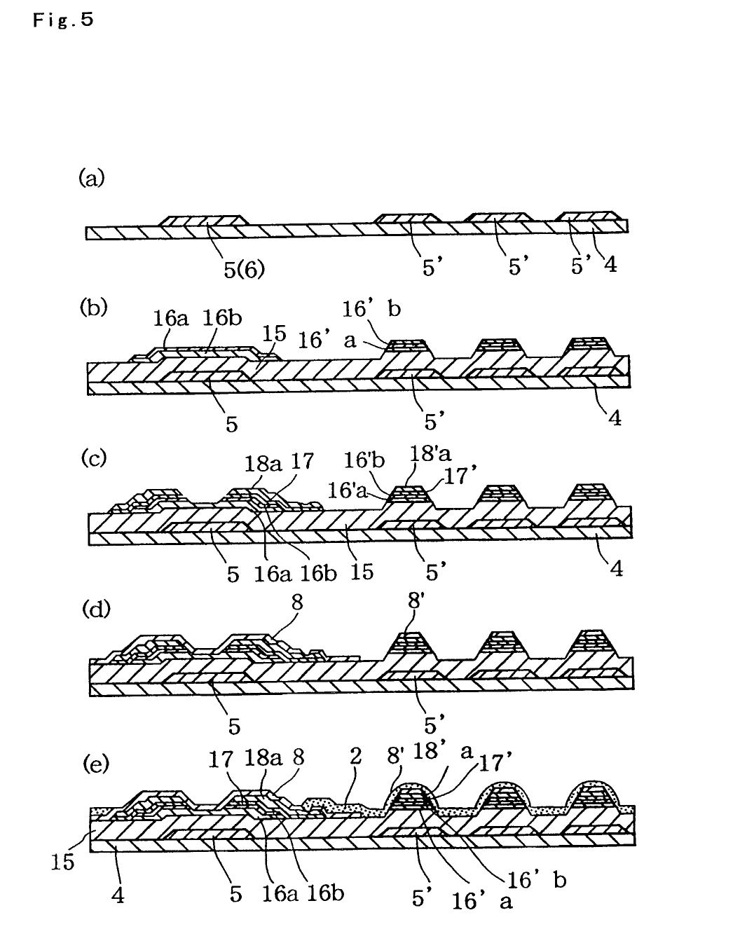

As shown in FIG. 5(a), the gate line 6 and the gate electrode 5 are formed in a region on the insulating substrate 4 where the TFT is formed, and a circular pattern layer 5′ made of the same material as the gate line 6 and the gate electrode 5 is formed in a region 7 on the insulating substrate 4 where concave/convex plane is formed.

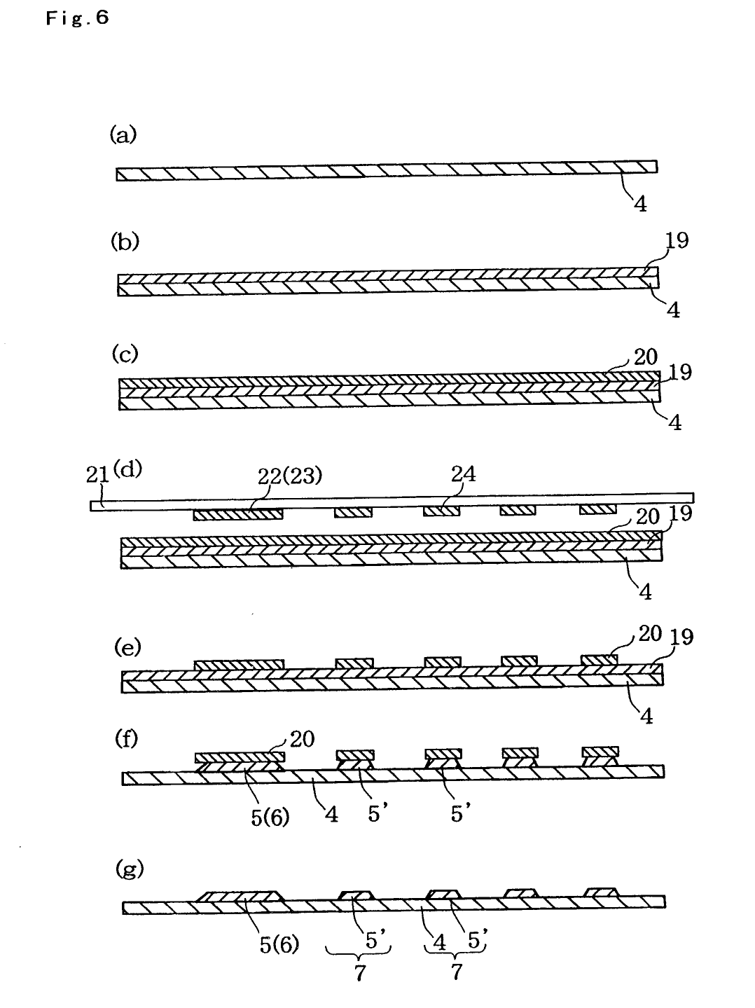

A method of manufacturing the circular pattern layer 5′ will be described in greater detail with reference to FIG. 6. A metal layer 19 made of aluminum or chromium is formed on the insulating substrate 4 by sputtering or the like (FIG. 6(b)). Then, a photosensitive resin layer 20 made of positive photosensitive resin is formed on the metal layer 19 by spin coating or the like (FIG. 6(c)).

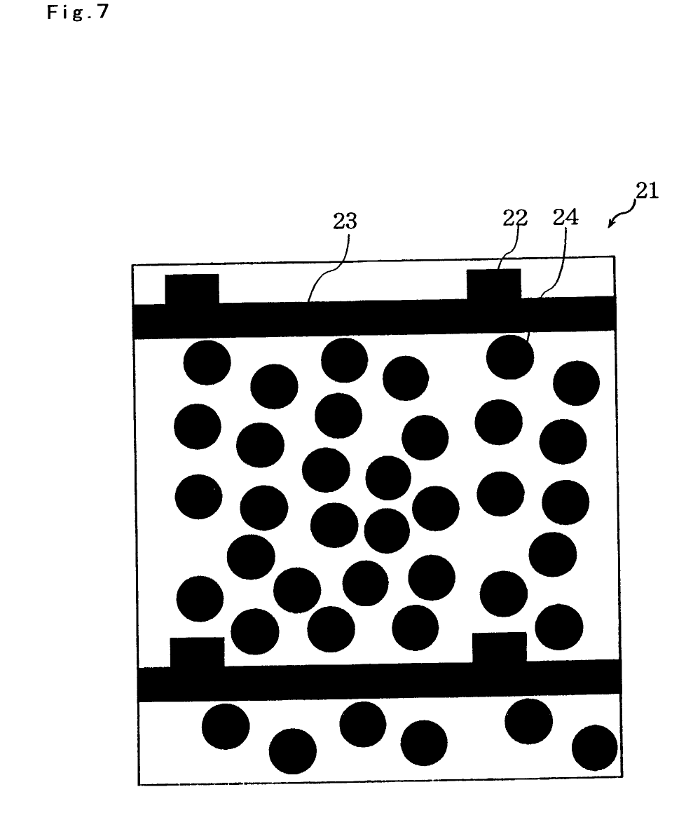

Following this, exposure is conducted by using a mask 21 (FIG. 6(d)). The mask 21 is, as shown in FIG. 7, provided with gate line patterns 22, gate electrode patterns 23, and a plurality of circular patterns 24. These are made of light-blocking material, e.g., chromium and aluminum.

After the exposure using the mask 21, development is conducted.

This results in the photosensitive resin layer 20 having predetermined patterns (FIG. 6(e)).

After patterning of the photosensitive resin layer 20 by the above-mentioned method, the metal layer 19 is etched (FIG. 6(f)). After etching of the metal layer 19, the photosensitive resin layer 20 is peeled by using peeling agent, thereby forming the gate line 6, the gate electrode 5, and the circular pattern layer 5′ which are comprised of the same metal layer, on the insulating substrate 4 (FIG. 6(g)). The etching for patterning is favorably conducted under conditions for obtaining taper shape. This can improve adhesion between the circular pattern layer 5′, the gate line 6, and the gate electrode 5, and a gate insulating film layer 15 formed later over these layers.

### Second Step

Subsequently, the gate insulating film layer 15 is formed over the gate line 6 and the gate electrode 5, and the circular pattern layer 5′.

### Third Step

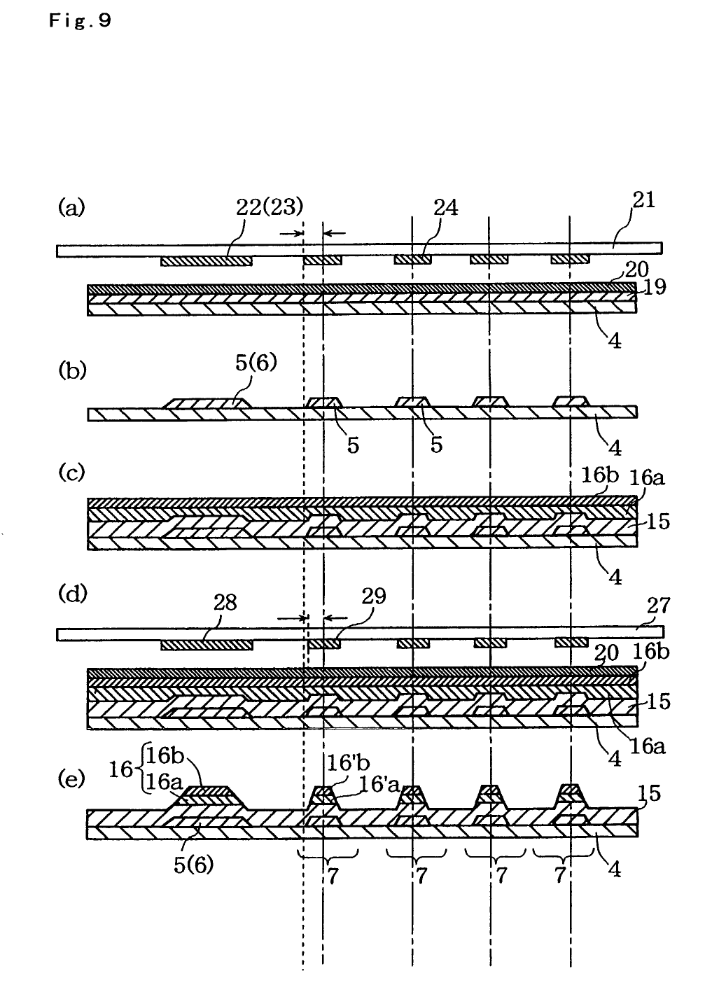

Then, a semiconductor layer 16 is formed. When the thin film transistor is used as the active matrix element 3, the amorphous silicon layer 16a is formed by plasma CVD or the like on the gate insulating film layer 15 formed in second step (FIG. 9(c)). In this step, an impurity layer 16b may be formed on the amorphous silicon layer 16a (FIG. 9(c)). Also, the gate insulating film layer 15 on the gate electrode 5 may be formed continuously with the semiconductor layer 16 (FIG. 9(c)).

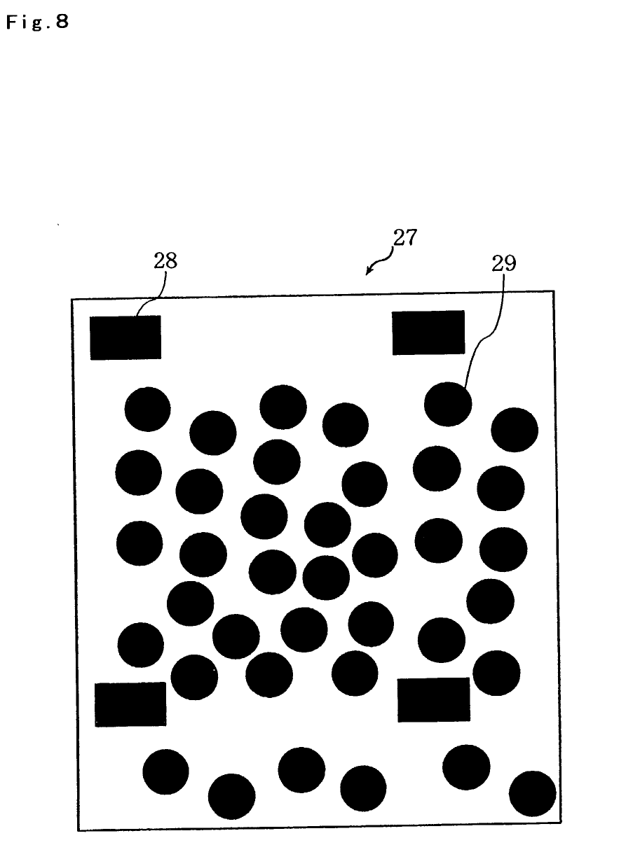

After formation of the semiconductor layer 16 in series, patterning is conducted again. At this time, as in the first step, the positive photosensitive resin layer is formed by spin coating or the like, and then exposure is conducted by using a mask 27 provided with patterns of FIG. 8 (FIG. 9(d)). The mask 27 of FIG. 8 includes semiconductor cumulated layer patterns 28 and circular patterns 29. The relationship between the mask pattern 21 of FIG. 7 and the mask pattern 27 of FIG. 8 is illustrated in FIG. 9. When mask alignment is made by using alignment mark, as shown in FIG. 9, the circular patterns of FIG. 7 and the circular patterns of FIG. 5 are designed so that their centers are located to coincide with each other. The difference between the masks 21, 27 is a radius of the circular patterns. Specifically, the circular patterns of the mask 27 in FIG. 8 are smaller in radius than the circular patterns of the mask 21 in FIG. 7. As a result, as shown in FIG. 9(e), after etching, a circular pattern layer 16′ (circular pattern layer 16a′ and circular pattern layer 16b′) formed of the semiconductor layer 16 (amorphous silicon layer 16a and the impurity layer 16b) becomes smaller than the circular pattern layer 5′ of the metal layer 19 made of the material of the gate electrode 19.

### Fourth Step

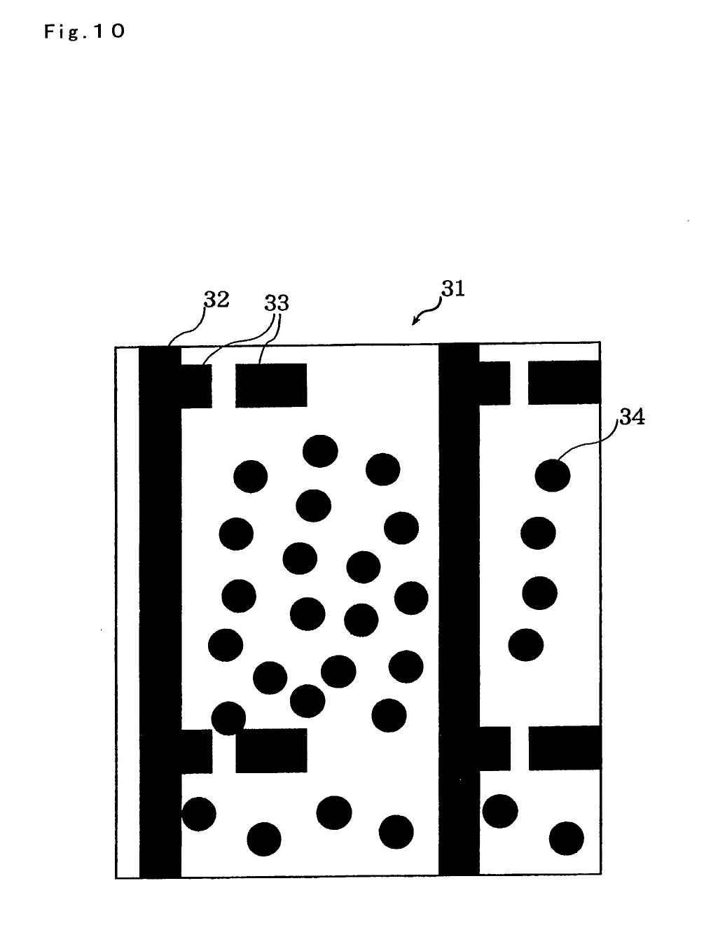

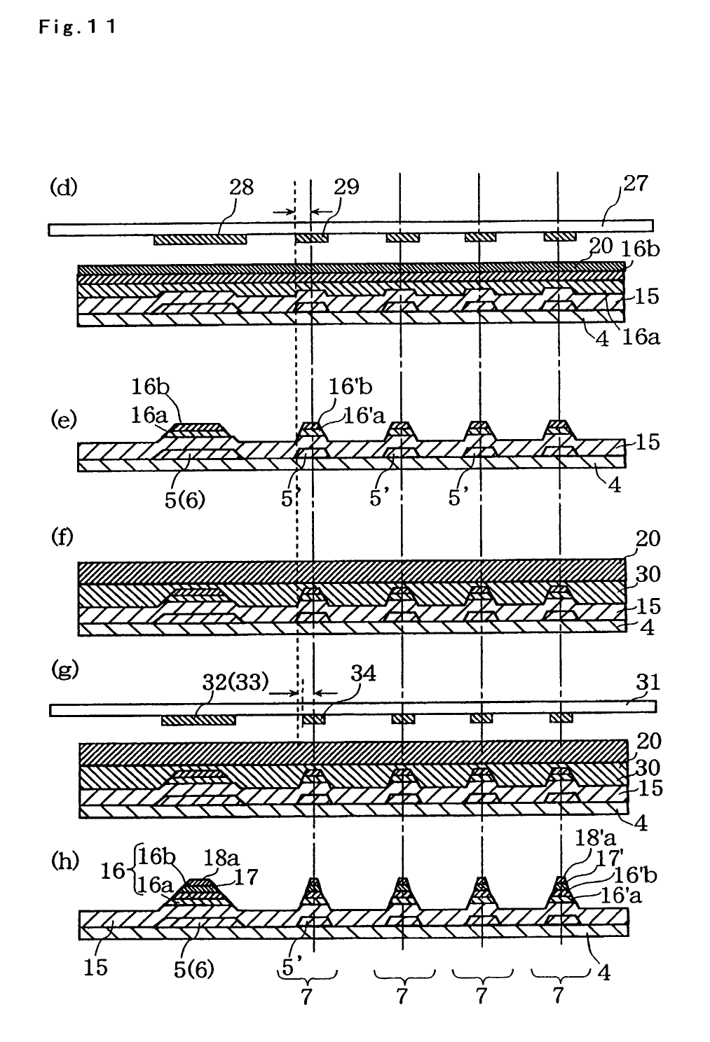

In fourth step, after forming the inter-layer insulating film layer 17,the metal layer 30 is formed by sputtering or the like for the purpose of formation of the signal line 18b and the source and drain electrodes 18a, and then, as in the first and third steps, the positive photo sensitive resin 20 is formed (FIG. 11(f)). Thereafter, by using a mask 31 provided with patterns in FIG. 10, exposure and development are conducted (FIG. 11(g)). Further, the metal layer 30 is patterned by a process using dry etching such as RIE, thereby forming a circular pattern layer 17′ and a circular pattern layer 18a′. The mask 31 needs to be designed to have the relationship in FIG. 11. Specifically, the centers of the circular patterns 31 are located to coincide with the centers of the circular patterns of the masks 21, 27, but the circular patterns 31 are smaller in size than the circular patterns of the masks 21, 27. Thus, the masks 31, 21, and 27 are designed so that the centers of the circular patterns lie at the same positions but the radiuses of the circular patterns become smaller in the order of the mask 31, the mask 27 and the mask 21, thereby obtaining the step-like circular pattern layers as shown in FIG. 11(h).

### Fifth Step

After formation of the insulating film layer 8, the positive photosensitive resin is formed and patterned by using the mask as in the third step, for forming the contact hole 9 through which the source and drain electrodes 18a are electrically connected. Further, patterning of the first insulating film layer 8 and formation of the contact hole 9 are carried out by etching or the like (FIG. 5(d)).

### Sixth Step

In sixth step, the reflective electrode 2 is formed by a process such as sputtering, followed by patterning by photolithography. As a result, a circular pattern layer 8′ is formed on a circular pattern layer 18a′.

As shown in FIG. 5(e), the reflective electrode formed through the first to sixth steps have concave/convex shape so as to conform in shape to the plurality of step-like structures, and therefore has the concave/convex shape. Further, since the upper layers become smaller in the step-like structure, area ratio of flat portions to the concave/convex shape can be made smaller than those of the reflective electrodes described in Japanese Laid-Open Patent Application Publication Nos. Hei. 9-54318, 11-133399, 11-258596, and the like.

Meanwhile, as disclosed in Patent Publication No. 2756206, in the step of forming concave/convex portions on the substrate provided with active elements on the surface thereof by using photosensitive resin, one step corresponding to a series of photolithography processes including application of photosensitive resin, exposure and development through mask, etc, is increased, which leads to increased fixed costs of photosensitive resin, developing agent, and mask manufacture. Also, reduced yield in the entire steps, and increased tact time lead to increased cost. On the other hand, in accordance with the embodiment 1, the manufacturing cost can be reduced because of absence of the above photolithography process in contrast with the manufacturing method disclosed in Patent Publication No.2756206.

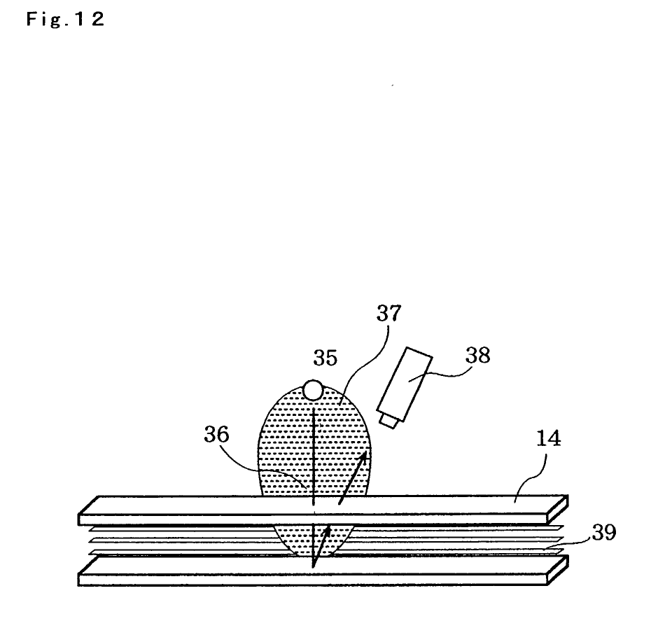

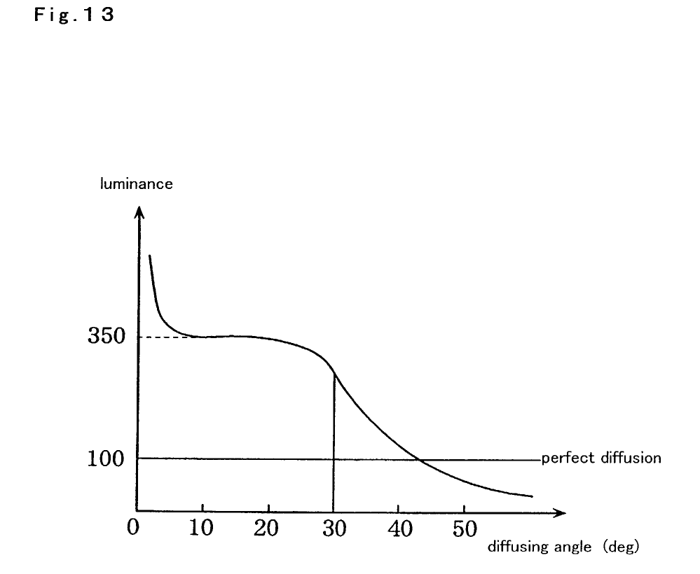

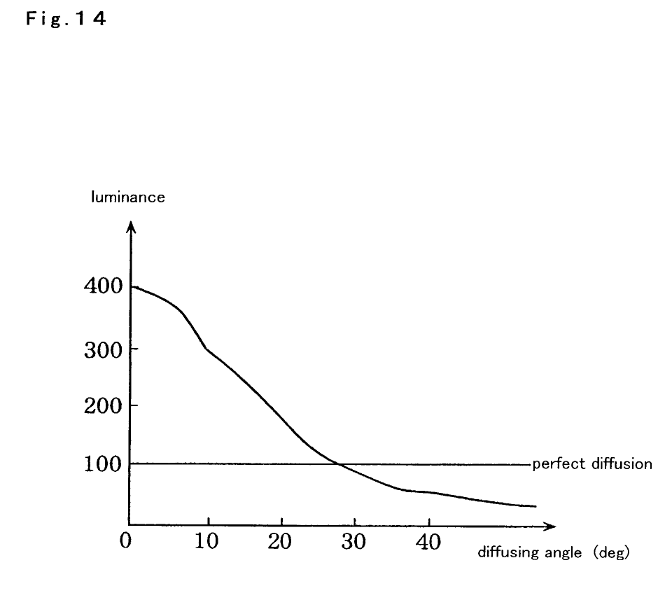

Here, a method of evaluating the reflection characteristic of the reflective electrode 2 manufactured through the above steps will be described. Only the reflector was manufactured and evaluation of the reflective electrode 2 was conducted. Specifically, as shown in FIG. 12, white light 36 from a parallel light source 35 is made incident and intensity 77 of reflected light (in this embodiment, intensity of diffused light) is measured by a luminance meter 38. In this case, the light source 35 is placed in normal direction of the substrate 4 provided with the reflective electrode 2 and measurement is conducted while rotating the luminance meter to be kept at equidistanct from the center of a circle plane where the incident light cross the horizontal plane of the reflective electrode. Besides, for the purpose of reproducing reflection characteristic of an actual liquid crystal display, an opposing substrate 14 is placed to interpose a layer which generally has refractive index of approximately 1.5 between them. The measurements are illustrated in FIG. 13. Likewise, FIG. 14 shows evaluations of the reflection characteristics of the reflective electrodes described in Japanese Laid-Open Patent Application Publication Nos. Hei. 9-54318, 11-13399, and 11-258596. In FIGS. 13, 14 showing these reflection characteristics, lateral axis indicates diffusing angle (measurement angle by the luminance meter with respect to normal direction of the substrate) and longitudinal axis indicates intensity of diffused light, in which case, the unit is arbitrary. As evident from FIGS. 13, 14, in the reflective electrode of this embodiment, the reflection characteristic exhibits almost constant and higher intensity in a range of wide diffusing angles around the diffusing angle at which the regular reflection of the incident light from the parallel light source is observed. As should be appreciated from the foregoing, it was possible to manufacture the reflective electrode with satisfactory luminance in the range of wide diffusing angles in this embodiment.

Further, reflection characteristic of a substrate with plural reflective electrodes was observed. The result was that peeling or crack of reflective metal layer was hardly observed.

### Seventh Step

On the insulating substrate which has undergone the first through sixth steps, polyimide-based-polymer material or polyamic-acid-based polymer material for aligning liquid crystal molecules, is applied over the reflective electrode and calcined. Then, a transparent substrate provided with a transparent electrode and color filters and an insulating substrate comprising the active matrix elements and the reflective electrode are bonded to each other as spaced by resin spacer so as to have a certain gap between the substrates, and liquid crystal material is filled into the gap. Further, through packaging of a drive circuit or the like, the reflective liquid crystal display is manufactured.

By using the liquid crystal display manufactured by the above method, a video signal was input and an image was displayed under ambient light. Unsatisfactory display such as flicker was not observed. Also, the voltage of the video signal was regulated and contrast was evaluated from the ratio between a minimum value and a maximum value of luminance under certain ambient light. The values almost equal to those of the liquid crystal panel which is simply matrix-driven were obtained.

The evaluation was conducted for the reflective liquid crystal display using a retardation film and one polarizer as an optical film and TN liquid crystal material as liquid crystal material. Alternatively, guest host liquid crystal material using pigment having two colors may be used without the polarizer.

Also, the video signals for white display and black display were input to the reflective liquid crystal display and contrast was measured by SCE. As a result, display quality more satisfactory than that of the conventional reflective liquid crystal display was obtained.

### Embodiment 1-2

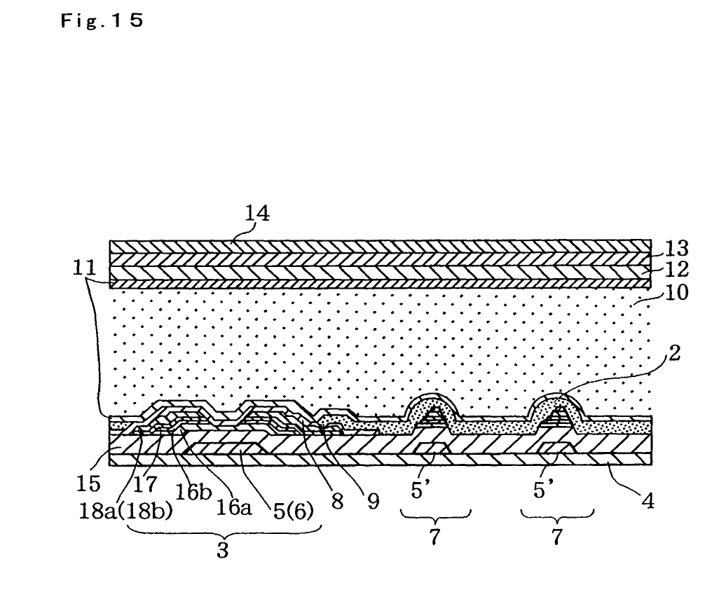

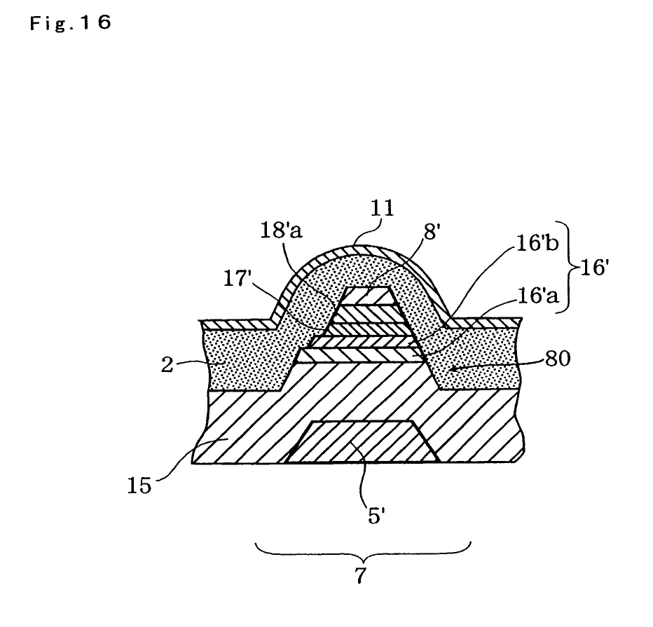

FIG. 15 is a cross-sectional view showing main portions of a reflective liquid crystal display according to an embodiment 1-2. FIG. 16 is a partially enlarged cross-sectional view of FIG. 15. The same or corresponding parts in the embodiment 1-2 are identified by the same reference numerals as those in the embodiment 1-1. The embodiment 1-2 differs from the embodiment 1-1 in that circular pattern layers provided in the step-like structure are asymmetrical. The structure is formed for the following reasons.

In evaluation process of the reflective liquid crystal display in the embodiment 1-1, new problems arise. There is a luminance peak in the direction in which light from the light source is incident. When observer sees an image in such a reflective liquid crystal display, white luminescent point apparently exists at the center of the observer's vision, and therefore affects the other portion. It became necessary to shift the luminescent point toward as apart from the center as possible. To solve this, it is necessary to shift the entire inclination angle distribution toward larger angles. Accordingly, by asymmetrically providing the layers in the step-like structures, the regular reflection direction can be shifted away from the center of the viewing angle of the observer, and as a result, satisfactory display quality is obtained.

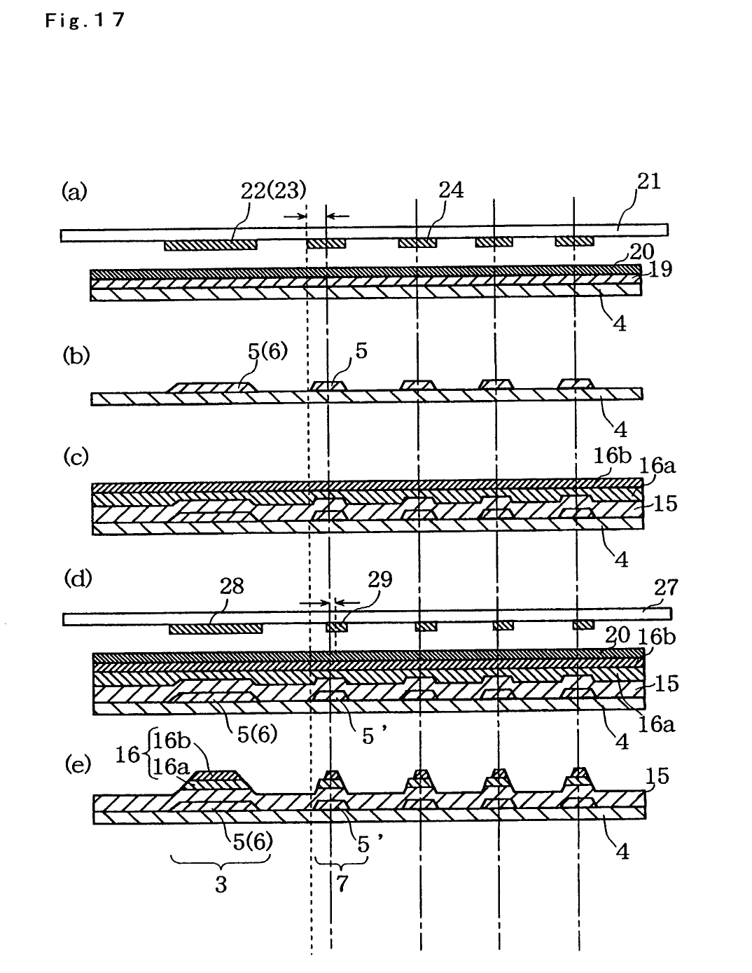

Subsequently, a method of manufacturing a reflective liquid crystal display 39 according to the embodiment 1-2 will be described. Herein, the manufacturing steps similar to those of the embodiment 1-1 are performed, but the pattern shape of the mask 40 used in the photolithography process in the respective steps is different. The pattern of the mask 40 will be described with reference to FIG. 17. As in FIGS. 7, 8, 10, the circular patterns are formed, but differently from the embodiment 1, the centers of the circles are not located at the same positions but deviate as shown in FIG. 17, thereby obtaining an asymmetric shape in the layers. Using the mask 40, forming and patterning of the layers constituting the TFT device 3 are repeated, thereby forming the reflective electrode in the uppermost layer.

The reflection characteristic of the reflective electrode manufactured in the aforementioned steps was evaluated by the evaluation method using the evaluation device in FIG. 12, similarly to the embodiment 1-1. As a result, the reflection characteristic of the reflective electrode according to the embodiment 1-2 was deflected, and therefore, the luminance peak was not observed in the direction in which the light from the light source is incident, i.e., at an angle at which the regular reflection should be observed.

The alignment layer was formed on the reflector according to the embodiment 1-2, and the reflector and the transparent electrode substrate with color filters, which is provided with the alignment layer, were bonded, and then the liquid crystal material was filled. Further, packaging process of configuration of the peripheral drive circuit was carried out, thereby manufacturing the reflective liquid crystal display 39. Contrast of the reflective liquid crystal display 39 was measured by using the evaluation device of FIG. 12 and inputting white and black display signals. At the angle at which the regular reflection should be conventionally observed, the peak was not observed. Thus, by asymmetrically providing the layers in the step-like structure 80, the regular reflection direction was able to deviate away from the center of the viewing angle of the observer and satisfactory display quality was obtained.

### Embodiment 1-3

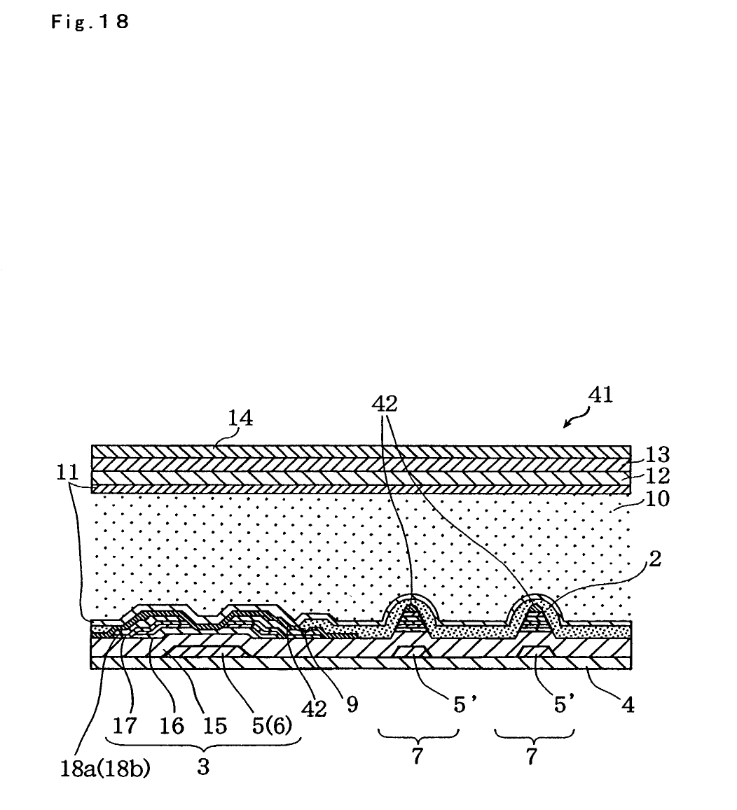

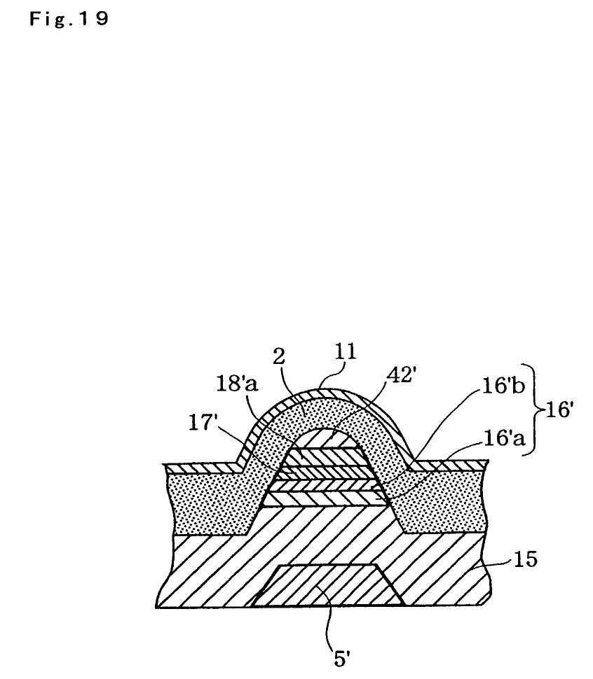

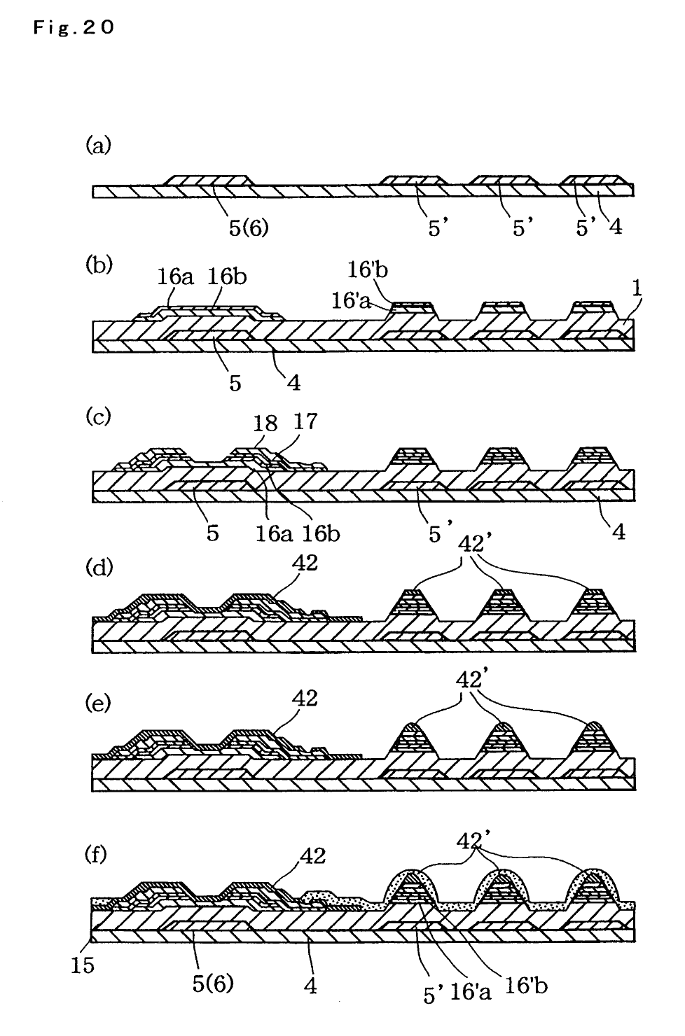

FIG. 18 is a cross-sectional view showing main portions of a reflective liquid crystal display according to an embodiment 1-3. FIG. 19 is a partially enlarged view of FIG. 18. FIG. 20 is a view showing steps of manufacturing the reflective liquid crystal display according to the embodiment 1-3. The same or corresponding parts in the embodiment 1-3 are identified by the same reference numerals as those in the embodiment 1-1. The embodiment 1-3 is characterized in that part of the first insulating film layer 8 of the layers in the step-like structure 80 is patterned, and melted and deformed to be rounded. Thereby, it is possible to obtain a reflective liquid crystal display exhibiting intensity of light that is substantially constant and high in a range of wide diffusing angles.

Subsequently, a method of manufacturing the reflective liquid crystal display 41 according to the embodiment 1-3 will be described. This method is substantially the same as the manufacturing method of the embodiment 1-1 (FIGS. 20(a)-20(f)), but the first insulating film layer 8 is replaced by an insulating film layer 42 made of material different from that of the first insulating film 8. It is preferred that the insulating film layer 42 be made of photosensitive resin comprised of organic material. It is more preferred that the insulating film. layer 42 be made of photosensitive resin, which is, after exposure and development, to be deformed by heating. The resulting shape after heating is shown in FIG. 20 (e). In the following step, metal with high reflectance is formed into film by sputtering or the like, and then the film is formed into the reflective electrode (FIG. 20(f)).

The reflective electrode manufactured through the aforementioned steps offers lower cost, because increased tact time and reduced yield are suppressed, which are caused by that fact that the photography processes are fewer than the processes in the steps described in Japanese Laid-Open Patent Application Publication No. Hei. 8-184846.

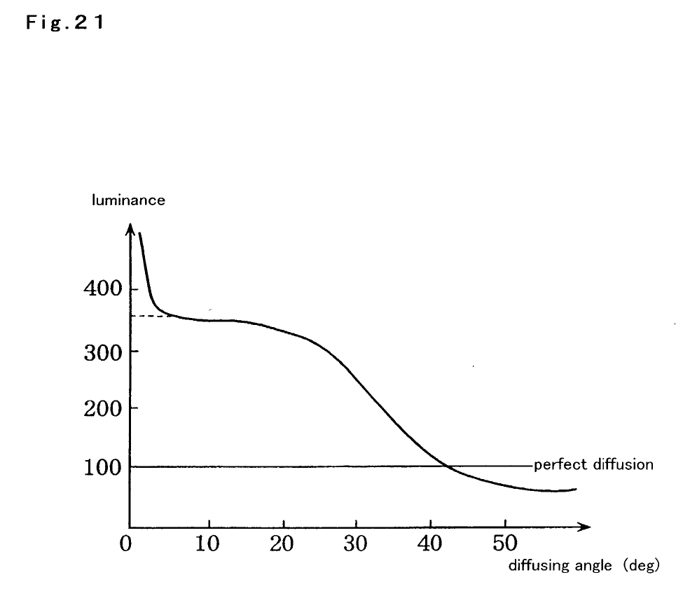

Here, a method of evaluating the reflection characteristic of the reflection electrode manufactured through the aforementioned steps will be described. The reflection characteristic was evaluated by using the evaluation device of FIG. 12 and by the method similar to the method of the embodiment 1. The result is shown in FIG. 21. As evident from FIG. 21, in the reflective electrode of the embodiment 3, the reflection characteristic exhibits almost constant and higher intensity in a range of wide diffusing angles around the diffusing angle at which the reflection characteristic of the incident light from the parallel light source is observed. As should be appreciated from the foregoing, it was possible to manufacture the reflective electrode with satisfactory luminance in the range of wide diffusing angles in this embodiment.

### Embodiment 1-4

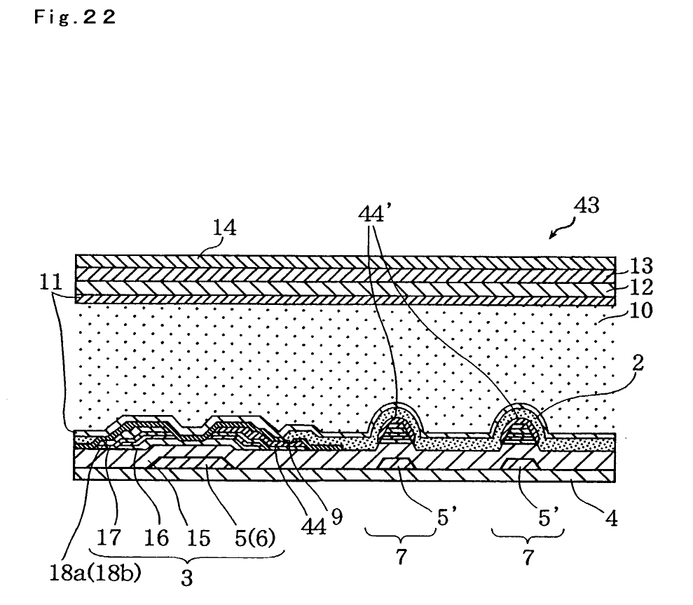

FIG. 22 is a cross-sectional view showing main portions of a reflective liquid crystal display according to an embodiment 1-4.

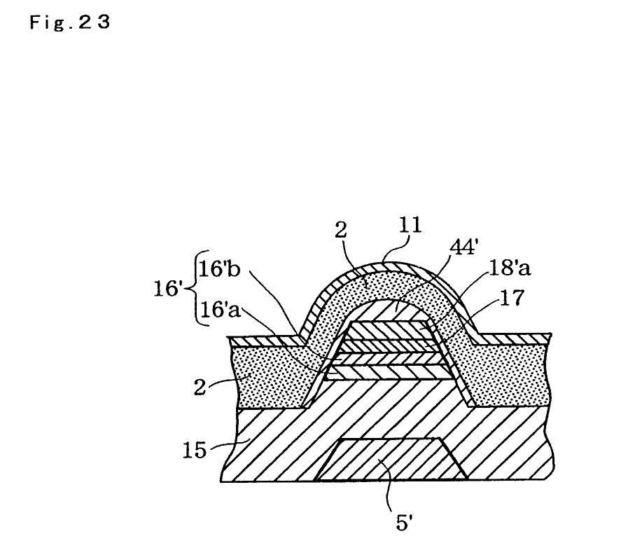

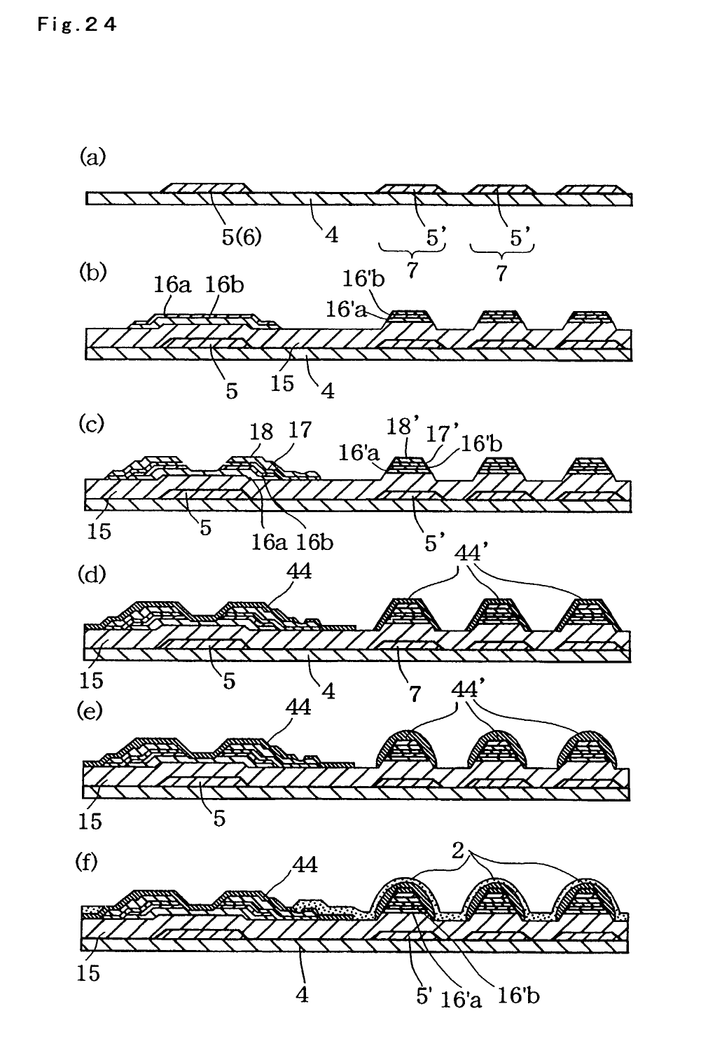

FIG. 23 is a partially enlarged view of FIG. 22. FIG. 24 is a view showing steps of manufacturing a reflective liquid crystal display according to an embodiment 1-4. The same or corresponding parts in the embodiment 1-4 are identified by the same reference numerals as those in the embodiment 1-1. The embodiment 1-4 is characterized in that part of the insulating film layer 44 of the circular pattern layers in the step-like structure 80 is patterned so as to cover the step-like structure 80. Such a structure provides the following effects.

(1) Peeling or cracks of the reflective metal layer was hardly observed.

(2) Under the ambient light, the video signal was input and the display image was observed. As a result, insufficient display such as flicker was not observed.

(3) The voltage of the video signal was regulated and the contrast was evaluated from the ratio between the minimum value and the maximum value of luminance under certain ambient light. As a result, the values almost equal to the values in the liquid crystal panel simply matrix-driven were obtained.

The reason for (1)-(3) is that the step-like structure is covered with the insulating film layer 44, and as a result, leakage by the electric field in OFF state is suppressed.

A method of manufacturing the liquid crystal display of this embodiment is basically the same as the embodiment 1-1 as shown in FIG. 24. It should be noted that the embodiment 1-4 differs from the embodiment 1-1 in that patterning of the insulating film layer 44 is conducted so as to cover the step-like structure.

### Embodiment 1-5

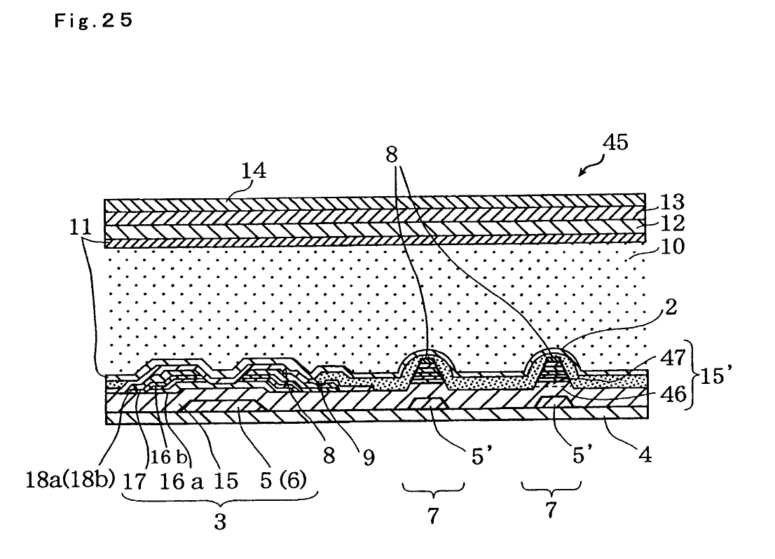

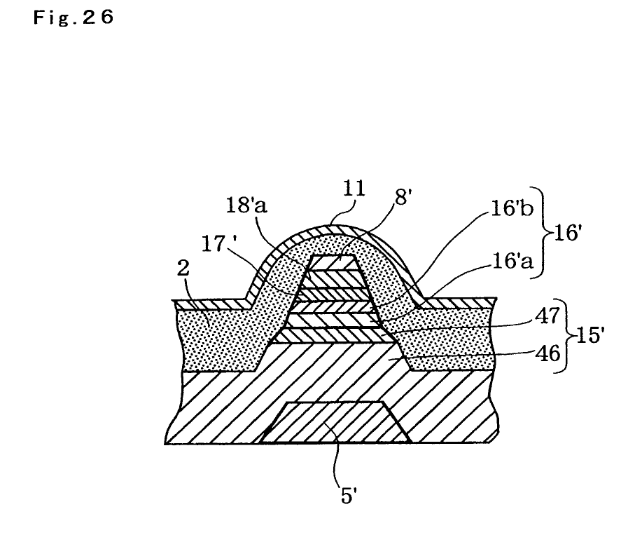

FIG. 25 is a cross-sectional view showing main portions of a reflective liquid crystal display according to an embodiment 1-5 and FIG. 26 is a partially enlarged view of FIG. 25. The same or corresponding parts in the embodiment 1-5 are identified by the same reference numerals as those in the embodiment 1-1. The embodiment 1-5 is characterized in that part of a gate insulating film layer 15 among the layers in the step-like structure is patterned and the gate insulating film layer 15 is comprised of two layers with the same composition and different film densities. By appropriately adjusting the film thickness with the use of the gate insulating film layer 15 with different film densities, the shape of the step-like structure can be controlled arbitrarily. As a result, the concave/convex shape of the reflective electrode can be controlled with high precision.

Subsequently, a method of manufacturing a reflective liquid crystal display 45 according to the embodiment 1-5 will be described. In this method, manufacturing steps similar to those of the method of manufacturing the reflective liquid crystal display in the embodiment 1-1 are performed, but the gate insulating film layer 15 has the same composition and is formed under different process conditions. For example, the gate insulating film layer 15 is formed by plasma CVD or the like when silicon nitride SiNx is used. In this process, by appropriately adjusting stoichiometric ratio of materials such as silane SiH₄, ammonia NH₃, and nitride N₂, and the temperature in film formation, so-called film density can be adjusted. When the insulating film with different film densities is patterned by etching, the higher the film density is, the lower the etching rate is. Therefore, as shown in FIG. 26, silicon nitride SiNx 46 with high film density and silicon nitride 47 with low film density are formed in first and second layers, respectively, and etching is then performed, thereby obtaining taper shapes with different angles. Besides, since the insulating film with low film density is formed as the upper layer, the angle can be made larger in the second layer than in the first layer. Thus, by forming the insulating films with different film densities, higher shape controllability is achieved. Also, by appropriately adjusting the film thickness, the concave/convex shape can be controlled.

Following this, film forming and patterning steps of metal layers such as the semiconductor layer 16, the signal lines 18b or the source drain electrode 18a are carried out. Thereafter, film made of high reflectance is formed by sputtering or the like, and then the film is formed into the reflective electrode 2.

The reflection characteristic of the reflective electrode which has undergone the aforementioned steps has satisfactory diffusing characteristic, with the light emanating in the regular reflection direction being less with respect to the incident light.

Further, using the substrate provided with the reflective electrode manufactured through the aforementioned steps, the reflective liquid crystal display was manufactured by the steps similar to those of the embodiment 1-1. This reflective liquid crystal display was used for displaying an image, which was superior in paper white and bright and had satisfactory contrast in the range of wide viewing angles.

### Embodiment 1-6

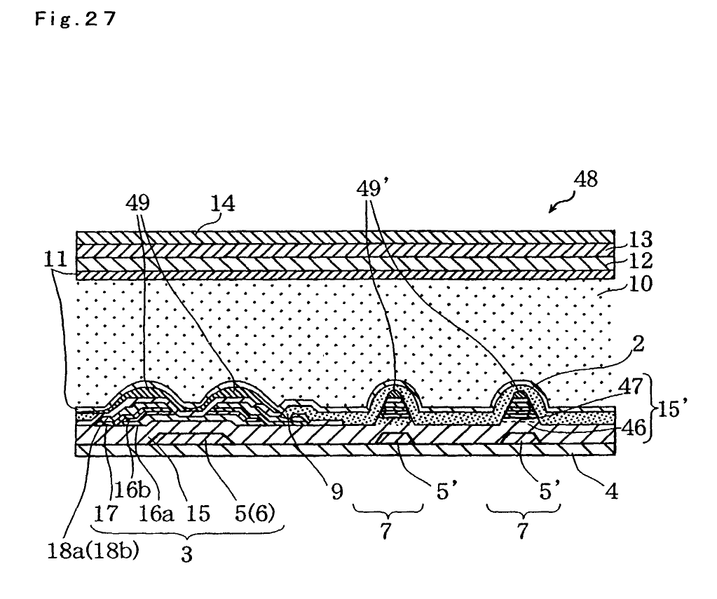

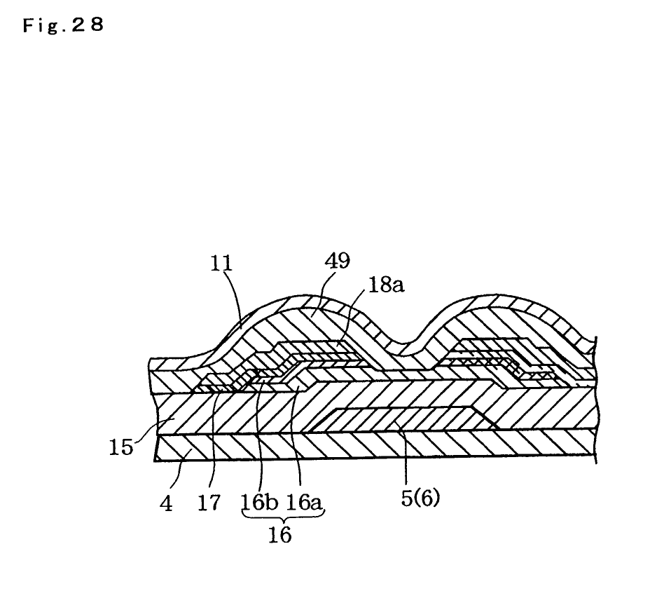

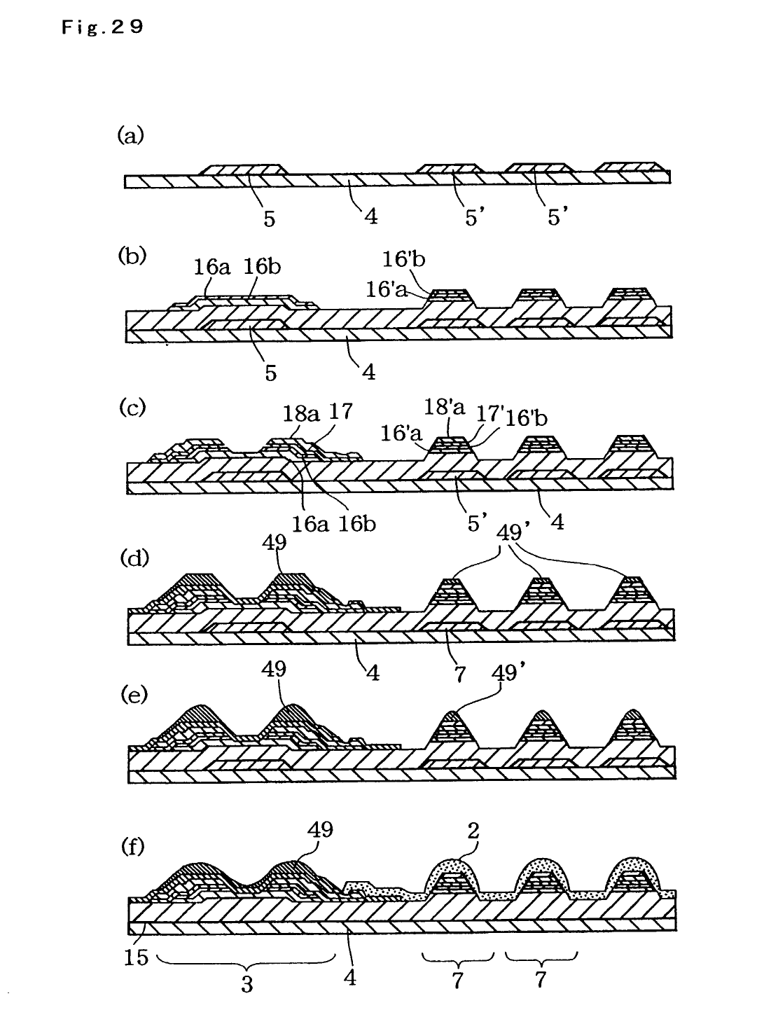

FIG. 27 is a cross-sectional view showing main portions of a reflective liquid crystal display according to an embodiment 1-6. FIG. 28 is a partially enlarged view of FIG. 27. FIG. 29 is a view showing steps of manufacturing the reflective liquid crystal display according to the embodiment 1-6. The same or corresponding parts in the embodiment 1-6 are identified by the same reference numerals as those in the embodiment 1-1. The embodiment 1-6 is characterized in that the concave/convex structure is formed in the source and drain electrodes 18a among the respective layers constituting the TFT3. The reason for such a structure is as follows. The formation of the concave/convex structure under the reflective electrode 2 does not eliminate flat portions, and accordingly, by forming the concave/convex structure on the source and drain electrodes, a reflective electrode with more satisfactory reflection characteristic, and hence a reflective liquid crystal display with satisfactory display quality, can be obtained. The upper surface of one of the signal line, the gate line, and the TFT may have the concave/convex structure.

Subsequently, a method of manufacturing a reflective liquid crystal display 48 according to the embodiment 1-6 will be described. In this method, the manufacturing steps similar to those in the method of manufacturing the reflective liquid crystal display according to the embodiment 1-1 are performed, but the source and drain electrodes 18a are formed and then an insulating film layer 49 is formed thereon. In this case, preferably, the insulating film layer 49 is made of photosensitive resin comprised of organic material. More preferably, the insulating film layer 49 is made of photosensitive resin which is, after exposure and development, to be deformed by heating under proper temperatures. The shape after heating is shown in FIG. 29 (e). In subsequent step, film made of metal with high reflectance is formed by sputtering or the like, and then the film is formed into the reflective electrode 2(FIG. 29(f)).

In the step of patterning the pixel electrode after formation of the reflective electrode layer, patterning of the source and drain electrodes is carried out simultaneously, for allowing the TFT to function as the switching device.

The reflective electrode which has undergone the above-mentioned steps has the concave/convex structure as the result of patterning of the layers constituting the TFT. For this reason, the reflection characteristic is satisfactory, with the light emanating in the regular reflection direction being less with respect to the incident light.

Further, using the substrate provided with the reflective electrode manufactured through the aforementioned steps, the reflective liquid crystal display was manufactured by the steps similar to those of the embodiment 1-1. This reflective liquid crystal display was used for displaying an image, which was superior in paper white and bright and had satisfactory contrast in the range of wide viewing angles.

### Embodiment 1-7

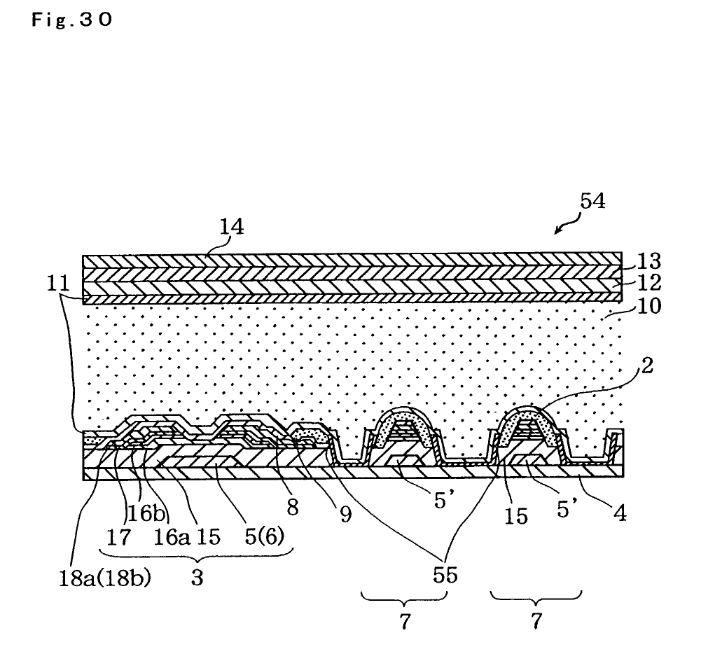

FIG.30 is a cross-sectional view showing main portions of a reflective liquid crystal display according to an embodiment 1-7. The same or corresponding parts in the embodiment 1-7 are identified by the same reference numerals as those in the embodiment 1-1. A reflective liquid crystal display 54 according to the embodiment 1-7 is a transmissive and reflective liquid crystal display, in which the reflective electrode 2 is partially provided with a transparent electrode 55, and the thickness of light-transmissive portion (flat portion having the transparent electrode 55) and the thickness of portions other than the light-transmissive portion (portion having the step-like structure) differ from each other.

Subsequently, a method of manufacturing a reflective liquid crystal display 54 according to the embodiment 1-7 will be described. In this method, the manufacturing steps similar to those in the method of manufacturing the reflective liquid crystal display according to the embodiment 1-1 are performed, but the reflective electrode 2 is not formed on part of the insulating substrate 4, and the shape of the layers is patterned to have portions through which the incident light from the rear surface of the substrate 4 is transmitted. In the subsequent step, film made of high reflectance is formed by sputtering or the like, and then the film is formed into the reflective electrode 2. After formation of the reflective electrode 2, the transparent electrode 55 made of ITO or the like is formed by sputtering or the like.

The reflection characteristic of the reflective electrode which has undergone the aforementioned steps is satisfactory, with the light emanating in the regular reflection direction being less with respect to the incident light.

Further, using the substrate provided with the reflective electrode manufactured through the aforementioned steps, the reflective and transmissive liquid crystal display panel was manufactured through the steps similar to those of the embodiment 1-1. Further, for the use in the transmissive mode, a backlight unit or the like comprised of a cold cathode tube, a reflector, and a light guiding plate is fixed. This transmissive and reflective liquid crystal display 54 was used for displaying an image, which was superior in paper white and bright and had satisfactory contrast in the range of wide viewing angles under bright ambient light. On the other hand, under dark environment, the backlight was turned ON, thereby performing video display with satisfactory visibility.

With regard to a substrate gap in the transmissive and reflective liquid crystal display 54, it is preferred that the spacing between the portion where the transparent electrode 55 is formed and the opposing substrate 14 provided with color filters 13 or the like be larger than that between the portion where reflective electrode 2 is formed and the opposing substrate 14, in terms of image display. Therefore, by appropriately patterning the layers, the film thickness is made different between the portion where the reflective electrode 2 is formed and the portion where the transparent electrode 55 is formed, as shown in FIG. 30.

### Embodiment 1-8

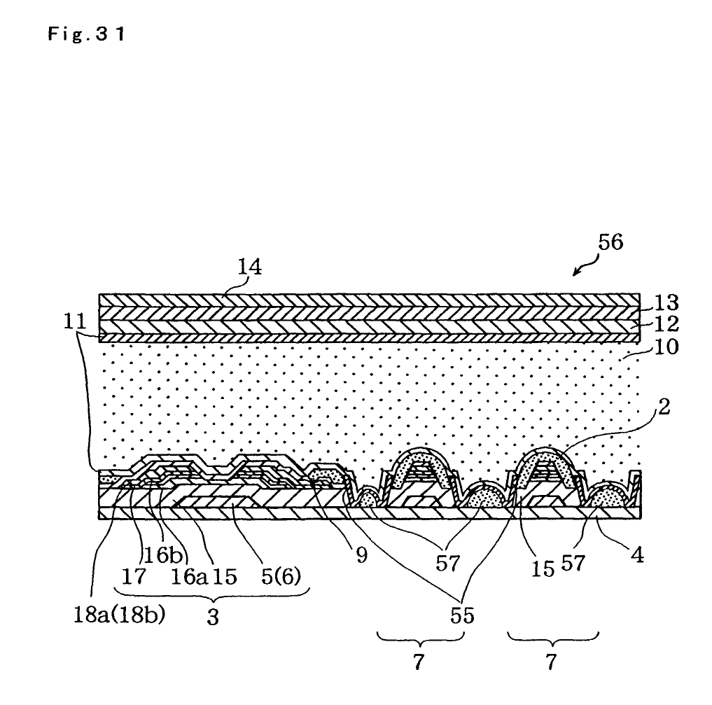

FIG.31 is a cross-sectional view showing main portions of a reflective liquid crystal display according to an embodiment 1-8. The same or corresponding parts in the embodiment 1-8 are identified by the same reference numerals as those in the embodiment 1-7. A reflective liquid crystal display 56 according to the embodiment 1-8 is a transmissive and reflective liquid crystal display similarly to the embodiment 1-7. The embodiment 1-8 is characterized in that micro lens 57 (corresponding to light-collecting means) is provided under or on the transparent electrode 55.

Subsequently, a method of manufacturing a reflective and transmissive liquid crystal display according to the embodiment 1-8will be described. In this method, the manufacturing steps similar to those in the method of manufacturing the reflective liquid crystal display according to the embodiment 1-7 are performed, but the micro lens 57 is formed under or on the portion where the transparent electrode is provided. Preferably, an insulating film formed under the reflective electrode 55 is made of transparent photosensitive resin. In this case, as the result of patterning and heating, as shown in FIG. 31, the concave/convex shape is obtained in the portion where the reflective electrode is formed, due to thermal deformation of the photosensitive resin, while photosensitive resin is thermally deformed in the portion where the transparent electrode is formed as shown in FIG. 31 and formed into the lens shape. Thus, by using the photosensitive resin which is deformed by heating, as the insulating film, the concave/convex shape under the reflective electrode and the micro lens for light-collecting under the transparent electrode can be simultaneously obtained. In the subsequent step, film made of high reflectance is formed by sputtering or the like, and then the film is formed into the reflective electrode. Further, after formation of the reflective electrode layer, the transparent electrode made of ITO or the like is formed by sputtering or the like.

The reflection characteristic of the reflective electrode which has undergone the aforementioned steps is satisfactory, with the light emanating in the regular reflection direction being less with respect to the incident light.

Further, using the substrate provided with the reflective electrode manufactured through the aforementioned steps, the reflective and transmissive liquid crystal display was manufactured by the steps similar to those of the embodiment 1-1. In this case, for the use in the transmissive mode, the backlight unit or the like comprised of a cold cathode tube, a reflector, and a light-guiding plate were fixed. This reflective and transmissive liquid crystal display was used for displaying an image, which was superior in paper white and bright and had satisfactory contrast in the range of wide viewing angles under bright ambient light. On the other hand, even under dark environment, the backlight was turned ON, there by performing video display with satisfactory visibility. Also, because of the presence of the micro lens, the luminance in ON state of the backlight was 1.3 times higher than the luminance in ON state in the reflective and transmissive liquid crystal display of the embodiment 1-7.

Moreover, the color filters provided on the opposing substrate have two types of optical concentrations as being of reflective type and transmissive type, and light-collecting characteristic of the micro lens is utilized, thereby allowing a satisfactory image with a wide color reproducibility range to be displayed in the reflective mode and the transimissive mode.

### Embodiment 1-9

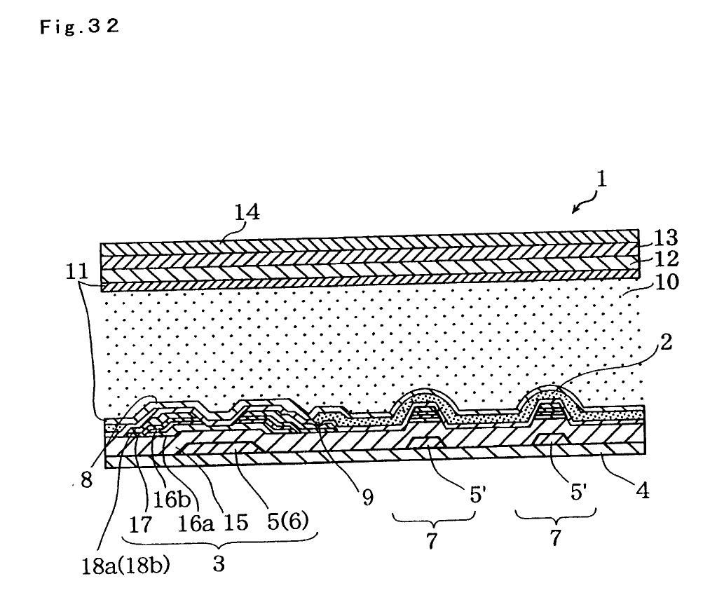

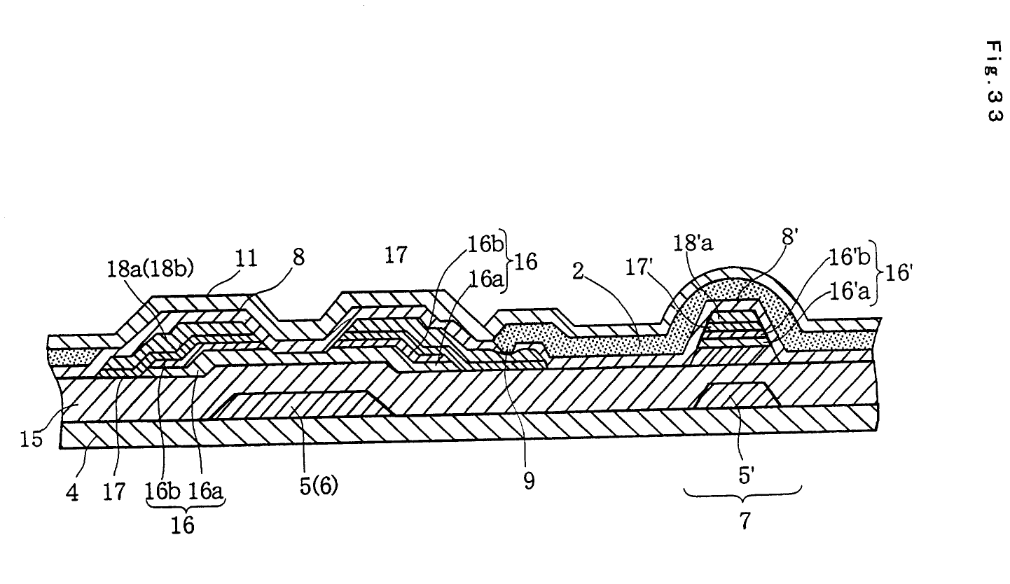

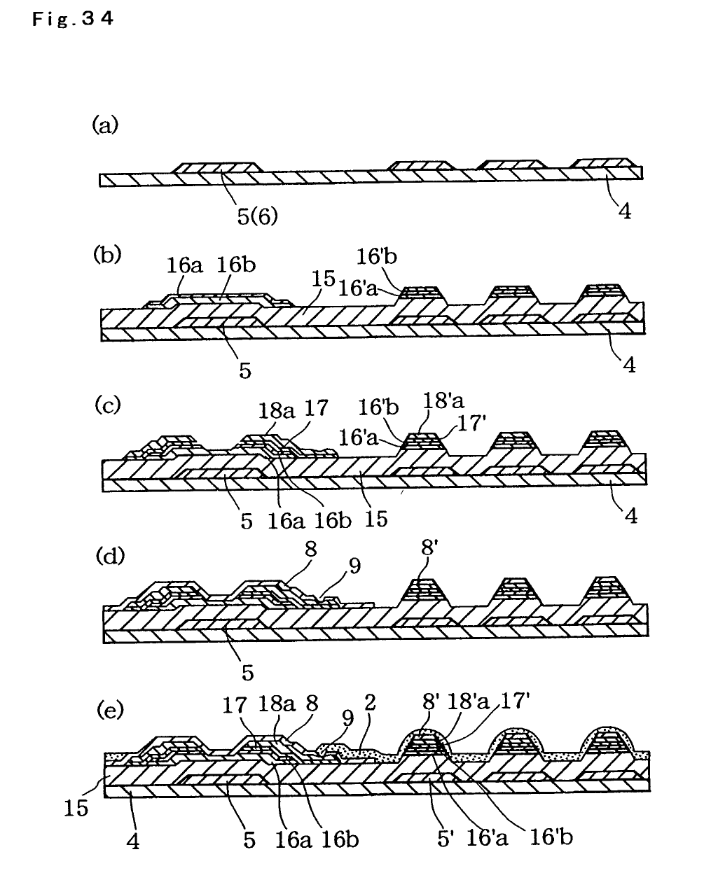

FIG. 32 is a cross-sectional view showing main portions of a reflective liquid crystal display according to an embodiment 1-9. FIG. 33 is a partially enlarged view of FIG. 32. FIG. 34 is a view showing steps of manufacturing a reflective liquid crystal display according to the embodiment 1-9. The same or corresponding parts in the embodiment 1-9 are identified by the same reference numerals as those in the above embodiments. The embodiment 1-9is characterized in that, the first insulating film layer 8 covering the source and drain electrodes 18a of the TFT 3 is configured such that only the region where contact hole is to be formed is patterned and the other portion is not. Such a structure has an effect of preventing reduction of tact in patterning of the first insulating film layer 8. The reason for this is described below.

In general, silicon nitride SiNx film is used as the first insulating film layer 8 covering the source and drain electrodes 18a. In the conventional example and the embodiments 1-1 through 1-8, silicon nitride (SiNx) film is used as the first insulating film layer 8. By the way, when the silicon nitrogen film is used as the insulating film, the following problem arises, because the nitride film is difficult to pattern. It has been revealed that, when the silicon nitride film is used as the insulating film and the insulating film 8 under the reflective electrode 8 is patterned in column shape by a dry etching process or the like, the etched region is increased and the etching process required much time, which leads to reduced tact. Accordingly, in the embodiments 1-1 and through 1-9, only the contact hole region in the first insulating film layer 8 is patterned, thereby avoiding reduced tact.

Subsequently, a method of manufacturing the liquid crystal display according to the embodiment 1-9 will be described. The manufacturing method in the embodiment 1-9 is basically the same as the method of manufacturing the liquid crystal display in the embodiment 1-1. Therefore, only the features of the manufacturing method in the embodiment 1-9 will be described.

First, similarly to the embodiment 1-1, in first step, the gate line 6, the gate electrode 5 and the circular pattern layer 5′ are formed (FIG. 34(a)). Then, in second step, the gate insulating film layer 15 is formed. Then, in third step, the semiconductor layer 16 and the circular pattern layer 16′ are formed (FIG. 34(b)). Then, in fourth step, the source and drain electrodes 18 and the circular pattern layer 18′ are formed (FIG. 34(c)). Thereafter, after formation of the first insulating film layer 8 in fifth step, the positive photosensitive resin is formed and patterned by using the mask as in third step, for the purpose of forming the contact hole 9 through which the source and drain electrodes 18a are electrically connected. The photomask used in the patterning is different from that of the embodiment 1-1. The photomask used in the embodiment 1-9 has a mask pattern in which the region corresponding to the contact hole 9 is light-transmissive portion. Exposure and development of the positive photo sensitive resin layer are carried out by using this mask, and as a result, the portion irradiated with light is melted and vanishes. Under the condition, dry etching is conducted, thereby forming the predetermined contact hole 9 in the first insulating film layer 8 (FIG. 34(d)). After formation of the contact hole 9, the positive photosensitive resin layer is peeled from the first insulating film layer 8.

Silicon nitride was used for the first insulating film layer 8 and film thickness was set to 2700Å. Only the contact hole portion 9 was etched as described above, which required 60 seconds. Meanwhile, the portion of the pixel portion other than the contact hole 9 was patterned by dry etching similarly to the embodiment 1-1, which required 150 seconds. That is, in the manufacturing method according to this embodiment, tact is improved to 250%.

Thereafter, similarly to the embodiment 1-1, in sixth step, the reflective electrode 2 is formed by a forming process such as sputtering, and then patterned by photolithography.

The reflective electrode 2 formed through the first to sixth steps has concave/convex shape along a plurality of step-like structures 80 as shown in FIG. 34 (e). Further, since the higher layers in the step-like structure 80 are smaller, the area ratio of the flat portions to the concave/convex shape can be made smaller than those of the reflective electrodes described in the conventional examples, Japanese Laid-Open Patent Application Publication Nos. 9-54318, 11-133399, 11-258596, and the like.

Meanwhile, as disclosed in Patent Publication No. 2756206, in the step of forming concave/convex portions on the substrate provided with TFTs on the surface thereof by using photosensitive resin, one step corresponding to a series of photolithography processes including application of photosensitive resin, exposure through photomask and development, etc, is increased, which leads to increased fixed costs of photosensitive resin, developing agent, and mask manufacture. Also, reduced yield in the entire steps, and increased tact time lead to increased cost. On the other hand, in accordance with the embodiment 9, the manufacturing cost can be reduced because of the absence of the above photolithography process after formation of the TFT 3 in contrast with the manufacturing method disclosed in Patent Publication No. 2756206.

Similarly to the method disclosed in Japanese Laid-Open Patent Application Publication No. Hei. 9-54318, layers including the semiconductor layer and the source and drain electrode layers, constituting the TFT are formed and then patterned by dry etching to obtain the shape, and thereafter, the silicon nitride film is formed and etched to obtain only the contact holes, thereby improving the tact as well.

The silicon nitride for the first insulating film layer 8 in the above example may be replaced by the silicon oxide (SiOx).

Also, photosensitive resin may be used as the film material of the first insulating film layer 8. It should be noted that the use of the photosensitive resin as the film material offers lower reliability of device operational performance, but advantageously offers easier patterning than the use of the silicon nitride. Therefore, when the photosensitive resin is used as the film material of the first insulating film layer 8, tact is not reduced even if the portion other than the contact hole region is patterned, as well as the contact hole region. As a matter of course, when the photosensitive resin is used as the film material of the first insulating film layer 8, only the contact hole region may be patterned as in the case of using the silicon nitride film.

### Embodiment 1-10

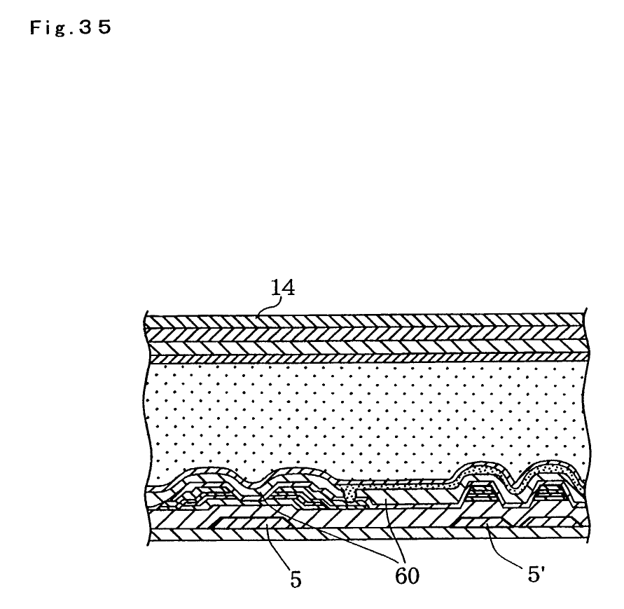

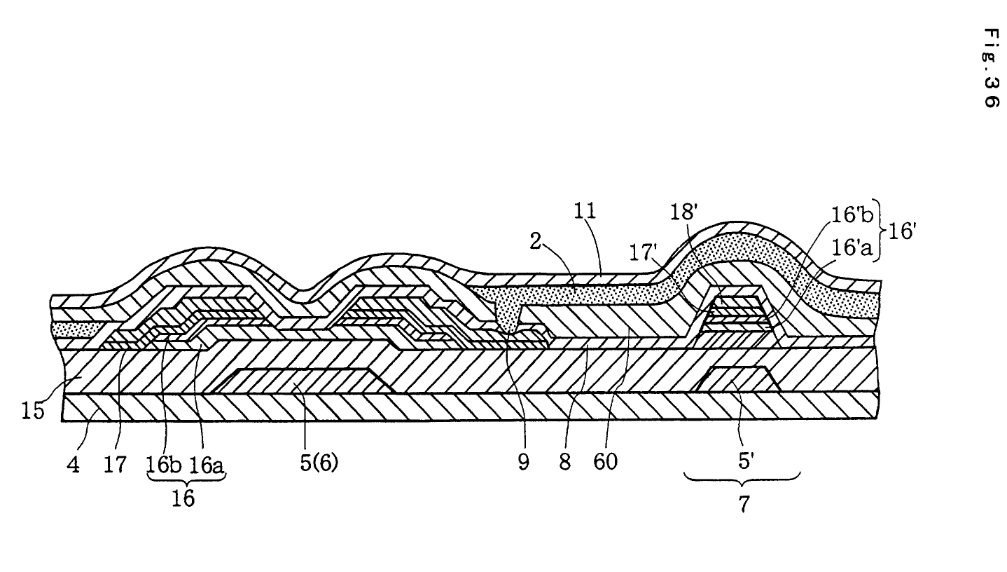

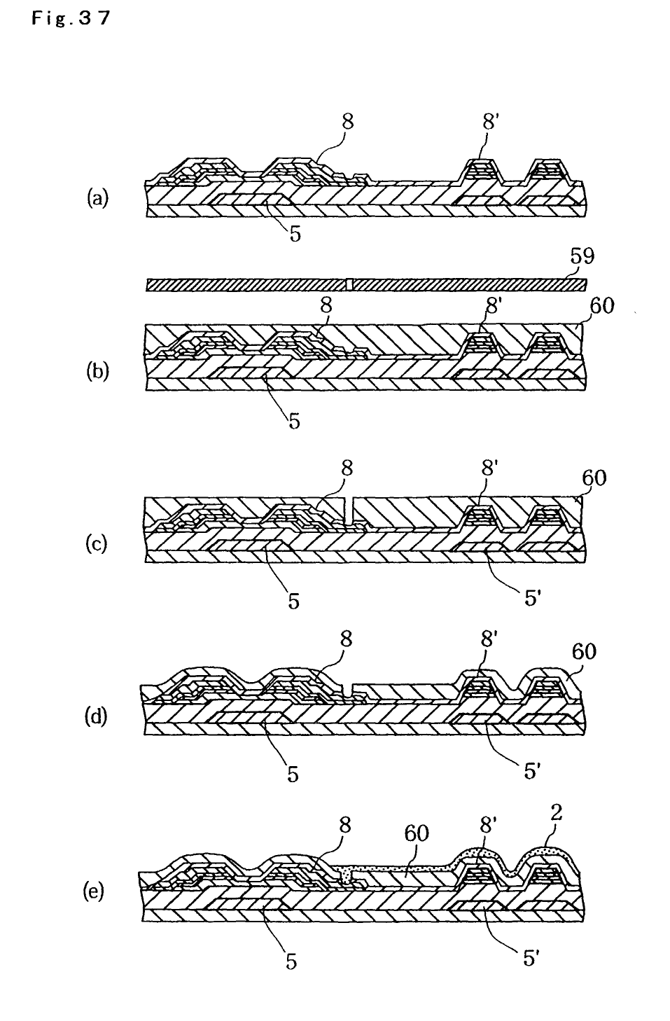

FIG. 35 is a cross-sectional view showing main portions of a reflective liquid crystal display according to an embodiment 1-10. FIG. 36 is a partially enlarged view of FIG. 36. FIG. 37 is a view showing steps of manufacturing the reflective liquid crystal display according to the embodiment 1-10. The same or corresponding parts in the embodiment 1-10 are identified by the same reference numerals as those in the embodiment 1-9. The embodiment 1-10 is characterized in that a photosensitive resin layer formed on the first insulating film layer 8 made of silicon nitride for formation of contact holes is left even after formation of the contact holes. Specifically, in the fifth step in the embodiment 1-9, the positive photosensitive resin layer 60 is formed on the first insulating film layer 8, followed by exposure and development, and after dry etching, the positive photosensitive resin layer 60 is peeled. This results in reduced tact which would lead to increased cost. As a solution to this problem, the embodiment 1-10 is characterized in that the positive photosensitive resin layer 60 is left.

Further, in the embodiment 1-10, the inner peripheral face of the photosensitive resin layer 60 and the inner peripheral face of the first insulating film layer 8 are coplanar with each other and are inclined at equal angle. For example, partially protruded shape from the inner peripheral face of the contact hole, causes degraded adhesion in the associated portion between the reflective electrode 2 and the inner peripheral face of the contact hole. This causes cracks or peeling in the reflective electrode 2, thereby leading to reduced display characteristic. On the other hand, in this embodiment, such a problem can be solved because the inner peripheral face of the contact hole is continuous without concave/convex portions.

In the embodiment 1-10, since the photosensitive resin layer 60 is left without peeling from the first insulating film layer 8, acrylic-based photosensitive resin is used for the photosensitive layer 60, instead of the conventionally novolack-based photosensitive resin. This is because the use of the novolack-based photosensitive resin brings about low device reliability because of its low heat resistance and more tendency toward peeling from the substrate. On the other hand, such problems do not arise in the case of the acrylic-based photosensitive resin, because it has high heat resistance and is capable of keeping strong adhesion to the substrate.

The material of the photosensitive resin layer 60 is not intended to be limited to the acrylic-based resin, but photosensitive and heat-resistant resin is sufficient.

Subsequently, a method of manufacturing the liquid crystal display constituted above will be described. The manufacturing method in this embodiment is basically the same as the method in the embodiment 1-9, and only main features of the manufacturing method will be now described.

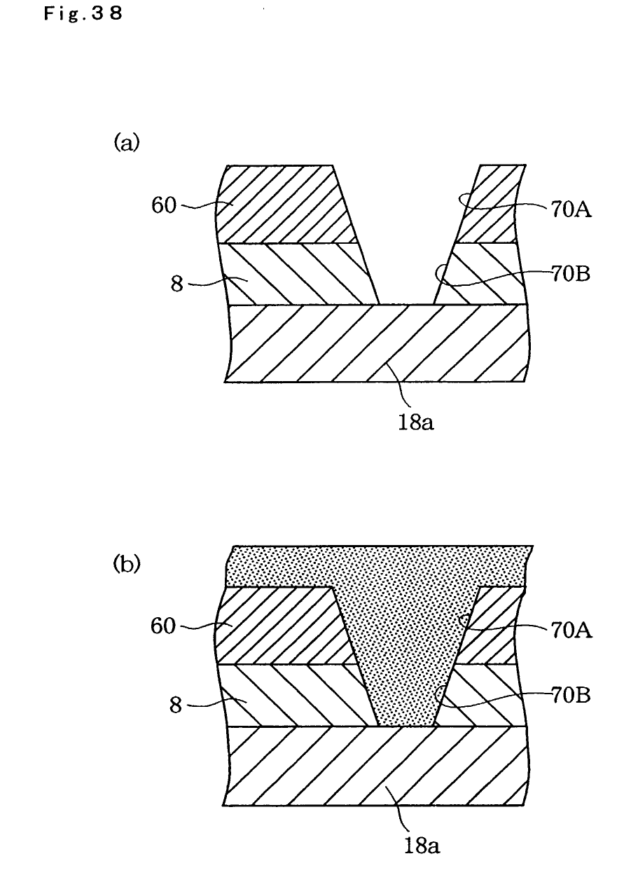

Similarly to the embodiment 1-9, after first and second steps, in third step, as shown in FIG. 37(a), silicon nitride is applied over the source and drain electrodes 18a in the thickness of 2700Å, thereby forming the first insulating film layer 8. Then, as shown in FIG. 37(b), acrylic-based positive photosensitive resin (e.g., PC403 (brand name) manufactured by JSR Corp.) is applied over the first insulating film layer 8 in the thickness of 7000Å, thereby forming the photosensitive resin layer 60. Using the photomask 59, exposure and development are conducted for removing only the contact hole regions in the photosensitive resin layer 60. Further, the first insulating film layer 8 is etched, thereby forming a contact hole 70A (see FIG. 38) in the photosensitive resin layer 60 and further a contact hole 70B (see FIG. 38) in the first insulating film layer 8. Etchant in the development of the photosensitive resin layer 60 and etching of the first insulating film layer 8 is a gas mixture of chlorine-based gas and fluorine-based gas. Noticeably, as evident from FIG. 38(a), the inner peripheral face of the contact hole 70A and the inner peripheral face of the contact hole 70B are coplanar with each other with equal inclination angle. The shape of the contact holes 70A, 70B provides satisfactory adhesion between the reflective electrode 2 and the inner peripheral faces of the contact holes 70A, 70B, as shown in FIG. 38(b), thereby preventing degraded display characteristic caused by the cracks or peeling of the reflective electrode in the contact holes.

To obtain the above-mentioned shape of the contact holes 70A, 70B, for example, composition of the etchant (mixing ratio between chloride-based gas and fluorine-based gas), etching time, and the like are appropriately adjusted.

Then, as shown in FIG. 37(d), the entire substrate is heated. Heating is conducted using a hot plate, for 5 seconds at 120° C. After this heating step, the photosensitive resin layer 60 is melted and deformed so as to conform in shape to the concave/convex portions of the TFT and the step-like structures. This allows the photosensitive resin layer 60 to be used as the layer of the step-like structure.

Then, as shown in FIG. 37(e), the reflective electrode 2 is formed using metal with high reflectance, e.g., Al-based or Ag-based alloy, and the reflective electrode 2 is electrically connected to the source and drain electrodes 18a through the contact holes 70A, 70B.

Then, in the reflective liquid crystal display manufactured in the above method, a signal for white display was input and reflection characteristic was measured in the above method. As a result, it was found that the intensity of regular reflection was suppressed. It was revealed that the cause for this was that flat portions between the concave and convex portions were covered with the positive photosensitive resin and consequently the regular reflection was suppressed. By thus applying the positive photosensitive resin in the proper thickness, the reflective liquid crystal display with suppressed regular reflection and less mirroring was obtained.

### Embodiment 1-11

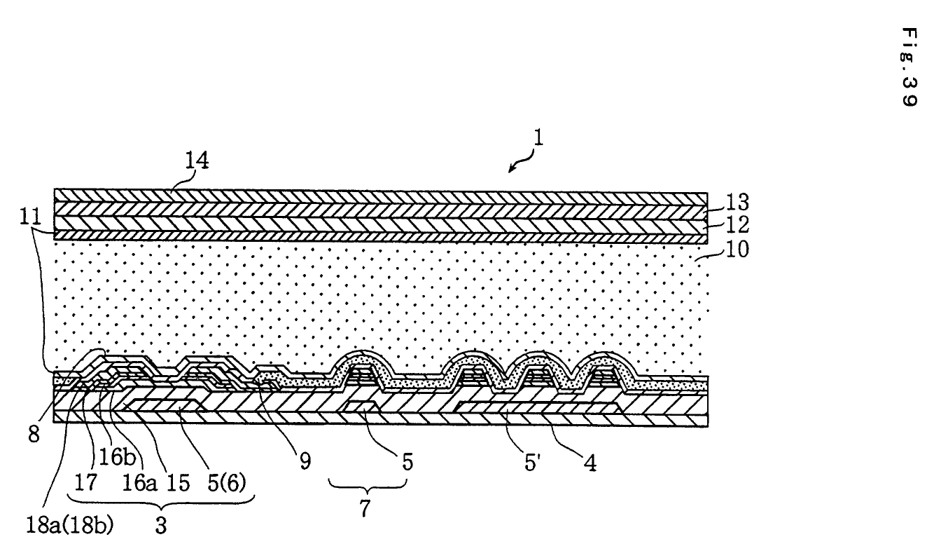

FIG. 39 is a cross-sectional view showing main portions of a reflective liquid crystal display according to an embodiment 1-11. The embodiment 1-11 is similar to the embodiment 1 and the same or corresponding parts are identified by the same reference numerals. In the embodiments 1-1 through 1-10, one step-like structure 80 is formed in each circular pattern layer 5′ obtained by pattering the metal layer constituting the gate electrode 5, while in the embodiment 1-11, a plurality of step-like structures 80 are formed on the circular pattern layer 5′ as a base layer of the concave/convex reflective electrode 2. Such a structure can further reduce the area of flat portions between the concave/convex portions of the reflective electrode 2. Consequently, the reflective liquid crystal display with suppressed intensity of regular reflection and improved display characteristic can be obtained.

It should be appreciated that the structures of the embodiment 1-11 may be applied to the structures of the embodiments 1-1 through 1-10. Or otherwise, the embodiments 1-1 through 1-10 may be combined with the embodiment 1-11. To be specific, the concave/convex structure in which one step-like structure 80 is formed in the circular pattern layer 5′ and a plurality of step-like structures 80 are formed in the circular pattern layer 5′ may be the base layer of the concave/convex reflective electrode 2.

### Embodiment 1-12

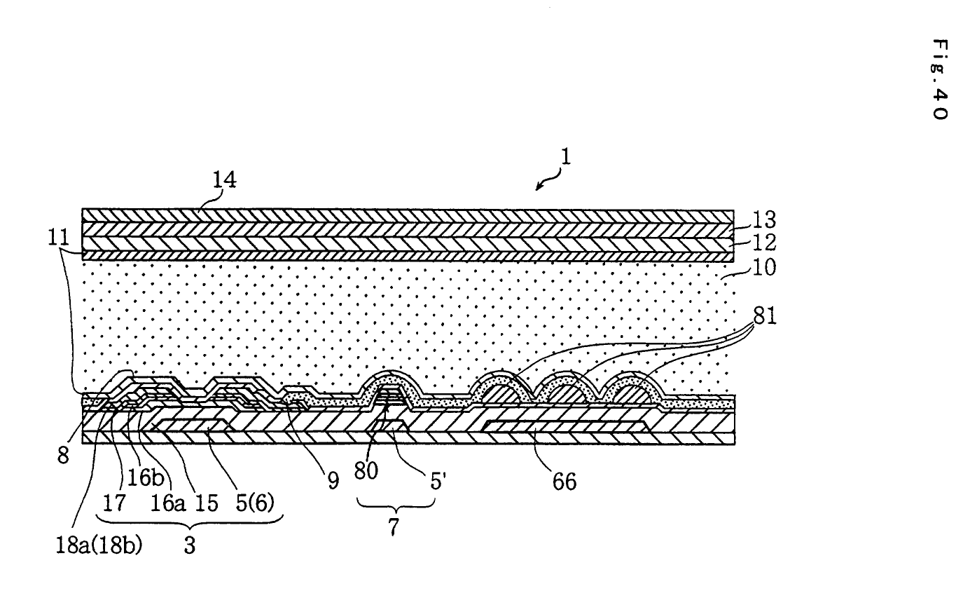

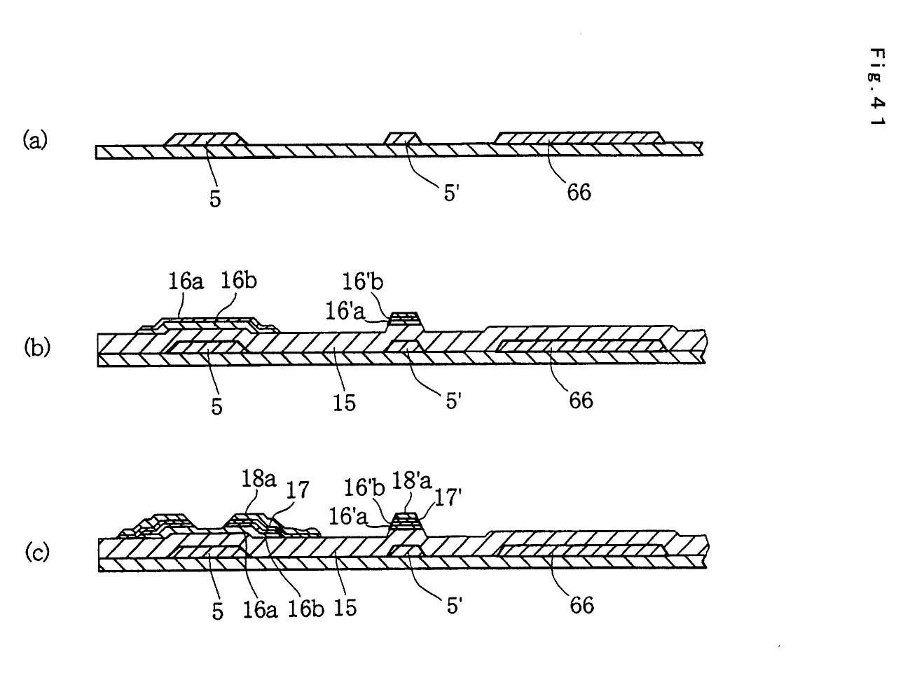

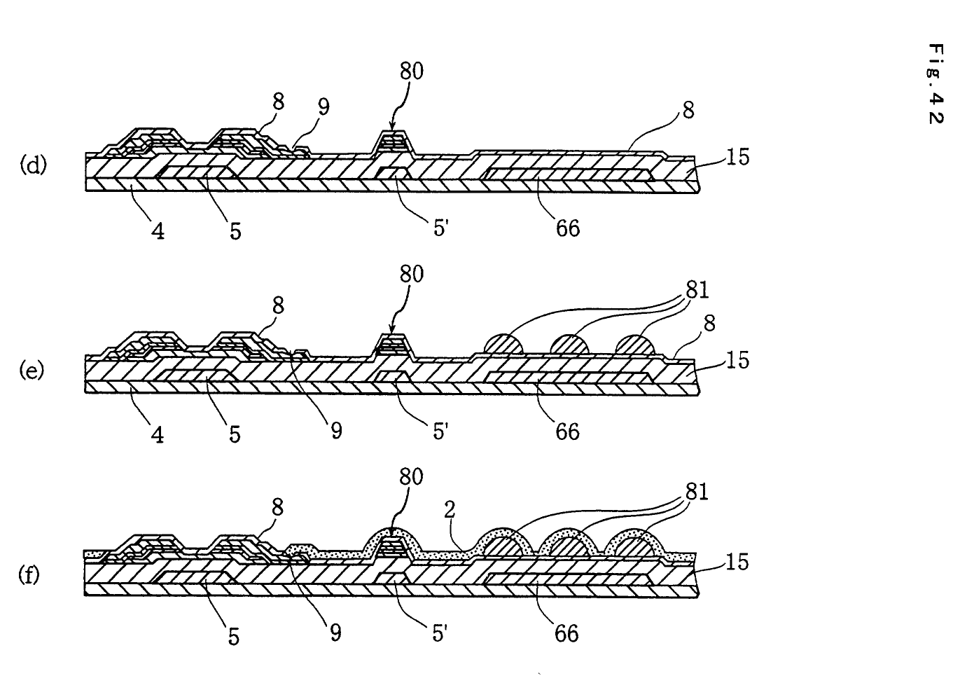

FIG. 40 is a cross-sectional view showing main portions of a reflective liquid crystal display according to an embodiment 1-12. FIGS. 41, 42 are views showing steps of manufacturing the reflective liquid crystal display according to the embodiment 1-12. The embodiment 1-12 is similar to the embodiments 1-1 through 1-9. The same or corresponding parts in the embodiment 1-12 are identified by the same reference numerals. The embodiment 1-12 is characterized in that, in addition to the step-like structure 80 (corresponding to a first cumulated layer pattern) formed on the circular pattern, a common electrode (capacitor electrode) 66 for formation of auxiliary capacitor (storage capacitor) is formed on the insulating substrate 4, and a plurality of step-like structures 81 (corresponding to second cumulated layer patterns) are formed on the common electrode 66 as abase layer of the concave/convex reflective electrode 2. With such a structure, it is possible to obtain a reflective liquid crystal display capable of preventing the occurrence of flicker and suppressing regular reflection, and having less mirroring. The reason is described below.

There arises new problem that, in the case of the pixel electrode with small area, flicker occurs when one or two of the layers constituting the TFT 3 are patterned, thereby forming the concave/convex portions under the reflective electrode 2. The cause was studied and it was revealed that such phenomenon occurs due to the fact that charge cannot be held during writing of an image corresponding to one frame since small charge is stored in pixel because of the small area of the pixel electrode. To solve such a problem, the metal layer constituting the gate electrode 5 is patterned, thereby forming a circuit configuration in which the common electrode 66 is grounded in the same manner as the counter electrode. As the result of formation of the storage capacitor by the common electrode 66, the flicker hardly occurred. However, the reflection characteristic of the substrate provided with the common electrode 66 for storage capacitor was measured by the above meter while sending the signal for white display, and it was observed that the intensity of the regular reflection was high. Accordingly, the shape of the reflective electrode having he concave/convex portions was re-evaluated, and it was revealed that most of the portions of the reflective electrode under which the common electrode 66 was formed were flat.

Accordingly, the storage capacitor is formed for the purpose of preventing flicker due to insufficient capacitor and a plurality of step-like structures 81 are formed on the common electrode 66 for the purpose of reducing the intensity of the regular reflection. With such a structure, the concave/convex shape is obtained on the portion of the reflective electrode 2 immediately on the common electrode 66, the area of the flat portions between the concave/convex portions of the reflective electrode 2 can be minimized, and the intensity of regular reflection can be reduced. It should be appreciated that in the embodiment 12, first step-like structure 80 constituted by the circular pattern layers is constituted by using part of the layers constituting the TFT 3 and second step-like structures 81 on the common electrode 66 are constituted by another layers different from those of TFT3.

Subsequently, a method of manufacturing the liquid crystal display constituted as described above will be described. First, the TFT 3 and the first step-like structure 80 using part of the layers of the TFT 3 are formed on the insulating substrate 4. This formation step is accomplished by the above-mentioned first to eighth steps. After formation of the TFT 3 and the first step-like structure 80, the second step-like structure 81 is formed on the common electrode 66. In the first through eighth steps, in the portion where the common electrode 66 is formed, as shown in FIG. 41(b), the gate insulating film 15, the amorphous silicon layer 16a, and the impurity layer 16b are formed, and thereafter, the amorphous silicon layer 16a and the impurity layer 16b are removed by dry etching. As shown in FIG. 41(c), the source and drain electrodes 18a are formed and patterned in the portion except where the common electrode 66 is formed, but the source and drain electrodes 18a are removed by dry etching in the portion where the common electrode 66 is formed. Thereafter, in the step in FIG. 42(d), the first insulating film layer 8 is formed and patterning is conducted for forming the contact hole 9.

Then, the second step-like structures 81 are formed on the common electrode 66. Specifically, the positive photosensitive resin, for example, PC403 (brand name: manufactured by JSR Corp. )is applied over the common electrode 66, thereby forming the photosensitive resin layer. Then, the photosensitive resin layer is exposed by using the photomask having predetermined patterns and then, the exposed photosensitive resin layer is developed, thereby forming a plurality of step-like structures 81 on the common electrode (FIG. 42(e)). Then, metal with high reflectance, for example, Al-based or Ag-based alloy is film-formed, thereby obtaining concave/convex reflective electrode 2 (FIG. 42(f)).

The reflection characteristic of the reflective liquid crystal display manufactured by the above method was measured in the manner described above. The experimentation was carried out under the condition in which a signal for white display was input. It was found that the intensity of the regular reflection was suppressed. It was revealed that the reason for this was that the flat portions on the common electrode 66 were covered with the step-like structure 81 made of positive photosensitive resin. It should be appreciated that, by forming the concave/convex structure on the common electrode 66, the reflective liquid crystal display with suppressed regular reflection and less mirroring is obtained.

The second step-like structure 81 is not intended to be limited to the photosensitive resin as shown in the above example. Alternatively, in the present invention, after formation of the TFT3, the second step-like structures 81 may be independently formed of metal or semiconductor material.

Also, while in the above example, the second step-like structures 81 are formed of layers different from the layers of the TFT 3, this may be formed using part of the layers constituting the TFT 3, similarly to the first step-like structure 80.

### Embodiment 1-13

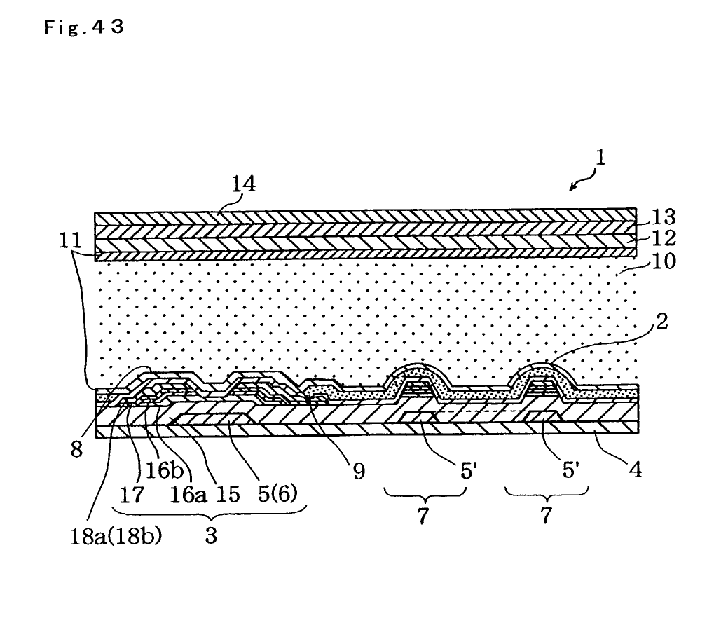

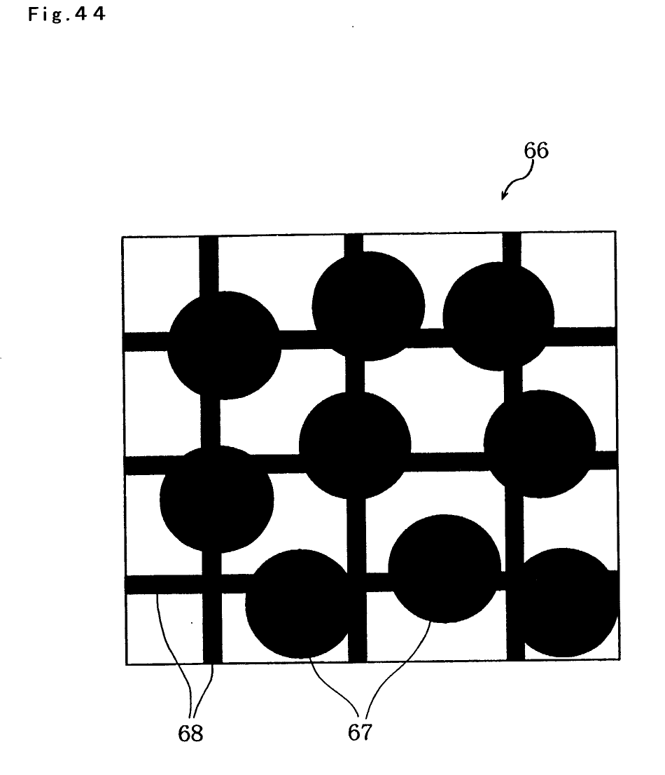

FIG. 43 is a cross-sectional view showing main portions of a reflective liquid crystal display according to an embodiment 1-13. FIG. 44 is a plan view showing part of a common electrode as seen from above. The embodiment 13 is similar to the embodiment 1-12 and the same or corresponding parts in the embodiment 1-13 are identified by the same reference numerals as those in FIG. 12. The embodiment 1-13 is characterized in that the common electrode 66 is pre-patterned, thereby forming a concave/convex structure. The specific reason for this will be described below. As shown in FIG. 44, the common electrode 66 is comprised of circular-pattern-shaped common electrode portions 67 for formation of concave/convex portions and wires 68 for rendering the common electrode portions 67 and the opposing substrate electrode at equipotential.

A method of manufacturing the circular-pattern-shaped common electrode 66 will be described. After formation of the metal layer as the gate electrode 5, photosensitive resin (e.g., OFPR5000 (brand name: manufactured by Tokyo Oka Kogyo (Corp.)) is applied over the metal layer, and the metal layer is exposed by using the photomask having light-blocking regions corresponding to the patterns 67 and the wires 68, followed by development. Thereafter, the metal layer is patterned by wet etching or dry etching, thereby forming the pattern-shaped common electrode. Each common electrode portion 67 is grounded through the wire 68.

In the following steps, similarly to the embodiment 1-12, the TFT is formed and then a plurality of step-like structures 81 made of photosensitive resin are formed on the common electrode 66. Then, Al or the like is applied so as to cover the TFT 3 and the step-like structures 81, thereby forming the concave/convex reflective electrode 2. Consequently, as shown in FIG. 43, the reflective liquid crystal display provided with the step-like structures 81 formed on the pre-patterned common electrode 66 and the concave/convex reflective electrode 2 conforming in shape to the step-like structures 81 as the base layer is manufactured.

Then, the reflection characteristic of the reflective liquid crystal display manufactured in the above method was measured in the above method by inputting the signal for white display. The result was that the intensity of the regular reflection was suppressed. Thus, the use of the pre-patterned common electrode 66 allows the concave/convex shape of the reflective electrode 2 on the common electrode 66 to be further controlled. In the case where the common electrode 66 is pre-patterned, since the concave/convex portions due to film thickness difference by patterning are formed, the step-like structures 81 can be formed by applying photosensitive resin over the common electrode, without a photolithography process conducted on the photosensitive resin.

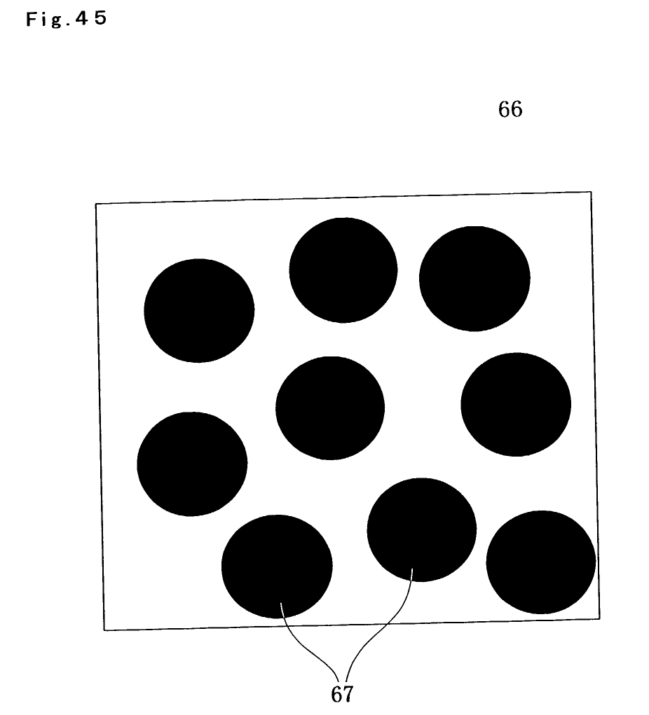

It should be appreciated that, as shown in FIG. 45, the common electrode 66 may be comprised of circular patterns without the wires 68. The concave/convex structure is formed without being affected by the absence of the wires 68, i.e., in a floating state, and therefore, the reflector with improved reflection characteristic can be obtained. However, when the reflector having such constitution is applied to the liquid crystal display, there is a possibility that proper charging becomes impossible in writing of image data, and consequently, a display having such a structure malfunctions. It is therefore required that the common electrode having the wires 68 be grounded when the above reflector is applied to the liquid crystal display.

While in the above example, the step-like structures made of photosensitive resin are formed on the common electrode, part of the layers constituting the TFT are formed into the step-like structures on the common electrode.

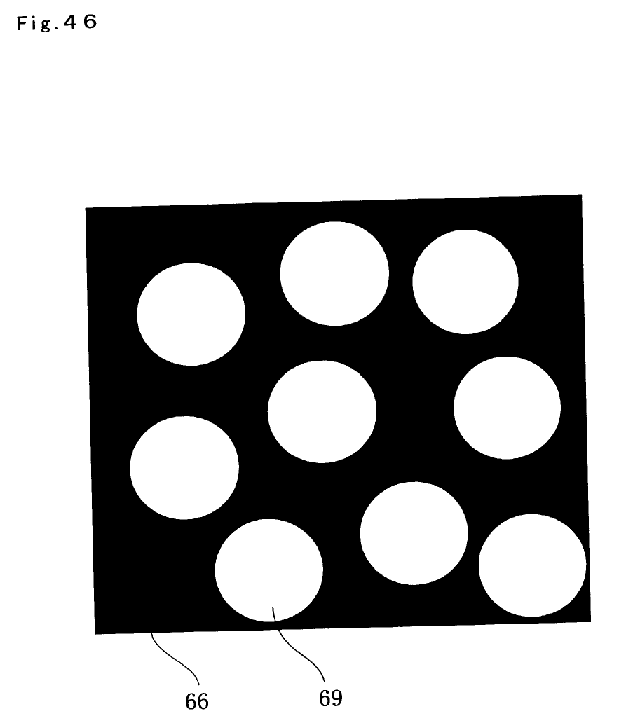

Also, the patterns of the common electrode are not intended to be limited to the pattern in FIG. 44, but hole patterns 69 shown in FIG. 46 may be used as well. While in this embodiment, one type of circular pattern is used, another shapes, for example, hexagon patterns may be used. In addition, with regard to the size of the patterns, any obstruction do not arise from the use of plural types of patterns, instead of one type of pattern. Further, a plurality of shapes may be used, instead of one type of shape.

### Embodiment 1-14

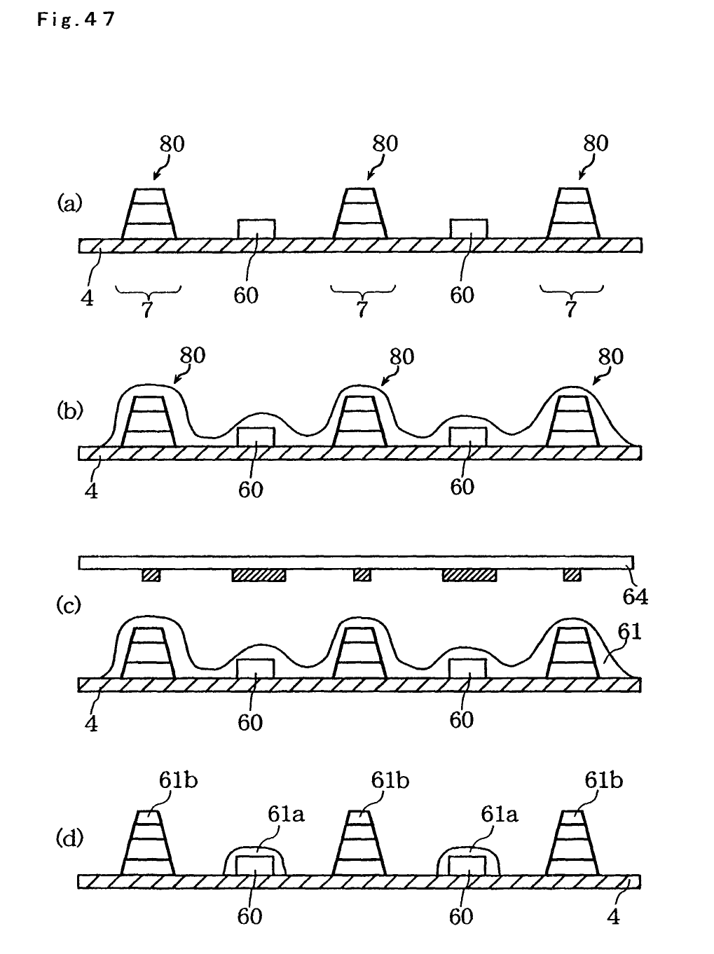

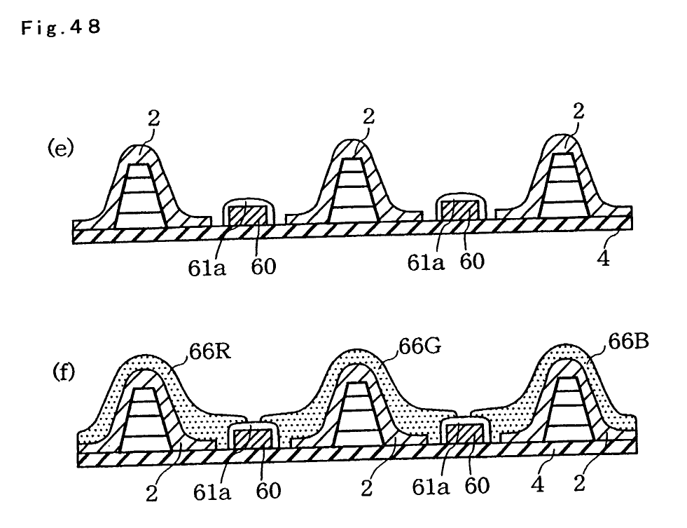

FIG. 47 is a view showing steps of manufacturing a reflective liquid crystal display according to an embodiment 1-14. FIG. 48 is a view showing steps of manufacturing the reflective liquid crystal display.

The embodiment 1-14 is similar to the embodiment 1-1 and the same or corresponding parts in the embodiment 1-14 are identified by the same reference numerals as those in the embodiment 1-1. The embodiment 1-14 is related to the reflector in which color filters are disposed on the substrate provided with active elements and concave/convex reflective electrode, and characterized in that the step-like structures comprised of column-shaped bodies are formed under the concave/convex reflective electrodes and the step-like structures include thin films constituting the color filters.

Thus, by using the thin films other than the thin films of the active elements, i.e., the thin films constituting the color filters, as the column-shaped bodies constituting the step-like structures, the shape of the step-like structure can be arbitrarily controlled. Consequently, the concave/convex shape of the reflective electrode can be controlled with high precision.

Subsequently, a method of manufacturing the reflective liquid crystal display according to the embodiment 1-14 will be described. The manufacturing method of the embodiment 1-14 undergoes the steps in the method of manufacturing the reflective liquid crystal display in the embodiment 1-1, but differs from the same in that the uppermost layer of the step-like structure is comprised of black matrixes constituting the color filters. For clarity, the gate insulating film layer is not illustrated and will not be described.

As shown in FIG. 47(a), through the steps in the embodiment 1-1, the step-like structures 80 are formed on the substrate 4, and then, as shown in FIG. 47 (b), e.g., resin black 61 with carbon or the like dispersed in photoresist is applied over the substrate 4. Although in FIGS. 47, 48, one step-like structure 80 is shown between source lines 60, a number of structures are actually formed.

Then, as shown in FIG. 47(c), by using a photomask 64, exposure and development are conducted, thereby forming black matrixes 61a in pattern so as to cover the source lines 60 and column-shaped bodies 61b comprised of resin black on the step-like structures 80 as shown in FIG. 47(d).

Then, as shown in FIG. 47(e), the reflective electrodes 2 are formed so as to cover the step-like structures 80 and lastly, color filters 66R, 66G, 66B are formed in matrix over the reflective electrode as shown in FIG. 47(f).

Thus, by using the thin films other than the thin films of the active elements, i.e., the black matrixes constituting the color filters, as the column-shaped bodies constituting the step-like structures, the shape of the step-like structures can be arbitrarily controlled. Metal chromium or the like may be also used as the black matrixes.

The column-shaped bodies constituting the step-like structures are not intended to be limited to the black matrixes, and each of the color filters 66R, 66G, 66B may be used as the column-shaped body.

The structure in the embodiments 1-14 may be applied to the embodiments 1-13.

### Embodiment 1-15

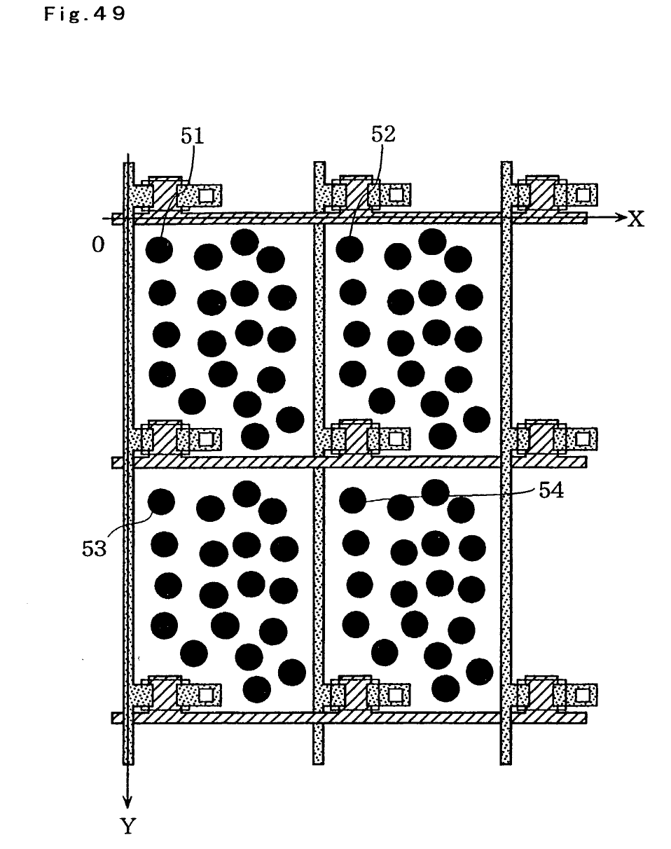

FIG. 49 is view schematically showing arrangement of circular-pattern layers in the reflective electrode used for a reflective liquid crystal display according to an embodiment 1-15.

Through the study so far, another new problem arises. In the step of manufacturing a plurality of reflective electrodes, it was revealed that variation in the reflection characteristic occurred. It was also revealed that the cause of the variation in the reflection characteristic was a margin in alignment in forming the circular-pattern layers.

Specifically, in the embodiments 1-14, the shape of the respective layers forming the circular pattern layers is controlled in forming layers by photolithography. Due to lack of consideration of mask alignment margin during exposure in the photolithography, the circular pattern layers are individually misaligned in the plane of the reflective electrodes, or the shapes of the step-like structures 80 comprised of the circular pattern layers are individually different from desired shapes. For this reason, variations occur in the inclination angle distribution of the concave/convex portions of the reflective electrode 2. Accordingly, the embodiment 1-15 is characterized in that, using a mask with deviation in a range less than alignment margin for each pixel, the layers are patterned, thereby preventing occurrence of variations in the reflection characteristic. In current TFT manufacturing process, the alignment margin of ±0.5 μm, and the whole margin of approximately 1 μm should be taken into account.

To be specific, with reference to FIG. 49, the coordinates of circular patterns 51, 52, 53, 54 present at the same positions in respective pixels are specified as follows. First, x-axis and y-axis are defined as parallel to the direction in which gate lines are arranged and as parallel to the direction in which signal lines are arranged, respectively. Further, the pitch of the pixels along the direction in which the gate lines are arranged is set to a μm and the pitch of the pixels along which the signal lines are arranged is set to b μm. Assuming that a center coordinate of the circular pattern 51 is (x0, y0) (μm), the coordinates of the circular patterns 52, 53, 54 should be 52(x0+y0), 53(x0, y0+b), 54(x0+a, y0+b).

In advance, the mask is designed so that these coordinates deviate toward respective directions in the range less than the alignment margin of the mask, for example, 52 (x0 +a−0.5, y0), 53(x0, y0+b−0.5), and 54(x0+a−0.5, y0+b−0.5). In actuality, since the alignment margin is ±0.5 μm, the center coordinates of the circular patterns deviate to be, for example, (x0−a+0.5, y0), (x0, y0−b+0.5), and(x0+a+0.5, y0+b+0.5), respectively.

The circular pattern layers formed within the range of this deviation form a concave/convex reflective electrode. The inclination angle distribution of the concave/convex portions on the reflective electrode (relative positional relationship of respective thin films forming the cumulated layer patterns) varies a little from pixel to pixel. But, this positional relationship is deemed to be constant in terms of all the pixel electrodes on the reflective electrode. That is, the reflection characteristic is deemed to be substantially constant in the whole reflective electrode regardless of the margin of the mask alignment.

A reflective electrode was produced by using the mask for patterning the respective layers, which is designed to have patterns with deviation in the range less than alignment margin. In the reflective electrode, the variation in the reflection characteristic observed in the above problem was not observed.

In this embodiment, by deviating the positions of drawn patterns on the mask pixel to pixel, the reflective electrode with less variations in the reflection characteristic and high diffusiveness was attained. While in the above embodiment, the pattern position deviates for each pixel, the pattern position may deviate for each of a plurality of regions into which one pixel is divided.

### Embodiment 1-16

Embodiment 1-16 relates to a technique of preventing variations in the reflection characteristic as in the embodiment 1-15.

The embodiment 1-16 is characterized in that the reflector has a shape structure comprised of two or more patterned thin films having plural types of cumulated layer patterns such that the order of the sizes of the thin films is different for each set of plural types of cumulated layer patterns.

By providing the above shape structure in the reflector, the variation in the reflection characteristic can be reduced by the plural types of cumulated layer patterns. Consequently, the reduction in controllability of the concave/convex shape of the reflective electrode can be suppressed. The shape structure can be used in the reflector like this embodiment, but also in an optical element (lens) or the like, which will be described in detail below.

In the above-mentioned steps, the shape of the layers forming the circular pattern layers is controlled in forming the layers by photolithography. The need for considering the alignment margin of the mask in exposure becomes manifest. In a current TFT process, the alignment margin is ±0.5 μm and, the margin of approximately 1 μm as a whole should be taken into account.

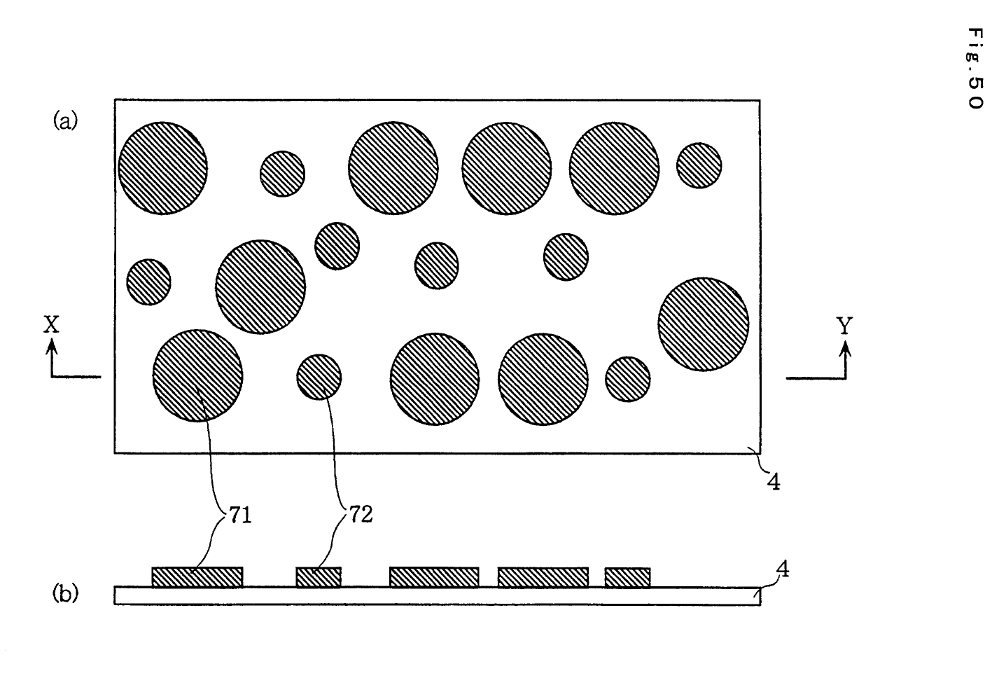

The reflective electrode of the embodiment 1-16 will be described with reference to FIG. 50. FIG. 50 is a partly schematic view of a substrate constituting a reflective liquid crystal display according to the embodiment 1-16, in which FIG. 50(a) is a plan view showing a shape of a gate metal layer formed on the substrate, and FIG. 50(b)is a cross-sectional view taken in the direction of arrows substantially along line X-Y of FIG. 50(a). The gate insulating film is irrelevant to the invention and therefore, is not illustrated for simplicity.

An arbitrary layer, for example, a gate metal layer made of A1, Cr or the like is formed on the substrate. Thereafter, using a mask (mask 73 in FIG. 50(a)) provided with desired patterns (circular patterns in FIG. 50(a)), resist is applied, and then exposure and development are conducted, followed by patterning of the gate metal layer. Thereafter, the gate insulating film made of silicon nitride SiNx or the like is formed.

As shown in FIG. 50, circular patterns of two sizes (gate metal layer), i.e., circular patterns 71 and circular patterns 72 smaller than the circular patterns 71 are provided on the substrate 4.

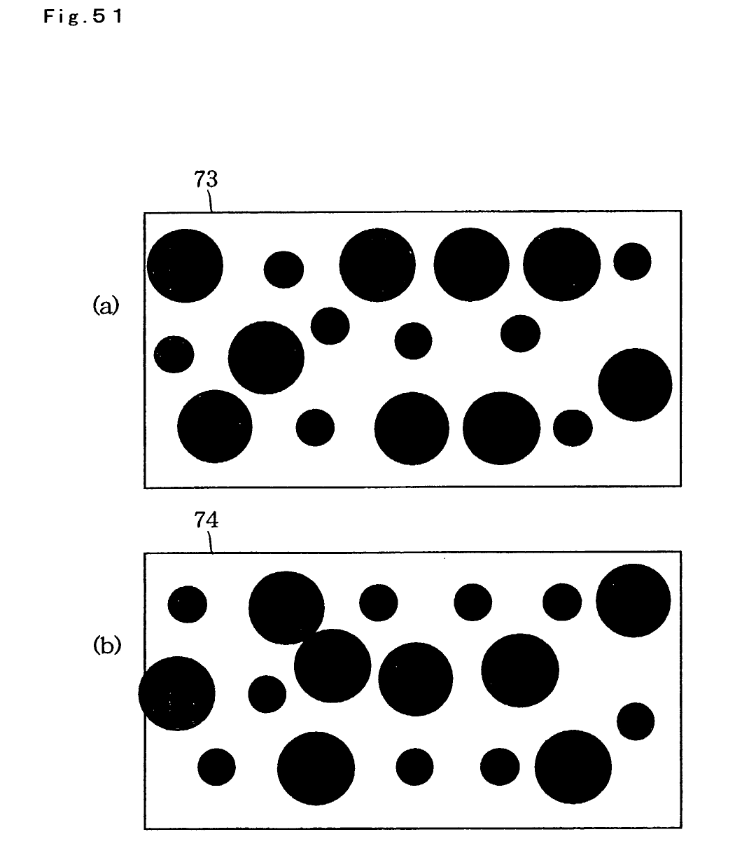

Then, a semiconductor layer such as a-Si is formed over the circular patterns 71 and the circular patterns 72 shown in FIG. 51. Using a mask (mask 74 in FIG. 51(b)) having the circular patterns 71 and the circular patterns 72 reversed in size, the shape is patterned. Herein, using the mask 74 in FIG. 51, resist is applied, and thereafter, exposure and development are conducted. Lastly, in an etching step, the semiconductor layer is patterned.

As shown in FIGS. 51(a), (b), the relationship between the mask 73 used in patterning of the gate metal layer and the mask used in patterning of the semiconductor film is that the large circular patterns 71 and the small circular patterns 72 formed in the mask 73 and the mask 74 are equal in number, respectively.

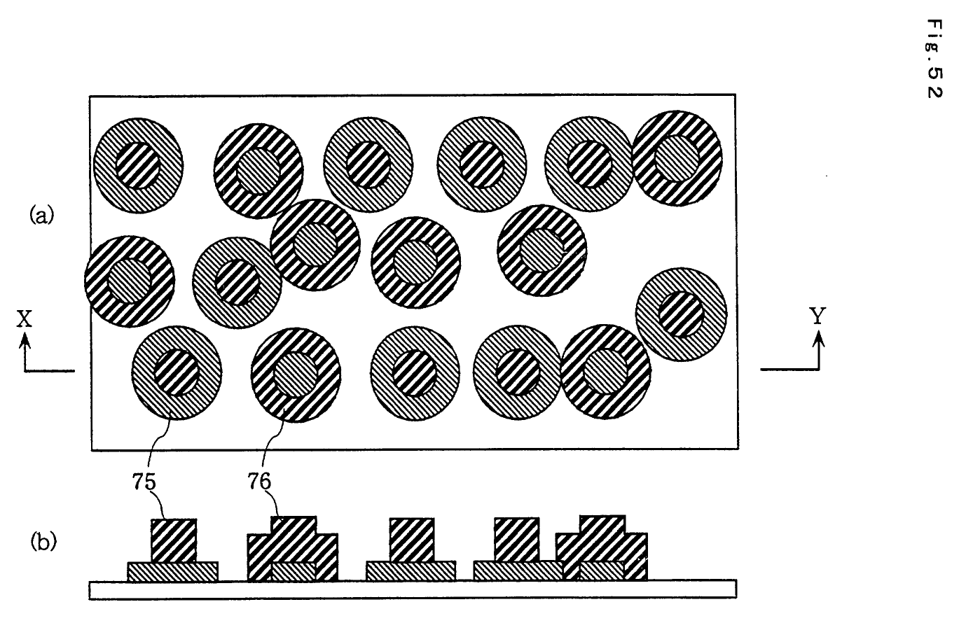

FIG. 52 is a schematic view showing patterns of the gate metal layer and the semiconductor layer formed on the substrate, in which FIG. 52(a) is a schematic plan view and FIG. 52(b) is a cross-sectional view taken in the direction of arrows substantially along line X Y of FIG. 52(a). The cumulated shapes are comprised of a shape 75 obtained by forming the small circular pattern on the large circular pattern and a shape 76 obtained by forming the large circular pattern on the small circular pattern.

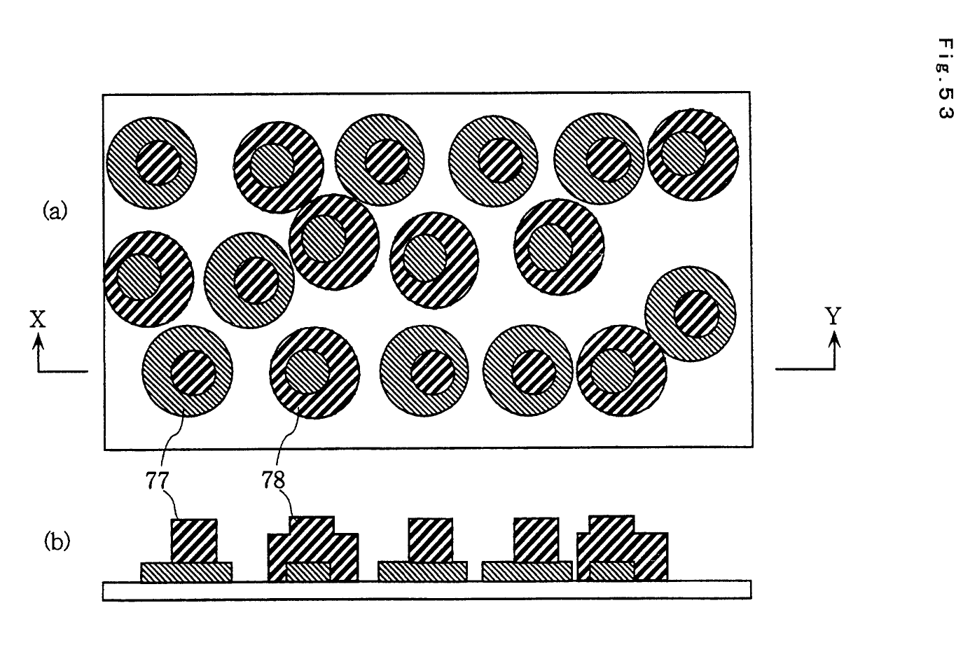

FIG. 53 is a schematic view showing patterns with the gate metal film and the semiconductor layer deviating on the substrate when mask misalignment occurs within a range of a margin δ in mask alignment from the state in FIG. 52, in which FIG. 53(a) is a schematic plan view thereof and FIG. 53(b) is a cross-sectional view taken in the direction of arrows substantially along line X-Y of FIG. 53(a).

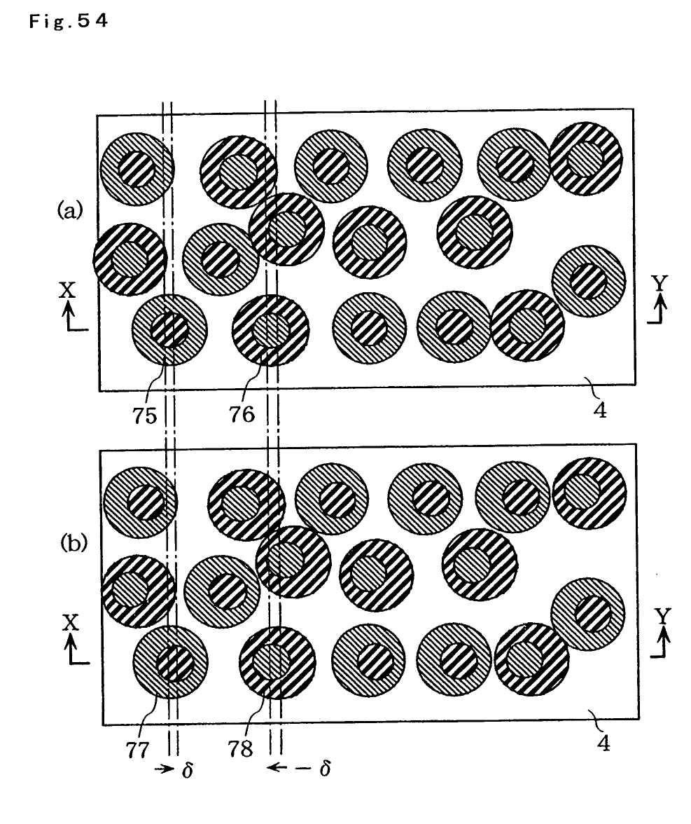

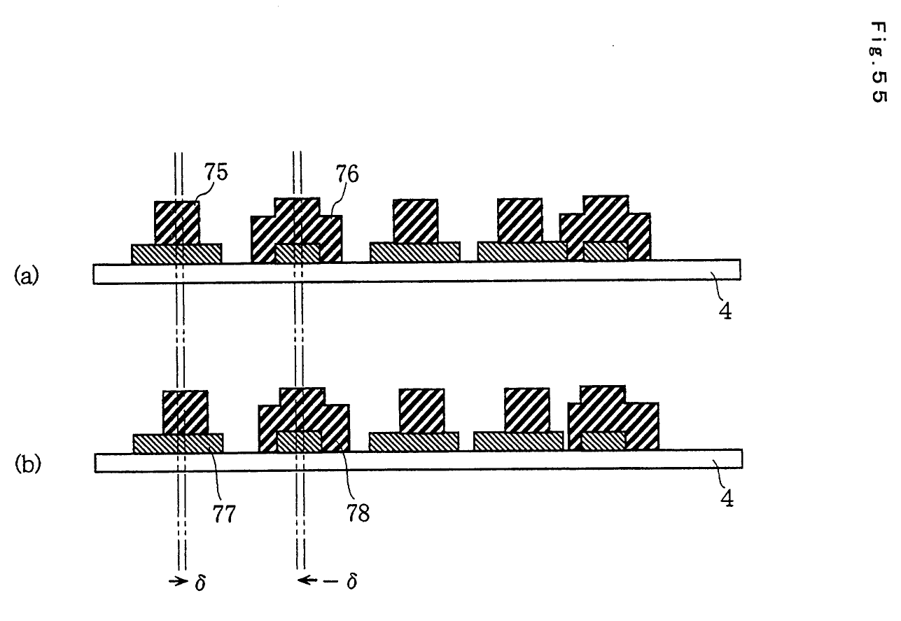

FIG. 54 is a schematic plan view of the substrate when the mask misalignment is 0 and the mask misalignment is δ. FIG. 55 is a cross-sectional view taken in the direction of arrows substantially along line X-Y of FIG. 54.

In FIGS. 54, 55, with regard to the positional deviation in centers of small circular patterns, in the cumulated layer patterns 77 with the small circular patterns formed of the semiconductor layer and the cumulated layer patterns 78 with the small circular patterns formed of the gate metal film, it is shown that the deviations are both δ in opposite directions. With such a structure, the finally obtained shape is less affected by the misalignment in mask alignment, thereby preventing variations in the reflection characteristic.

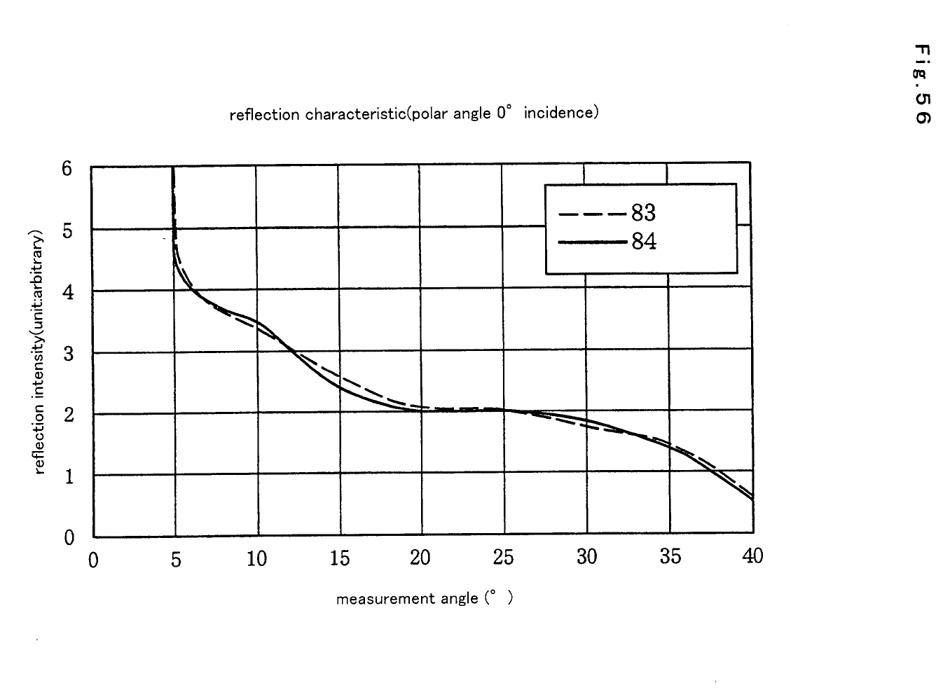

On the concave/convex shape, in the steps in the above embodiments, the layers were formed, and lastly, the metal layer with high reflectance, such as Al alloy or Ag alloy, was formed as the reflective electrode. Thereafter, the reflection characteristic was measured. The reflection characteristic of the reflector with mask misalignment 0 is represented by 83 and the reflection characteristic of the reflector with mask misalignment δ is represented by 84. As a result, as shown in FIG. 56, almost equal reflection characteristics were obtained.

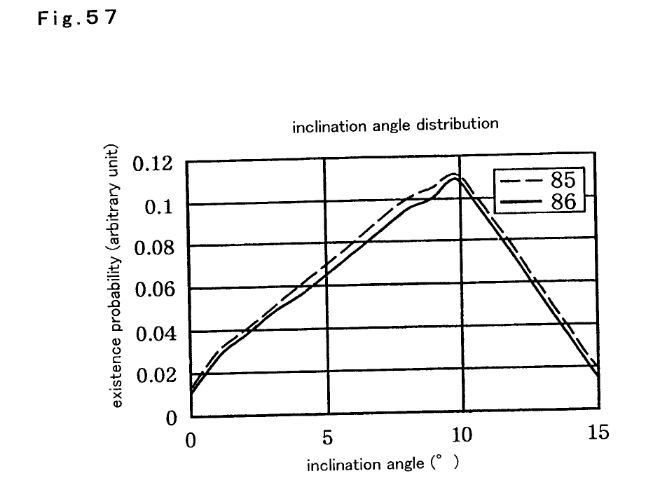

Also, the surface shapes were measured using an interatomic microscope AFM, and inclination angle distributions were calculated. As a result, as shown in FIG. 57, inclination angle distribution 85 of the reflector with mask misalignment 0 and inclination angle distribution 86 of the reflector with mask misalignment δ were almost equal.

Thus, in this embodiment, in the steps of forming layers, a pair of patterns with different sizes or shapes are formed such that the centers coincide with each other, in which case, provided that the ratio between them, i.e., the number of them, is equal, the reflector and the reflective liquid crystal display with reflection characteristic having less variation and high diffuseness was achieved, regardless of the positional deviations in the mask alignment.

While in this embodiment, circular patterns are used, the other shape can be used in the same manner provided that the shape is comprised of a pair of patterns formed in different layers to have the same positional relationship.

Moreover, in addition to the active elements, the shape having similar relationship between two layers may be used. Instead of the two layers, three or more layers may be used.

### Embodiment 1-17

In the reflective liquid crystal display manufactured in the steps in the above embodiments, new problems that mirroring occurs under environment in which ambient light is intense, for example, in sunny day, arise. The inventors of the present application researched the cause and it was revealed that the ratio of the flat portions to the concave/convex plane region was still high. This is because resolution limit of the patterning by photolithography is 2 μm and the flat portions are left between the patterns. For this reason, it becomes necessary to reduce the resolution.

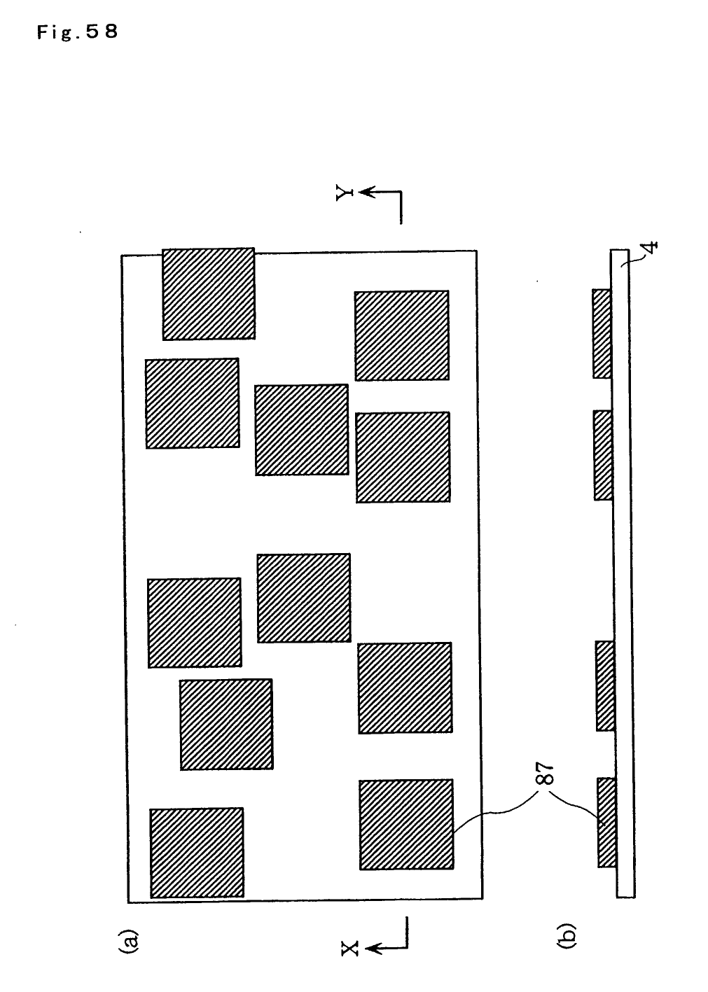

The manufacturing step of the reflective electrode in this embodiment will be described. An arbitrary layer, for example, a gate metal layer made of Al, Cr, or the like is formed on the substrate. Thereafter, using a mask with desired graphics, resist is applied and exposure and development is carried out. Then, patterning of the gate metal layer is conducted in the active element region and concave/convex plane region. Thereafter, a gate insulating film made of silicon nitride SiNx or the like is formed. FIG. 58 is a schematic view showing a shape of a pattern layer comprised of a gate metal layer after formation of a gate insulating film in a region where the concave/convex plane is formed, in which FIG. 58(a) is a plan view showing the shape of the pattern layer and FIG. 58(b) is a cross-sectional view taken in the direction of arrows substantially along line X-Y of FIG. 58(a). The gate insulating film is irrelevant to the invention and therefore, is not illustrated for simplicity.

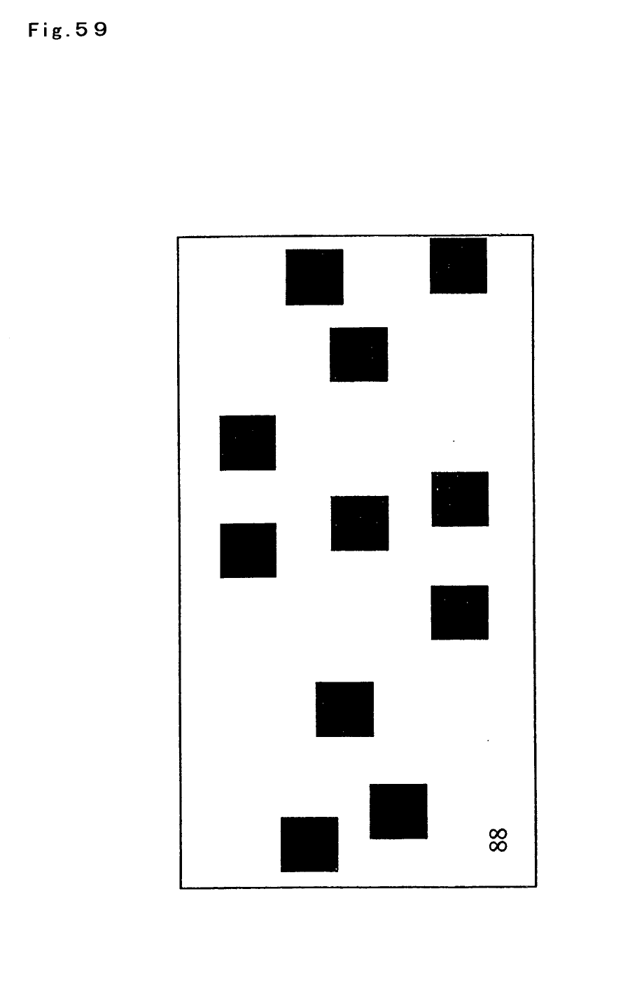

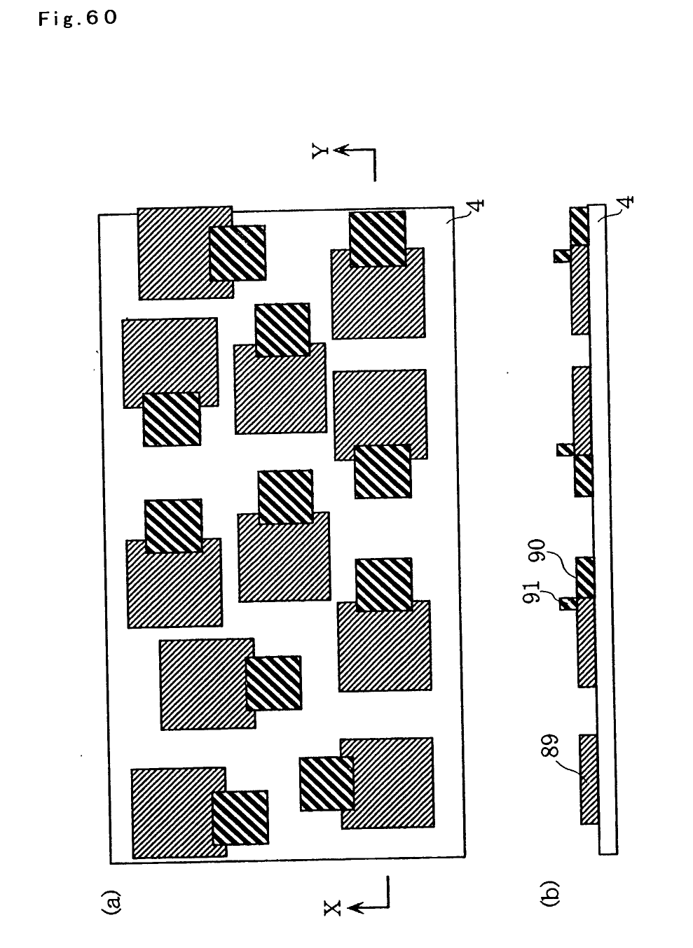

After the above step, the semiconductor layer such as a-Si is formed. Here, using a mask 88 in FIG. 59, resist is applied and then exposure and development is conducted. Lastly, in the etching step, the semiconductor layer is patterned. FIG. 59 is a schematic plan view of a mask used in embodiment 1-17. FIG. 60 is a schematic view of a substrate provided with a pattern layer comprised of the semiconductor layer in the region where the concave/convex plane is formed, in which FIG. 60(a) is a schematic plan view of the substrate after the patterning step of the semiconductor layer, and FIG. 60(b) is a cross-sectional view taken in the direction of arrows substantially along line X-Y of FIG. 60(a).

As shown in Fig, 60, the cumulated shape is comprised of large square pattern layers (gate metal layers) 89, small square pattern layers (semiconductor layers) 90, and overlapping portions between the pattern layers 89 and the pattern layers 90. If the alignment precision of the mask 88 in FIG. 59 is 1 μm or less, the overlapping portion 91 can be set to 1 μm or less. Therefore, since the ratio of the flat portions can be reduced by setting the overlapping portion to 1 μm or less, i.e., by reducing the resolution, the reflective liquid crystal display with small intensity of the light reflected in the regular reflection direction and less mirroring under intense ambient light environment, can be attained.

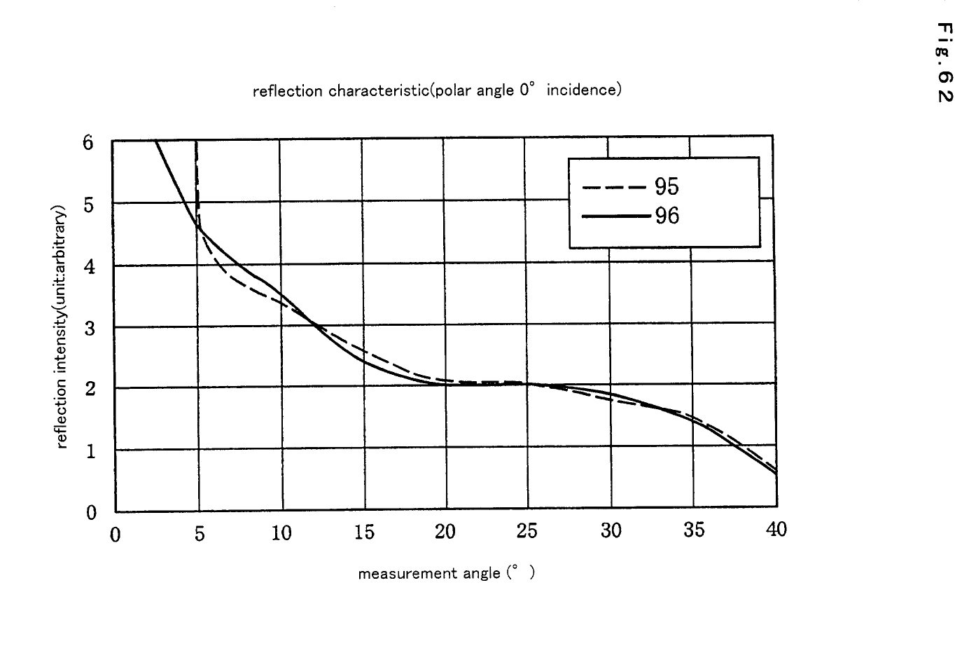

Based on this principle, the reflective electrode was manufactured utilizing the steps of forming layers in an active matrix array step so that the patterns have overlapping portions. FIG. 62 is a graph showing comparison between the reflection characteristic of the reflector without overlapping portion (i.e., the ratio of the area of the flat portions is high) and the reflection characteristic of the reflector shown in the embodiment 16. As shown in FIG. 62, reflection characteristic 96 of the reflector in this embodiment has reflection intensity in the regular reflection direction that is lower than that of reflection characteristic 95 of the reflector without overlapping portion.

Thus, in this embodiment, by forming the layers constituting the array so as to have the overlapping portion in the layer forming steps, the reflective electrode and the reflective liquid crystal display, with small intensity of the light reflected in the regular reflection and less mirroring under intense ambient light environment, can be attained.

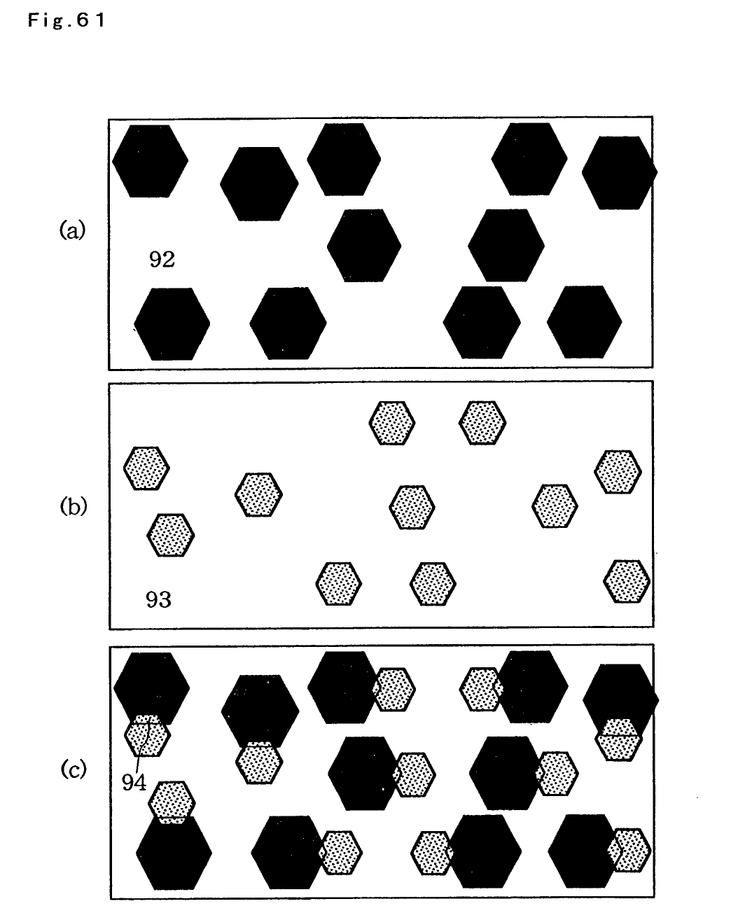

It should be appreciated that, while the square patterns are used in this embodiment, for example, circular patterns, or polygon patterns such as hexagon patterns in FIG. 61 may be used provided that two layers (gate metal layer and semiconductor layer) have overlapping portions after the step of forming these layers. FIG. 61 is a schematic view of another mask used in the embodiment 1-17. A mask 92 and a mask 93 in FIGS. 61(a), 61(b) are designed to have an overlapping portion 94 as shown in FIG. 61(c).

The pattern shapes of the two layers need not be identical. For example, the circular pattern and the polygon pattern may have the overlapping portion.

In this embodiment, the resolution limit of photolithography has been described. The other patterning means may be employed by generating overlapping with a width smaller than the minimum width of the patterns.

### The other Items Relating to First Invention Group

(1) Either dry etching or wet etching may be employed in the etching in the above-mentioned embodiments 1-9.

(2) While in the embodiments 1 through 17, the reflector comprising the inverse stagger TFTs has been described, the present invention is applicable to the reflector comprising forward stagger TFTS.

(3) The TFTs in the embodiments 1 through 17 may be comprised of amorphous silicon or polycrystalline silicon. The TFT as the active element in the embodiments 1 through 14 may be replaced by MIM elements.

(4) In the embodiments 1 through 17, the surface of the insulating substrate is the flat plane. Instead, the surface of the insulating substrate may be etched by, for example, sand blasting in advance, thereby forming base column-shaped bodies in the region where the concave/convex plane is formed, and then part of the layers constituting the TFTs may be formed on the base column-shaped bodies, thereby forming the step-like structures including the base column-shaped bodies.

(5) In the above embodiments, the step-like structure is comprised of a plurality of cumulated column-shaped bodies with the width sequentially reduced so as to have the taper shape. The step-like structure is not intended to be limited to this, and may be comprised of a plurality of cumulated column-shaped bodies having width which is not sequentially reduced.

### Second Invention Group

Hereinafter, a reflective display panel (reflective liquid crystal display panel) of the present invention will be described with reference to drawings.

### Embodiment 2-1

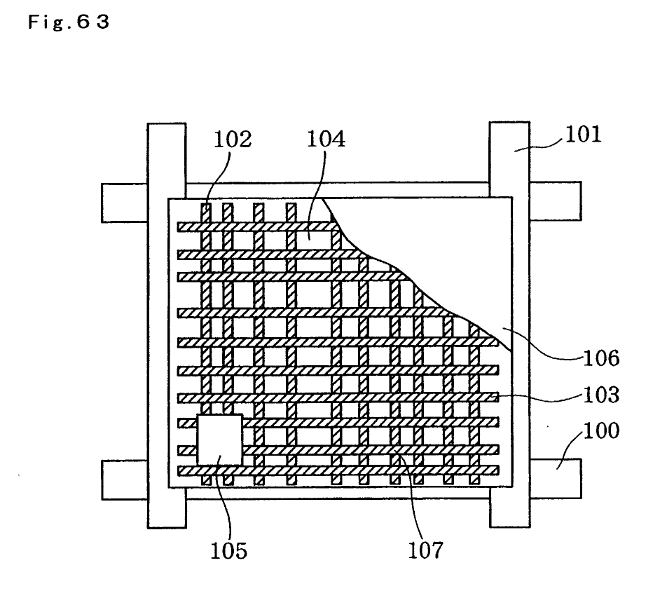

FIG. 63 shows a plan view of an array substrate constituting a liquid crystal display panel according to an embodiment 2-1. A reflective layer 106 is formed over gate lines 100 and source lines 101.

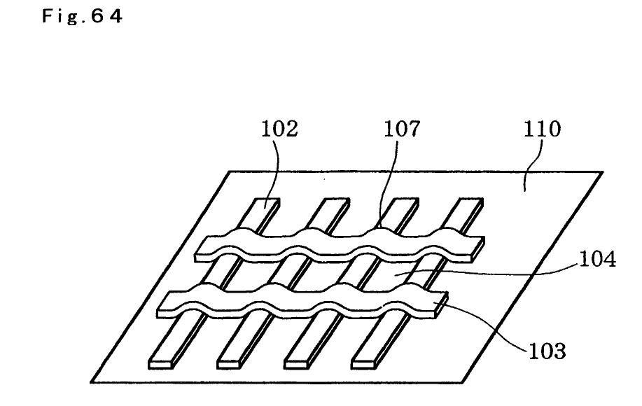

Under the reflective layer 106, first convex portions 102 and second convex portions 103 cross each other in the shape of meshes. Concave portions 104 are each formed between the meshes. Also, the size of the meshes is random so that diffraction, interference, or the like is not generated.

Where the first convex portion 102 and the second convex portion 103 cross each other, the highest convex intersection 107 formed of the two layers is formed on the reflection plane. FIG. 64 is a schematic view showing that the first convex portions 102 and the second convex portions 103 cross each other. At convex intersections 107, the two layers are superposed to be the highest.

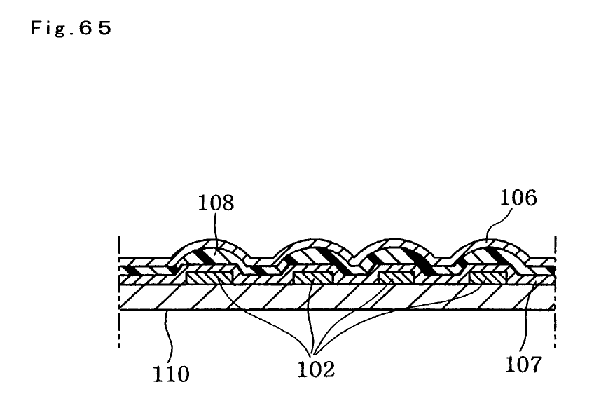

Then, as shown in FIG. 65, a flattening layer 108 is formed over the above structure, and thereafter, a reflective layer 109 is provided over the flattening layer 108, which smoothes the convex portions and the concave portions, thereby forming the concave/convex structure with the convex apexes 107 and concave portions 104, thus forming concave/convex portions of the reflective layer 106.

The convex portions of the reflection plane are band-like convex portions as can be seen from the above, and further, a plurality of layers are formed in the form of cross, thereby forming the convex intersections 107 that are inevitably the highest from the reflection plane at the crossing portions. With this structure, the shapes of the convex intersections are almost the same and productivity is improved regardless of the mask misalignment. For example, assume that the second convex portions 103 as the upper layer deviate to the right in FIG. 1 from the first convex portions 102. In this case, the reflection performance is constant because the position of the convex intersections 107 remain unchanged. Even with upward deviation, the entire convex intersections deviate upwardly, and therefore, the reflection performance is almost constant in the entire reflection plane. Consequently, inferiority due to the mask misalignment is greatly reduced and productivity is improved.

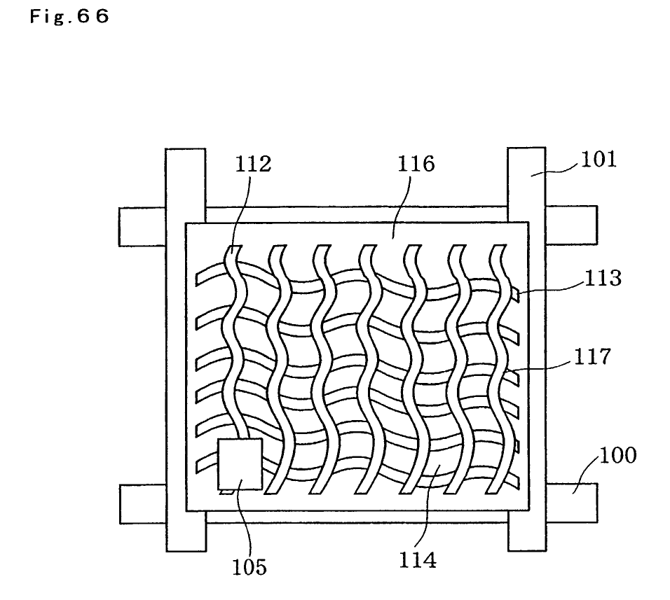

FIG. 66 is a view of another structure of the embodiment 2-1. The embodiment 2-1 is characterized in that first convex portions 112 and second convex portions 113 are formed as curved bands. The use of curved convex portions makes it possible that the concave portions 114 have various shapes, and desired reflection characteristic is easily obtained. This is because the inclination angle distribution after forming the flattening layer can be more easily controlled with the use of variously shaped concave portions. Also, if the first convex portions 112 do not cross each other and the second convex portions 113 do not cross each other when the curved convex portions are used, the reflection performance is nearly constant regardless of the mask misalignment as described above. In addition, the use of the curved convex portions makes it difficult to generate the diffraction and interference of the reflected light. This is because symmetry in vertical, lateral, and oblique directions of the band-shaped convex portions is significantly reduced.

As a matter of course, the concave portions having random intervals make it further difficult to generate diffraction and interference of the reflected light.

Subsequently, a specific example of the embodiment 2-1 of the present invention will be described with reference to FIGS. 63, 64, 65.

Using the process of forming the TFT devices, the gate lines, the source lines, and the like, the convex portions are formed on the array substrate. In this case, the first convex structures 102 are formed in the shape of stripe bands to be 10 μm wide and 0.5 μm high, using the step of forming the gate oxidation film. Following this, the second convex structures 103 are formed in the shape of stripe bands to be 10 μm wide and 0.5 μm high, using the step of forming the source lines. In this case, the vertical difference at the convex intersections obtained by forming the two layers was 1 μm. Thus, by forming the band-like convex portions using the process of manufacturing the array substrate and the materials identical to the materials of the TFT devices, peripheral wires, and the like, the manufacturing step is simplified and the productivity is improved.

Subsequently, the flattening layer 108 was formed to be 0.5 μm thick and melted by thermal annealing to have a desired inclination angle, and then the reflective layer 109 was formed using aluminum. The average inclination angle of the reflective layer 109 was about 11 degrees at maximum.

The liquid crystal display panel was manufactured using the array substrate and the opposing substrate. The reflectance of the panel was 36% and high luminance panel was attained.

For examining the margin of the mask alignment, the mask used in forming the second convex structures 103 was intentionally deviated, and comparison is made between the associated reflectance and the reflectance of the conventional panel.

In the case of the conventional column-shaped convex portions, when the diameter of the first convex structures is 10 μm, the column shapes become asymmetrical with deviation of 2 μm or larger. Consequently, desired inclination angle distribution was not obtained. For this reason, the reflection performance was significantly reduced. Besides, due to variations in the deviation in the panel, the luminance variation in the panel occurred.

Also, when the panel was manufactured using a large-sized glass substrate in a manufacture line, the mask misalignment was further increased depending on the position of the panel in the glass. As a result, the panel with constant display performance was not obtained.

On the other hand, in accordance with the structure of the present invention, only the positions of the convex intersections 107 deviate as the whole, but the reflection performance was almost constant regardless of the deviation of approximately 10 μM in the mask positions. Consequently, productivity was significantly improved.

The convex structures are not intended to be limited to the above example, but can be formed using an arbitrary layer in the array process. For example, the convex structures may be formed using the a-Si layer. The number of the layers may be two or more.

Further, after forming the flattening layer over the source lines, the gate lines, or the like, independently of the array process, the convex portions may be formed using the photosensitive resist. In that case, the similar display performance is obtained.

Other than the above stripe structure, the convex structure may be curve structure shown in FIG. 66, or otherwise may be a mixed structure of stripes and curves. For example, the curve structure may be formed within the pixels, and the stripe structure may be formed only in the vicinity of the contact hole 105, thereby efficiently arranging the convex portions. In the case of the curve structure, the shape of the contact hole 105 maybe curved according to the adjacent curved structure. Also in that case, the convex portions can be efficiently arranged. By efficiently arranging the convex portions, the flat regions with small inclination angle are reduced, and reflectance is improved.

The thickness of the flattening layer may be approximately 2 μm or less, other than the above-identified 0.5 μm. The film thickness can be arbitrarily selected according to the size of the largest vertical difference of the convex portions, the size and shape of the concave portions, and the shape of the upper surfaces of the convex portions.

While in the above example, the reflective liquid crystal display panel is entirely provided with the reflective layer, semi-transmissive liquid crystal display panel provided with apertures in the reflective layer may be adopted. In this case, other than the circular shape, the square shape, and the rectangular shape, the shape of the apertures may be varied according to the structure of the adjacent band-like convex portions, thereby efficiently arranging the convex portions.

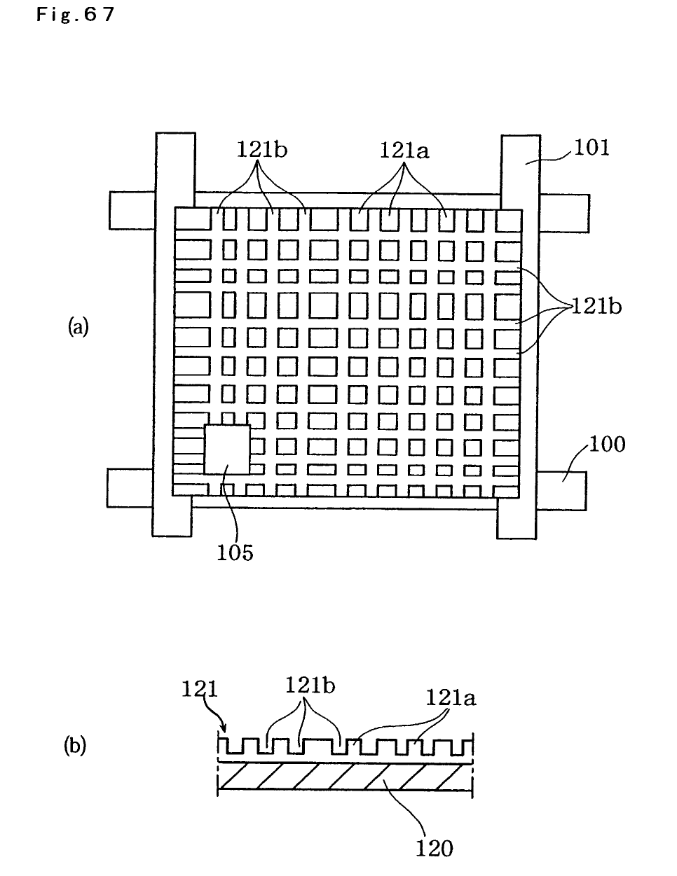

Instead of the concave/convex structure using the band-like convex portions in the above example, the concave/convex structure shown in FIG. 67 may be used. To be specific, a gate insulating film 121 is formed on a substrate 120, and is structured to have convex portions 121a (have band-like concave portions 121b) in matrix by photolithography and etching techniques or the like. Alternatively, the band-like convex portions and concave portions may be combined.

While in the above example, the band-like convex portions are combined to form the concave/convex structure, the concave/convex structure may include the shapes other than the band-like convex portions. For example, an independent convex potion may be formed in the concave portion. The independent convex (for example, cylindrical, or polygon-column) portion in the concave portion further facilitates control of the inclination angle of the concave portion and achieves improved reflectance.

The band-like convex portions are not necessarily continuous, but may be partially discontinuous. According to the mask misalignment, for example, when the deviation is small, the band-like convex portions may be designed so that the band-like convex portions are formed in the shape of cross from the centers of the convex portions based on the standard intersections. Also, the same effects are provided.

### Embodiment 2-2

A backlight system, a drive circuit portion, a casing or the like were added to the liquid crystal display panel of the embodiment 2-1, thereby creating the reflective liquid crystal display.

The convex portions were randomly spaced, thereby obtaining satisfactory display without generating diffraction, interference, or coloring.

### Embodiment 2-3

The same structure as that of the reflective layer used in the liquid crystal display panel in the embodiment 2-1 was formed on the substrate, thereby obtaining a reflector. With the reflector of this structure, even when a plurality of convex portions or concave portions are formed into the concave/convex structure, pattern deviation due to the mask misalignment did not occur, and as a result, a diffusive reflector with uniform reflection performance in a large area was obtained.

### The others Relating to Second Invention

(1) In the above embodiments, the reflective liquid crystal display panel using liquid crystal has been illustrated, as light control means. The reflective display panel of the present invention is not intended to be limited to the display panel using liquid crystal. The reflective display panel of the present invention is applicable to reflective display panels other than the liquid crystal display panel, for example, electrophoresis display panels adapted to control absorption and transmission of light by moving fine particles dispersed in a solution in an electric field.

### Third Invention Group

### Embodiment 3-1

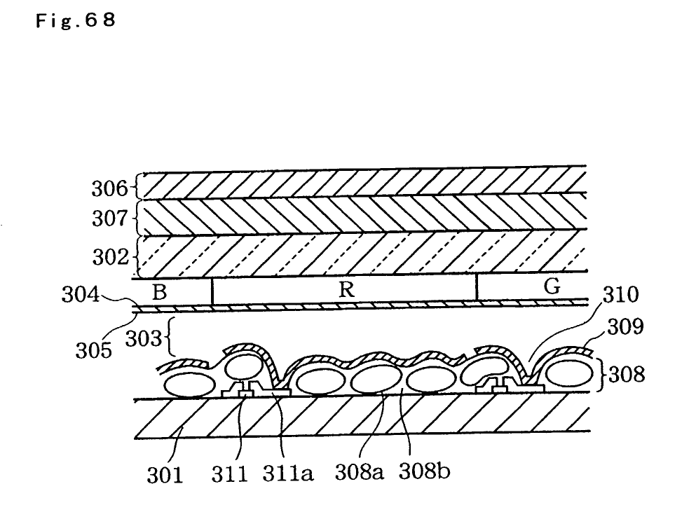

An embodiment of the reflector and the reflective display panel of the present invention will be described with reference to Figures. FIG. 68 is a schematic cross-sectional view of the reflective liquid crystal display panel using liquid crystal as light control means and is a cross-sectional view of one pixel at the center of a display portion. In FIG. 68, some components are omitted and actual scaling is different.

As shown in FIG. 68, the reflective liquid crystal display panel is a so-called reflective color liquid crystal display panel of one polarizer type. There is a predetermined gap between a substrate 301 and an opposing substrate 302. A liquid crystal layer 303 contains liquid crystal filled into this gap. The opposing substrate 302 is provided with color filters 304 corresponding to red R, green G, and blue B for respective pixels and a common electrode 35 comprised of a transparent conductive film on an inner side of the color filters 304. A polarizer 306 and a retardation film 307 are provided on an outer side of the opposing substrate 302.

A resin layer 308 having a concave/convex shape on the surface is provided over the substrate 301. A reflective member 309 is formed over the resin layer 308 for reflecting incident light. The role of the concave/convex portions of the surface of the resin layer 308 is to diffuse the reflected light to suppress mirroring of the light source and obtain visibility associated with reflectance, viewing angles, and the like.

The resin layer 308 is structured such that second resin portions 308a made of second resin are dispersed and held in a first resin portion 308b made of first resin, and the convex shape of the resin layer 308 conforms to the second resin portions 308a.

The second resin portions are drop-like portions having a thickness of approximately 2 μm and a diameter of approximately 10 μm. The difference in thickness of the resin layer 308 between the center portion of the drop-like portions of the second resin portions(top portion of the convex shape of the resin layer)and the portion between the drop-like portions (bottom portion of the concave shape of the resin layer) is approximately 0.5 μm. It should be appreciated that, the thickness, diameter and thickness difference of the second resin portions may have values different from the above values. Also, instead of the drop-like portions, bar-like portions may be used.

The second resin portions are generated as a result of phase separation from a mixed solution containing the first resin, the second resin, and a solvent. The second resin portions are spontaneously, and hence, irregularly arranged. The phase separation is a phenomenon in which a mixed solution containing compatible different materials are separated into higher-ratio phases of respective materials.

The reflective member 309 on the resin layer 308 is formed of metal containing aluminum with high reflectance as a major component in the thickness of approximately 0.2 μm. The reflective member may be made of a metal containing metal other than aluminum, for example, silver, as a major component.

The reflective member 309 is defined for each pixel and also serves as a pixel electrode. The reflective member 309 is connected to a drain terminal 311a of a drive element 311 on the substrate 301 through an aperture (contact hole) 310 penetrating through the resin layer 308. This structure makes it possible that the drive element 311 on the substrate 301 changes the voltage being applied between the reflective member 309 as the pixel electrode and the common electrode 305, thereby enabling display operation.

In this structure, the light incident from the side of the opposing substrate 302 travels through the polarizer 306, the retardation film 307, the opposing substrate 302, the color filters 305, and the liquid crystal layer 303, and is reflected by the reflective member 309. The light travels through in the reversed order and is observed by a viewer observing the reflective display panel. In this case, by controlling the voltage being applied to the liquid crystal layer, the absorption and transmission of light can be controlled. In this manner, the liquid crystal layer is used as a light control means.

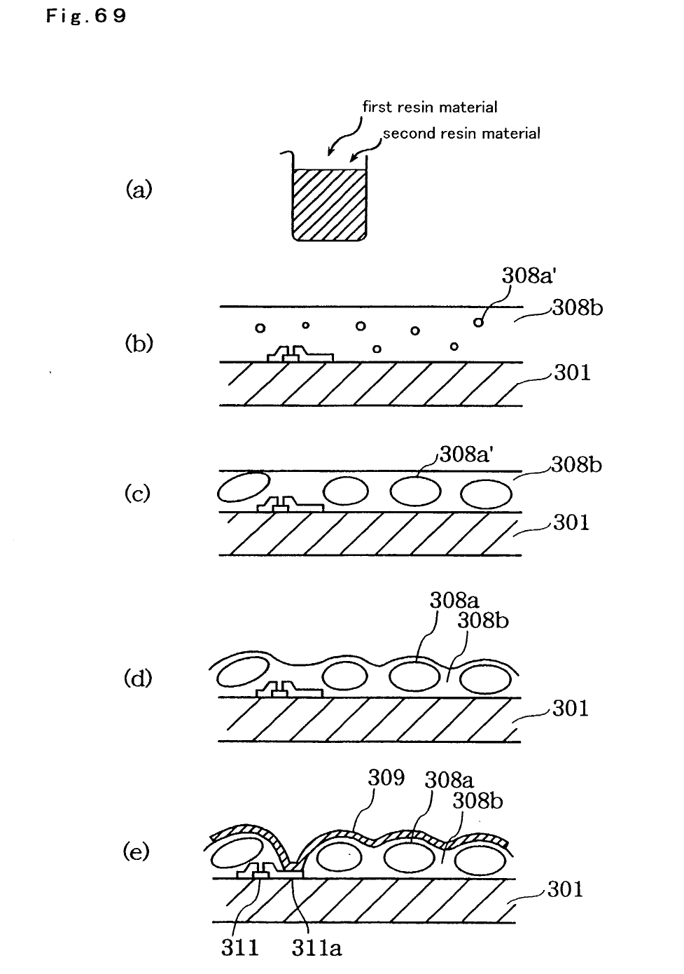

Subsequently, a step of forming convex/concave portions of the resin layer 308 of the reflective display panel of the present invention will be described with reference to FIG. 69. FIG. 69 is a schematic explanatory view showing a step of forming the resin layer of the reflective display panel according to an embodiment 3-1 of the present invention.

First of all, as shown in FIG. 69(a), a mixed solution was created by dissolving the first resin and the second resin having photosensitivity into a common solvent. In this case, the first resin was an acrylic-based positive photosensitive material and the second resin was styrene-based positive photosensitive material. The ratio between the first resin and the second resin was 40:60 weight percentage. The solvent was propylene glycol monomethyl ether acetate (PGMEA). As the second resin, a material with solubility to PGMEA as the common solvent that is lower than that of the first resin was selected. Another materials may be used as the first and second resins, and the solvent, provided that the first and second resins have different solubilities to the common solvent.

Then, the mixed solution was applied over the substrate 301 provided with the drive element 311 and the terminal 311a of the drive element and then pre-baked. The application was conducted by spin coating and the pre-baking was conducted in such away that the substrate was placed on the hot plate set to have a certain temperature. When the solvent was dried by pre-baking, the second resin is phase-separated and aggregates as shown in FIG. 69(b), because the second resin is less soluble to the solvent in the mixed solution than the first resin.

Then, as shown in FIG. 69(c), after the second resin aggregated to be formed into the second resin portions, the first resin was left and became the first resin portion, which covered the second resin portions.

In this manner, as shown in FIG. 69(d), after pre-baking, the second resin portions 308a made of the second resin were dispersed and held in the first resin portion 308b made of the first resin, thus forming the resin layer. Since the first resin and the second resin are materials of different surface tensions, the surface of the resin layer conforms in shape to the second resin portions and minute concave/convex portions were formed on the surface of the resin layer.

When the pre-baking is carried out at a temperature around 100° C., the solvent rapidly volatilizes from the mixed solution after application. Consequently, the time during which the second resin aggregates becomes short and the size of each of the second resin portions becomes small as shown in FIG. 6. When the second resin portions are small, the surface of the resin layer 8 is almost even, without concave/convex portions. For this reason, after application, two-stage pre-bakings, i.e., the pre-baking at a low temperature of 20-30° C. higher than normal temperature and pre-baking at a high temperature around 100° C. were carried out.

Specifically, the resin layer was dried for 5 minutes on the hot plate of 50° C. and then dried for 2 minutes on the hot plate of 100° C. Thereby, the solvent slowly volatilized during the low-temperature pre-baking and therefore the second resin aggregated to be formed into the structure of FIG. 69(c) and then, the solvent volatilized from the first resin and second resin during the high-temperature pre-baking, there by obtaining a shape of FIG. 69(d).

Instead of the low-temperature pre-baking, as an alternative to or addition to this step, a dry step by reduced pressure dry or ventilation may be employed. This also makes it possible that the solvent volatilizes more slowly than the solvent in the high-temperature pre-baking, and thereby the drop-like portions of the second resin are grown to be into the second resin portions, thus obtaining concave/convex portions on the surface of the resin layer as described above.

After forming the resin layer having the concave/convex portions on the surface by the above method, mask exposure for exposing only apertures, development, and rinsing steps were conducted, thereby removing the resin layer over terminals of the drive elements provided on the substrate 301, to form the contact holes. Then, the resin layer was calcined for one hour in a thermostat at a temperature of 200° C. which is equal to the curing temperature of the resin 1 and the resin 2. After calcination, the reflective member 309 mainly comprised of aluminum was film-formed over the resin layer and was subjected to photolithography and etching steps, thereby performing patterning in the form of pixels as shown in FIG. 69 (e). The reflective member 9 patterned in the form of pixel was connected to the drain terminal 311a of the drive element 311 on the substrate through the contact hole formed in the resin film.

Then, on the substrate 301 with the patterned reflective member, an alignment layer (not shown) for aligning the liquid crystal of the liquid crystal layer in a predetermined direction was formed. Meanwhile, the alignment layer was formed on the opposing substrate 302 provided with the color filters 304 and the common electrode 305, similarly to the substrate 301. The substrate 301 and the opposing substrate 302 were bonded to each other with a certain gap between them, and into the gap, the liquid crystal was filled. Thereafter, a polarizer 306 and a retardation film 307 were bonded onto the opposing substrate 302, thereby completing a reflective liquid crystal display panel of this embodiment shown in FIG. 68.

As described above, in accordance with the method of manufacturing the reflective display panel of the present invention, unlike in Japanese Laid-Open Patent Application Publication No. Hei. 6-27481, two step of 1) forming protrusions as the base of concave/convex portions and 2) applying the resin layer over the protrusions for smoothness, need not be conducted, and the resin layer having concave/convex portion on the surface can be obtained through one step, and therefore, the steps can be simplified and satisfactory reflective characteristic can be obtained.

When forming the concave/convex portions on the surface of the resin film according to the present invention, the arrangement of the concave/convex portions is spontaneously determined, and therefore, irregular concave/convex shape is provided on the surface of the resin layer. This follows that moire caused by regularity of arrangement of the concave/convex portions is not generated.

In addition, in accordance with the present invention, minute concave/convex portions can be formed on the surface of the reflector. In particular, the vertical difference between the concave/convex portions can be set to be as small as 0.7 μm or less. Consequently, the reflector having more satisfactory reflection characteristic can be obtained.

The size of the second resin portions depends on two conditions, i.e., 1) ratio between the first resin and the second resin, and 2) pre-baking condition of the resin layer, which is described above. With regard to 1), in this embodiment, the ratio of the second resin to the total of the first and second resin is set to 40 weight %, but when the ratio is generally smaller than 50 weight %, the thickness of the drop-like portions is smaller relatively to the thickness of the film, so that the concave/convex portions are not formed on the film surface. On the other hand, when the ratio is larger than 50 weight %, the thickness of the second resin portions is larger relatively to the film, thereby obtaining the concave/convex portions on the surface of the resin layer.

While in this embodiment, single solvent is used, plural types of solvents may be mixed. For example, the first resin soluble to a solvent A and second resin soluble to a solvent B are dissolved in a mixed solvent of the solvents A, B, to be created into a mixed solution. In this case, the solvent B is more volatile than the solvent A. Under the condition, during pre-baking, the solvent B first volatilizes from the mixed solution and the second resin less soluble to the solvent A first aggregates. Also, in this method, the resin layer with the second resin portions being dispersed and held in the first resin portion can be obtained, and the effects provided by the above embodiment can be obtained.

While in this embodiment, the solvent is used, the solvent need not be used provided that the first resin and the second resin have compatibility.

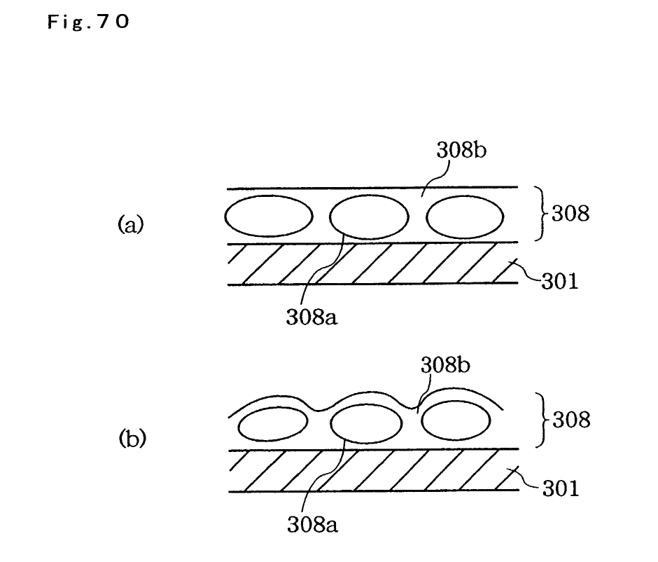

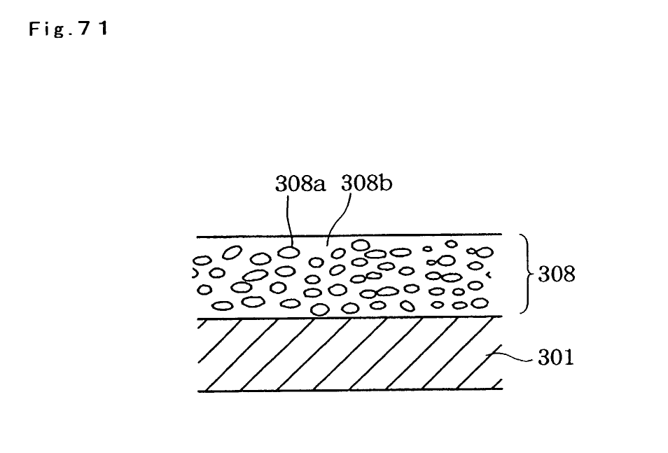

While in this embodiment, the second resin aggregates during pre-baking, thereby forming a resin film with the second resin portions being dispersed and held in the first resin portion. By using a material with shrinkage factor by heating during curing that is different from that of the second resin, as the first resin, larger concave/convex portions can be formed on the surface of the resin layer. FIG. 70 shows this state. FIG. 70 is a schematic explanatory view for explaining how the concave/convex shape is formed on the surface of the resin layer of the reflective display panel.

As shown in FIG. 70(a), in the case where there are no or little concave/convex portions on the surface of the resin layer after pre-baking, when the first resin has higher shrinkage factor, the thickness of the first resin portions 8b becomes small after curing as shown in FIG. 70 (b), thus allowing required concave/convex portions to be formed on the surface of the resin layer 8.

In this embodiment, the first resin and the second resin are photosensitive materials. This allows the pixel electrode to be connected to the terminal of the drive element through the aperture. It should be appreciated that, when the size of the aperture is sufficiently larger than the size of the second resin portions made of the second resin, the second resin is not necessarily a photosensitive material. In this case, provided that the first resin is the photosensitive material, the second resin portions located at the apertures are simultaneously cleaned and eliminated during mask exposure, development, and cleaning, and therefore, the apertures can be formed.

The second resin may be a resin which is liquid after pre-baking and solidified after calcination of the first and second resin. For example, when epoxy-based resin being liquid at normal temperature before curing is used as the second resin, this is liquid when the second resin portions aggregate during pre-baking. For this reason, when forming apertures in the resin layer, the second resin portions located at the apertures can be cleaned away in the step of development and cleaning of the first resin portion. The following calcination thermally crosslinks and solidifies the second resin portions held in the first resin portion. In this method, the material without photosensitivity may be used as the second resin.

While in this embodiment, so-called active matrix liquid crystal display panel that is adapted to control the voltage being applied for each pixel by the drive element on the substrate, corresponding to each pixel, has been described, the reflective display panel of the present invention may be constituted such that the drive element is not formed for each pixel. In the case where the drive element is not formed for each pixel, for example, a substrate provided with a comb-shaped reflective member and an opposing substrate provided with a comb-shaped transparent electrode are placed such that the combs are oriented so as to be perpendicular to each other and bonded as spaced to have a certain gap. Liquid crystal is filled into the gap, and the voltage is applied to each pixel defined by crossing points of electrodes of the upper and lower substrates, which is called passive matrix type liquid crystal display panel. In the passive matrix type, there is a STN (super twist nematic) type liquid crystal display panel in which a twist angle of liquid crystal in the gap between the upper and lower substrates has 180 degrees or more. When the drive element is not formed for each pixel, the aperture penetrating through the drive element need not be formed in the resin layer. Therefore, the material having no photosensitivity can be used as the first resin and the second resin.

### Embodiment 3-2

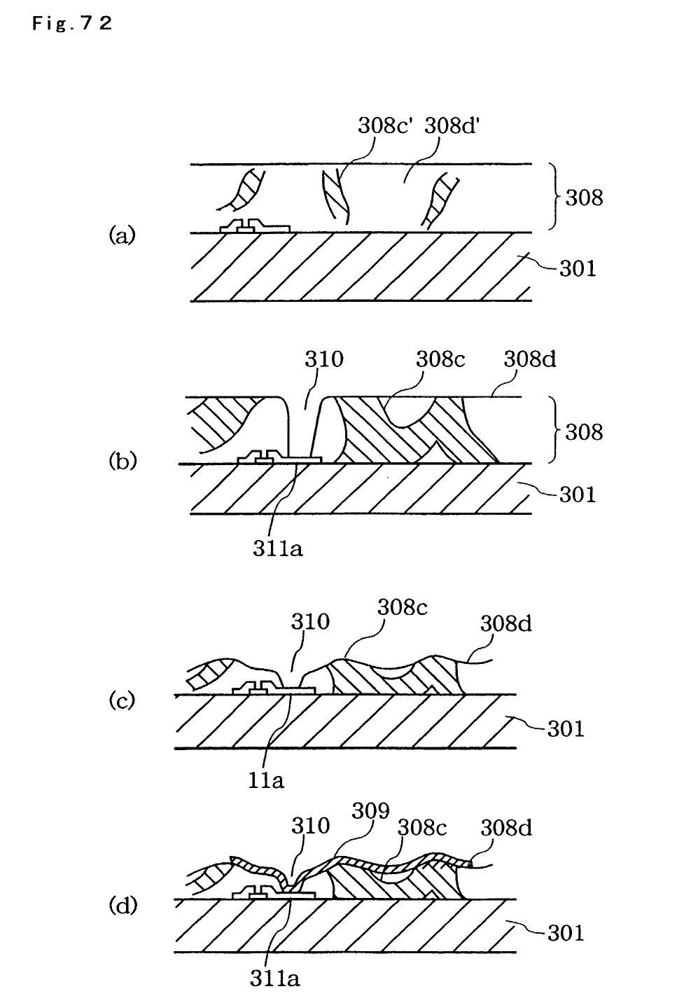

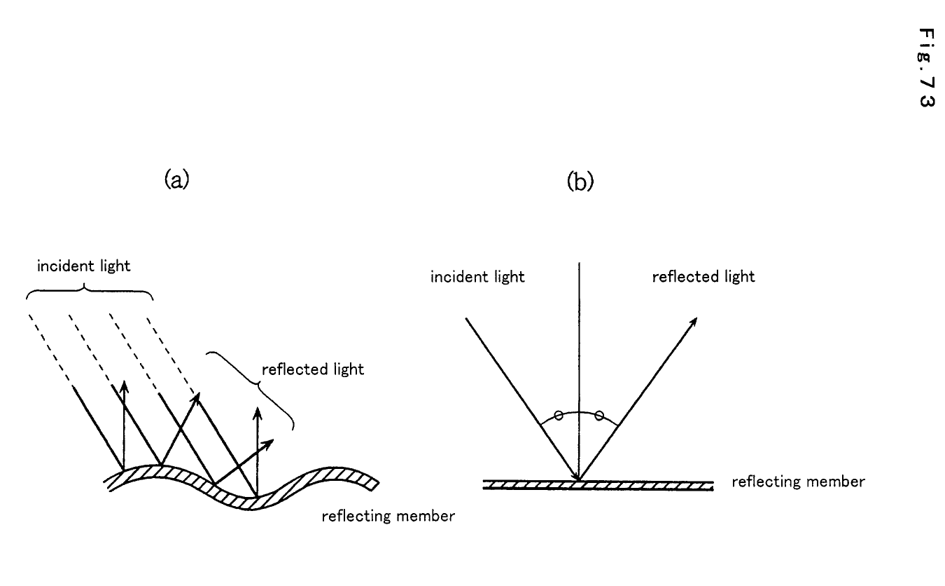

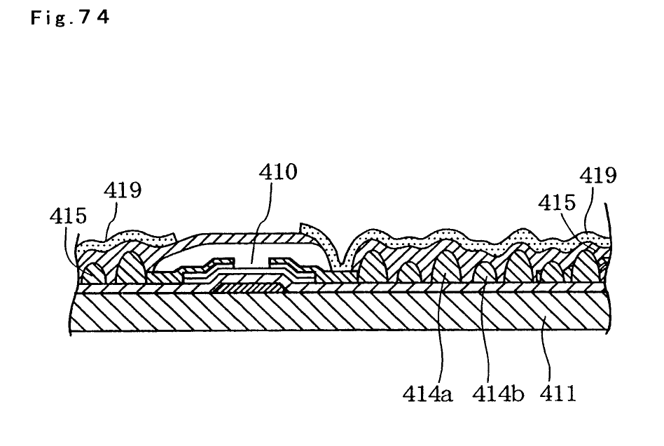

A reflector and a reflective display panel of a reflective display panel according to an embodiment 3-2 of the present invention, and a manufacturing method of these will be described. The embodiment 3-2 differs in resin structure from the embodiment 3-1, and the other parts are identical. Only a step of forming the resin layer in the embodiment 3-2 will be described with reference to FIG. 72. FIG. 72 is a schematic explanatory view showing steps of forming the resin layer of the reflective display panel according to the embodiment 3-2.

A mixed solution was created by dissolving the first resin and the second resin having photosensitivity into a common solvent. In this case, the first resin was an acrylic-based positive photosensitive material and the second resin was styrene-based positive photosensitive material. The ratio between the first resin and the second resin was 50:50 weight percentage. In the embodiment 3-2, the compatibility of the first resin and the second resin is higher than that in the embodiment 3-1.

The mixed solution was applied over the substrate 301 provided with the drive element 311 and the terminal 311a of the drive element, and pre-baked. The solvent was dried by pre-baking, thereby phase separating the first resin and the second resin as shown in FIG. 72(a), thus obtaining the resin layer 308 with a first resin portion 308c made of the first resin and a second resin portion 308d made of the second resin being phase-separated in the form of network, as shown in FIG. 72(b).

Subsequently, mask exposure for exposing only apertures, development, and rinsing steps were conducted, thereby removing the resin layer on the terminal 311a of the drive element provided on the substrate 301, to form a contact hole a shown in FIG. 72(b).

Then, the resin layer was calcined for one hour in a thermostat at a temperature of 200° C. which is equal to the curing temperature of the resin 1 and the resin 2. The first resin and the second resin having different heat shrinkage factors during curing were selected, thereby forming minute concave/convex portions on the surface of the resin layer 308. In this embodiment, since the heat shrinkage factor of the second resin is higher than the heat shrinkage factor of the first resin, the thickness of the second resin portion 308d is made smaller, and as shown in FIG. 72(c), minute concave/convex portions conforming to arrangement of the respective resins in the resin layer 308 were formed on the surface of the resin layer 308. The heat shrinkage factor of the first resin may be higher than the heat shrinkage factor of the second resin.

After calcination, the reflective member 309 comprised of aluminum as a major component was provided over the resin film, and as shown in FIG. 69(e), the reflective member 309 was patterned in the form of pixels in photolithography and etching steps, as described in the embodiment 3-1. The reflective member 309 was connected to the terminal 311a of the drive element on the substrate through the contact hole 310 formed in the resin film.

Thereafter, the steps were carried out as in the embodiment 3-1, thereby completing the reflective liquid crystal display panel.

In the structure and manufacturing method of the embodiment 3-2, minute concave/convex portions can be formed on the surface of the resin layer and the same effects can be provided as in the embodiment 3-1.

The configuration of the resin layer in which the resin forming the resin layer is applied over the substrate and phase-separated by pre-baking varies according to type and ratio of the materials. For example, there is a case where one of the resins is drop-like portions, which is described in the embodiment 3-1, and two types of resins are irregularly formed and one of the resins forms a network, as in the embodiment 2. In either of the embodiments 1, 2, minute concave/convex portions conforming to the arrangement of the two types of resin portions can be formed on the surface of the resin layer, and similar effects can be provided.

### The other Items Relating to Third Invention Group

(1) In the above embodiments, the reflective liquid crystal display panel using liquid crystal has been illustrated, as light control means. The reflective display panel of the present invention is not intended to be limited to the display panel using liquid crystal. The reflective display panel of the present invention is applicable to reflective display panels other than the liquid crystal display panel, for example, electrophoresis display adapted to control absorption and transmission of light by moving fine particles dispersed in a solution in an electric field.

(2) In the above embodiments, two types of resin portions are formed by phase separation. In a method other than the phase separation, the two types of second resin portions can be formed. To be specific, using the two types of resins which are not in compatible state but in a mixed state, heating and irradiation of ultra violet are conducted to separate the two types of resins, thereby forming the two types of resin portions.

(3) In the above embodiments, the resin layer is formed of two types of resins. Alternatively, three or more resins may be used and the same effects can be also provided.

(4) In the above embodiments, the materials with different heat shrinkage factors during curing are used to form minute concave/convex portions on the surface of the resin layer. The minute concave/convex portions can be formed on the surface of the resin layer according to a method using materials with difference in property, associated with viscosity or surface tensions, and the like.

### Industrial Applicability

As should be appreciated from the foregoing description, in accordance with the first invention group, it is possible to manufacture a reflector and a reflective liquid crystal display capable of maintaining high controllability of the shape of the reflective electrode and improving reflection characteristic, only in the step of forming the active elements, without a need for special manufacturing steps.

In accordance with the second invention group, with the use of a plurality of band-like convex portions having intersections as the concave/convex structure of the reflective layer, the variation in the reflectance due to pattern deviation in forming a plurality of layers to create the concave/convex structure is eliminated and productivity is significantly improved.

In accordance with the third invention group, since the resin layer having minute concave/convex portions on the surface as the base of the reflective member is formed in one step, the step can be simplified, and a reflector having satisfactory reflection characteristic and a reflective display panel comprising the reflector can be attained.

1. A reflector comprising an active element and a concave/convex reflective electrode on a substrate, characterized in that
a plurality of cumulated layer patterns obtained by cumulating thin films are formed under the concave/convex reflective electrode, and
the cumulated layer patterns include two or more thin films selected from all thin films constituting the active element and obtained by predetermined patterning in a step of manufacturing the active element.

2. The reflector according to claim 1, wherein the cumulated layer patterns are configured to have a taper shape obtained by cumulating the plurality of thin films with width sequentially reduced.

3. The reflector according to claim 2, wherein the cumulated layer patterns have an asymmetric structure.

4. The reflector according to claim 2, wherein an insulating film is formed between the reflective electrode and the cumulated layer patterns.

5. The reflector according to claim 4, wherein the insulating film is made of resin.

6. The reflector according to claim 5, wherein the resin is photosensitive resin.

7. The reflector according to claim 2, wherein the thin films constituting the cumulated layer patterns include at least two layers having different taper angles.

8. A reflector comprising an active element, a color filter, and a concave/convex reflective electrode on a substrate, characterized in that
a plurality of cumulated layer patterns obtained by cumulating thin films are formed under the concave/convex reflective electrode, and
the cumulated layer patterns include two or more thin films selected from all thin films constituting the active element or the color filter and obtained by predetermined patterning in a step of manufacturing the active element or the color filter.

9. A method of manufacturing a reflector comprising an active element and a concave/convex reflective electrode on a substrate, wherein cumulated layer patterns are formed under the concave/convex reflective electrode, characterized in that
when forming and patterning thin films constituting the active element in a region of the substrate where the active element is formed, two or more of the thin films are formed and patterned in a region where a concave/convex plane is formed, thereby forming the cumulated layer patterns in the region where the concave/convex plane is formed.

10. A reflector comprising an active element, a capacitor electrode for formation of storage capacitor, a concave/convex reflective electrode, and cumulated layer patterns formed under the reflective electrode, on a substrate, characterized in that
a plurality of first cumulated layer patterns obtained by using part of thin films constituting the active element are formed on a region of the substrate except where the capacitor electrode is formed,
a plurality of second cumulated layer patterns different from the first cumulated layer patterns are formed on the capacitor electrode, and
the concave/convex reflective electrode covers the first and second cumulated layer patterns.

11. The reflector according to claim 10, wherein the second cumulated layer patterns are comprised of thin films other than the thin films constituting the active element.

12. The reflector according to claim 11, wherein the second cumulated layer patterns include thin films obtained by patterning the capacitor electrode.

13. A method of manufacturing a reflector comprising an active element, a capacitor electrode for formation of storage capacitor, and a concave/convex reflective electrode, on a substrate, characterized by the steps of:
forming thin films other than thin films constituting the active element on the capacitor electrode; and
patterning the thin films other than the thin films constituting the active element to form cumulated layer patterns.

14. A method of manufacturing a reflector comprising an active element, a capacitor electrode for formation of storage capacitor, and a concave/convex reflective electrode, on a substrate, characterized by the steps of:
forming thin films other than thin films constituting the active element on the capacitor electrode; and
patterning the thin films other than the thin films constituting the active element to form cumulated layer patterns.

15. A method of manufacturing a reflector comprising an active element, a capacitor electrode for formation of storage capacitor, a concave/convex reflective electrode, and cumulated layer patterns formed under the reflective electrode, on a substrate, characterized by the step of:
patterning the capacitor electrode to form the cumulated layer patterns.

16. A reflector comprising an active element, a concave/convex reflective electrode, and cumulated layer patterns formed under the reflective electrode, on a substrate, characterized in that relative positional relationship between thin films constituting the cumulated layer patterns varies for each predetermined region.

17. The reflector according to claim 16, wherein the cumulated layer patterns are asymmetric.

18. A shape structure characterized in that
the shape structure has plural types of cumulated layer patterns comprised of two or more patterned thin films, and an order of sizes of the formed thin films varies for each plural types.

19. A reflector characterized in that
the reflector comprises the shape structure according to claim 18 as the cumulated layer patterns on a substrate.

20. A reflector comprising an active element and a concave/convex reflective electrode on a substrate, characterized in that
cumulated layer patterns obtained by cumulating thin films are formed under the concave/convex reflective electrode, and
the cumulated layer patterns include two or more thin films selected from all thin films constituting the active element and obtained by predetermined patterning in a step of manufacturing the active element, the cumulated layer patterns partially having overlapping portion.

21. The reflector according to claim 20, wherein the overlapping portion is smaller than a minimum width of the thin films constituting the cumulated layer patterns.

22. The method of manufacturing the reflector according to claim 9, wherein the thin films constituting the cumulated layer patterns have partial overlapping portion.

23. The method of manufacturing the reflector according to claim 22, wherein the overlapping portion is smaller than a minimum width of the thin films constituting the cumulated layer patterns.

24. The reflector according to claim 1, having light transmitting portion.

25. The reflector according to claim 24, wherein the light transmitting portion has thickness different from thickness of portion other than the light transmitting portion.

26. A reflective display panel characterized by using the reflector according to claim 1.

27. A semi-transmissive display panel characterized by using the reflector according to claim 24.

28. A semi-transmissive display panel according to claim 27, having light collecting portion.

29. A reflector comprising:
a substrate; and
a reflective layer having a concave/convex structure formed on the substrate, characterized in that
the concave/convex structure is formed by crossing a plurality of band-like thin film patterns formed on the substrate.

30. The reflector according to 29, wherein convex portions are provided at portions where the thin film patterns cross each other.

31. The reflector according to claim 29, wherein the portions where the thin film patterns cross each other have a concave shape.

32. The reflector according to claim 29, wherein the thin film patterns have a mesh shape.

33. The reflector according to claim 29, wherein the thin film patterns are irregularly spaced.

34. The reflector according to claim 29, wherein an active element is further formed on the substrate, and the thin film patterns are comprised of thin films constituting the active element.

35. The reflector according to claim 29, wherein an active element is further formed on the substrate, and the thin film patterns are formed in a step of forming the active element.

36. A reflective display panel characterized by comprising:
the reflector according to claim 29; and
a light control means provided on the reflector, for controlling amount of absorbed light.

37. A reflector comprising:
a substrate;
a resin layer formed on the substrate and having minute concave/convex portions on a surface thereof;
a reflective member provided on the resin layer, for reflecting light, characterized in that
the resin layer has the concave/convex portions obtained by dispersing and holding at least two types of resin portions.

38. The reflector according to claim 37, wherein the concave/convex portions conform to arrangement of the at least two types of resin portions.

39. The reflector according to claim 37, wherein vertical difference of the concave/convex portions is 0.7 μm or less.

40. The reflector according to claim 37, wherein the at least two types of resin portions are formed by phase separation in a solution including at least two types of resins applied over the substrate.

41. The reflector according to claim 37, wherein the at least two types of resin portions have shrinkage factors differing from each other.

42. A reflective display panel characterized by comprising:
the reflector according to claim 37; and
light control means provided on the reflector, for controlling amount of absorbed light.

43. The reflective display panel according to claim 42, wherein the resin portions comprise photosensitive resin.

44. The reflective display panel according to claim 42, wherein an active element is further formed on the substrate and covered by the resin layer,
the resin layer is provided with a contact hole reaching the active element, and the active element is electrically connected to the reflective member through the contact hole.

45. A method of manufacturing a reflector comprising:
a substrate;
a resin layer formed on the substrate and having minute concave/convex portions on a surface thereof; and
a reflective member provided on the resin layer, for reflecting light, wherein the resin layer is provided with the concave/convex portions obtained by dispersing and holding at least two types of resin portions, comprising the steps of:
creating a mixed solution including at least two types of resins;
applying the mixed solution over the substrate;
phase-separating the resins contained in the mixed solution applied over the substrate to form the resin layer having concave/convex portions on the surface thereof; and
forming a reflective member on the resin layer.
